(19) United States
(12) Patent Application Publication
(10) Pub. No.: US 2006/0224478 A1
(43) Pub. Date: Oct. 5, 2006

(54) Personnel absence management and monitoring system

(75) Inventors: Gary Harbison, Chattanooga, TN (US); Dana Jackson, Chattanooga, TN (US); Leah Cooper, Chattanooga, TN (US)

Correspondence Address: LUEDEKA, NEELY & GRAHAM, P.C., P O BOX 1871, KNOXVILLE, TN, 37901, US

(73) Assignee: Absentys, LLC

(21) Appl. No.: 11/265,248

(22) Filed: Nov. 2, 2005

Related U.S. Application Data
(60) Provisional application No. 60/662,782, filed on Mar. 17, 2005.

(51) Int. Cl. G07C 1/10; G06F 15/02

(52) U.S. Cl. 705/32

(57) ABSTRACT

The invention provides a system for recording and reporting employee absences. It tracks and administers information needed to comply with the Family Medical Leave Act (FMLA), state and employer authorized leave along with employee attendance policies and vacation plans within the employer's system. In a preferred embodiment, the system is deployed through the Internet and interacts with Short Term Disability and Workers' Compensation vendors and tracks which employee absences should be classified as such. With all absence data integrated into one system, the invention easily creates reports that have been difficult, if not impossible, to compile previously.

This application claims priority to provisional patent application Ser. No. 60/662,782 filed Mar. 17, 2005.

This application includes a computer program listing submitted on two compact discs (duplicates—Copy 1 and Copy 2), the entire contents of which are incorporated herein by reference. A complete list of the files contained on the compact discs is submitted herewith in Appendix I.

### FIELD

This invention relates to the field of personnel management. More particularly, this invention relates to monitoring and reporting employee absences, and administering employee leave policies.

### BACKGROUND

The Family and Medical Leave Act (FMLA) was enacted in 1993 to guarantee employees the availability of temporary leave in case of family and medical related emergencies. Since enactment of the FMLA, employers have had substantial difficulty in complying with its regulations. As a result of these difficulties, the FMLA has been a significant source of litigation. Costly verdicts have been awarded against employers, especially when employee claims have involved violations of both federal and state leave laws. Thus, non-compliance with the FMLA can result in major financial liability to employers and to management personally.

The most frequent reasons why employers have failed to comply with the FMLA include failure to identify and promptly designate FMLA-qualifying absences, failure to educate management about the FMLA regulations, failure to notify employees of their FMLA rights and obligations, failure to administer state leave laws correctly in conjunction with the FMLA, failure to properly calculate leave entitlement, failure to understand that FMLA obligations exist even when employees do not request FMLA leave, failure to track FMLA leave in situations where more generous leave benefits are provided, failure to designate extended leaves as FMLA leave, failure to invest in the personnel and technology required to properly administer the FMLA and failure to realize that there can be significant penalties assessed for FMLA violations.

Therefore, what is needed is a system to help employers monitor, administer and report employee leave and absences, and provide information needed to help employers comply with the FMLA and state laws regarding employee leave.

### SUMMARY

The invention provides a system for recording and reporting employee absences. It tracks and administers information needed to comply with the FMLA, state and employer authorized leave, employer attendance policies and employee vacation plans. In a preferred embodiment, the system is deployed through the Internet and interacts with Short Term Disability (STD) and Workers' Compensation (WC) vendors to track which employee absences should be classified as such. With all employee absence and leave data integrated into one system, the invention creates reports that have been difficult, if not impossible, to compile previously.

The invention provides employees a self-service interface for submitting requests and status inquiries. The invention also provides simple navigation and data display, integrated absence intake and processing, unlimited security levels and access groups, comprehensive audit trails, integrated online reporting, determination of leave eligibility and entitlement, and Federal FMLA administration including continuous leave, intermittent leave and reduced schedule leave. The invention further provides for automatic application of state leave based on employee's work location and reason for leave, management of employer authorized leaves, administrator and manager work lists, customized paperwork generation using a standard portable document format, medical certification processing, accrual of vacation, sick leave, personal leave and pregnancy time off (PTO), consistent application of employer attendance policies, coordination and tracking of STD and workers' compensation, and insurance premium payment tracking.

In one preferred embodiment, the invention provides an apparatus for managing information related to employee leave. In this embodiment, the apparatus comprises an employee database, a client computer and a server computer that are in communication via a communication network. The employee database is for maintaining employee information related to absences of the employee from the workplace. The client computer is for entering input information related to requested employee leave. The server computer is for receiving the input information, accessing employee information from the employee database and executing one or more software modules. The software modules operate on the input information and the employee information to determine whether the requested employee leave is to be granted. The determination of eligibility for the leave is based at least in part on government-enacted employee leave laws and employer leave policies.

In another embodiment, the invention provides an apparatus for managing information related to requests for employee leave. The apparatus of this embodiment includes means for maintaining employee identification information and employee leave information, means for receiving a request for approval of the employee leave, where the request includes a reason for the requested leave, and means for determining eligibility of the employee for the requested leave based at least in part on the employee identification information, the employee leave information and the reason for the requested leave. The apparatus also includes means for automatically generating documentation for notifying the employee regarding whether the employee is eligible for the requested leave.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 is functional block diagram of a personnel absence management and monitoring system according to a preferred embodiment of the invention;

FIG. 2 is functional block diagram of a hardware implementation of a personnel absence management and monitoring system according to a preferred embodiment of the invention;

FIGS. 3-14 are functional flow diagrams of a personnel absence management and monitoring system according to a preferred embodiment of the invention;

FIGS. 15-45 are example user interface screens generated by a personnel absence management and monitoring system as displayed on a display device according to a preferred embodiment of the invention;

FIG. 46 is a functional flow diagram of a personnel absence management and monitoring system according to a preferred embodiment of the invention;

FIGS. 47-51 are example user interface screens generated by a personnel absence management and monitoring system as displayed on a display device according to a preferred embodiment of the invention;

FIG. 52 is a functional flow diagram of a personnel absence management and monitoring system according to a preferred embodiment of the invention;

FIGS. 53-59 are example user interface screens generated by a personnel absence management and monitoring system as displayed on a display device according to a preferred embodiment of the invention;

FIG. 60 is a functional flow diagram of a personnel absence management and monitoring system according to a preferred embodiment of the invention; and

FIG. 61 is an example user interface screen generated by a personnel absence management and monitoring system as displayed on a display device according to a preferred embodiment of the invention.

### DETAILED DESCRIPTION

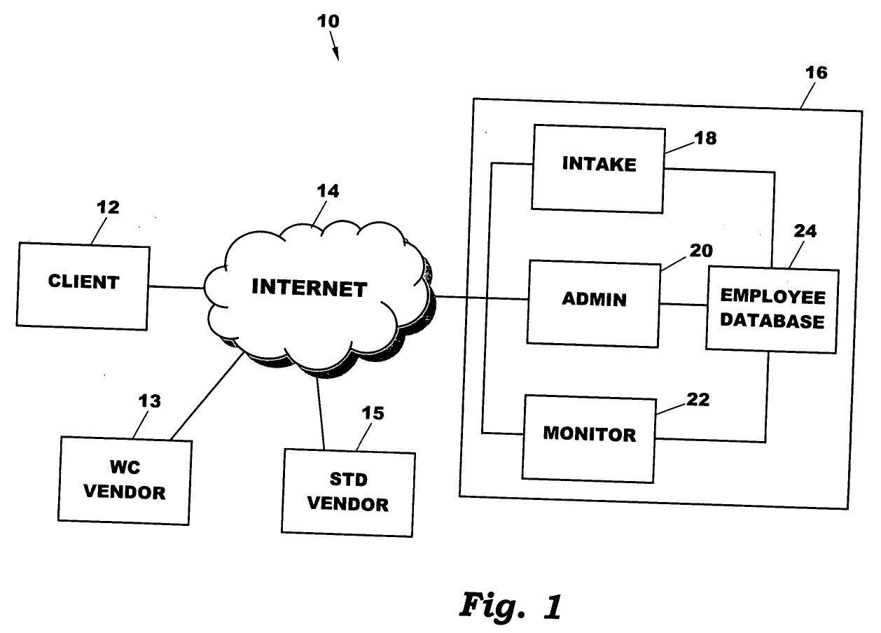

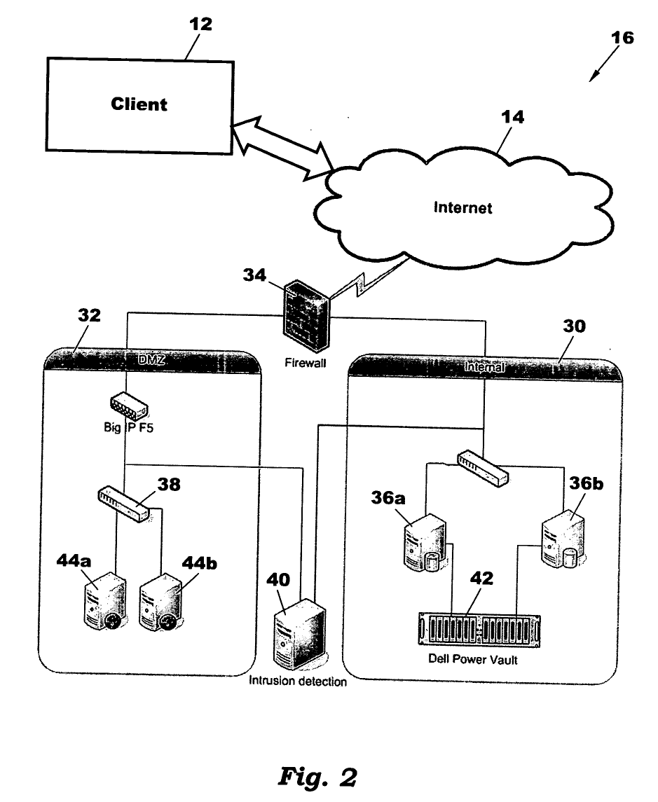

In the preferred embodiment, the invention provides an absence tracking and administration system hosted through a third party hosting provider. With reference to FIG. 1, the system 10 includes a client computer 12 running a web browser, such as Microsoft Internet Explorer. The client computer 12 has access, such as through a local area network (LAN), to a global communication network 14 such as the Internet. The system 10 also includes a server computer system 16 which is also connected to a global computer network 14. In the preferred embodiment, the server computer system 16 is provided and maintained by an entity other than the employer, which entity is also referred to herein as a third party hosting provider. The server computer system 16 comprises hardware components, such as depicted in FIG. 2, and software components, such as depicted in FIG. 2.

As shown in FIG. 1, a preferred embodiment of the invention also provides communication via the network 14 with a Workers Compensation vendor 13 and a Short Term Disability vendor 15.

In the preferred embodiment, the software components include intake modules 18, administration modules 20, and monitor modules 22. The functions of these and other modules are described in detail herein. Preferably, the modules 18, 20 and 22 have access to an employee database 24. The database 24 includes identification, absence and leave information regarding employees employed by a particular employer or by several employers. The database 24 also preferably includes absence and leave policy information for the employer.

Should a user of the system (also referred to as a client) require onsite hosting, an alternative embodiment of the hardware and software of the system can be installed and configured in the client's data center.

A diagram of the physical infrastructure of a preferred embodiment of the system 10 is depicted in FIG. 2. The system network is divided into an internal network 30 and a DMZ network 32 attached to a firewall 34. Located within the internal network 30 are two domain controllers and a pair of database servers 36a-36b comprising a clustered SQL Server 2000 database system. Located within the DMZ is an F5 load balancer 38 and two web servers 44a-44b constituting a web farm. Both networks are served by an ISS intrusion detection server 40.

The preferred configuration includes dual Dell 2650's with dual 2.8 GHz Zeon processors with 4 GB memory for the database servers 36a-36b with a PowerVault 220 storage array 42. The database servers preferably run Windows Server 2003 Enterprise Edition and SQL Server 2000 Enterprise Edition. The web servers 44a-44b are preferably Dell 1750s with dual 2.8 GHz processors with 1 GB memory running Windows Server 2003 Standard. An additional Dell 1750 is used as a utility server for SFTP and various automated tasks. The Windows domain servers are Dell 1750's with dual 2.8 GHz processors and 1 GB memory running Windows 2000 sp4.

Thus, the preferred embodiment of the system is deployed in three tiers. The backend internal system 30, the middle tier DMZ system 32, and the presentation tier which consists of client web browsers 12 running a network browser application. The firewall 34, load balancer 38 and intrusion detection servers 40 use their own operating systems.

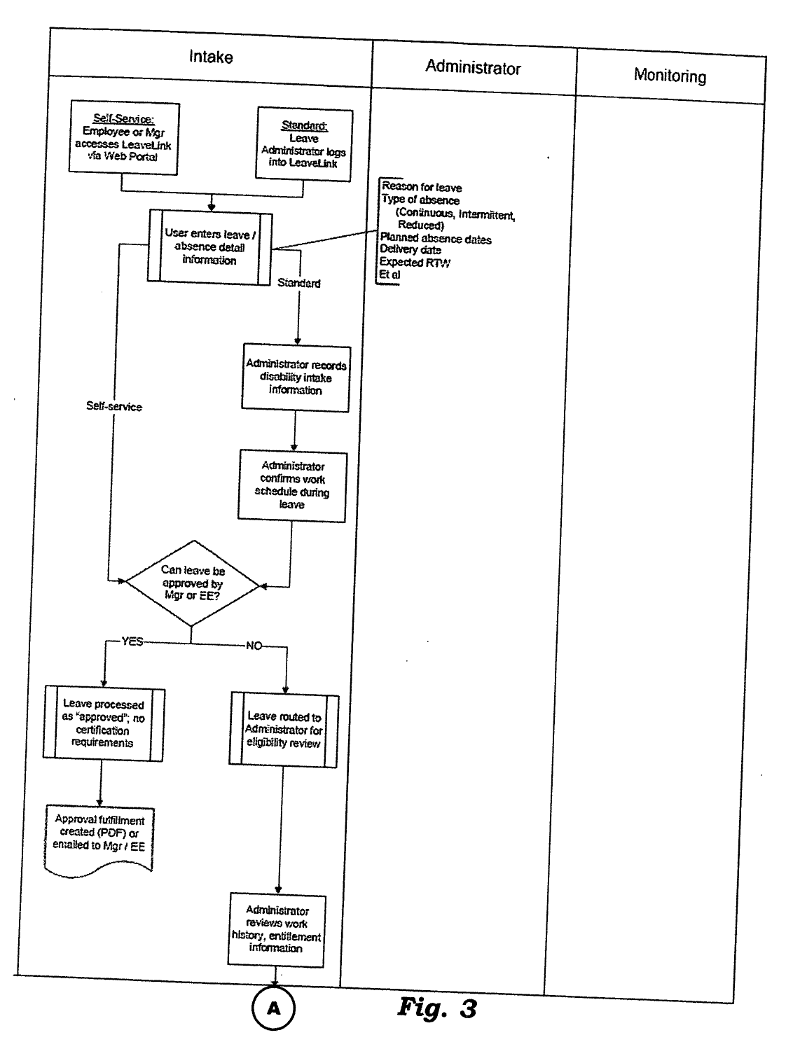

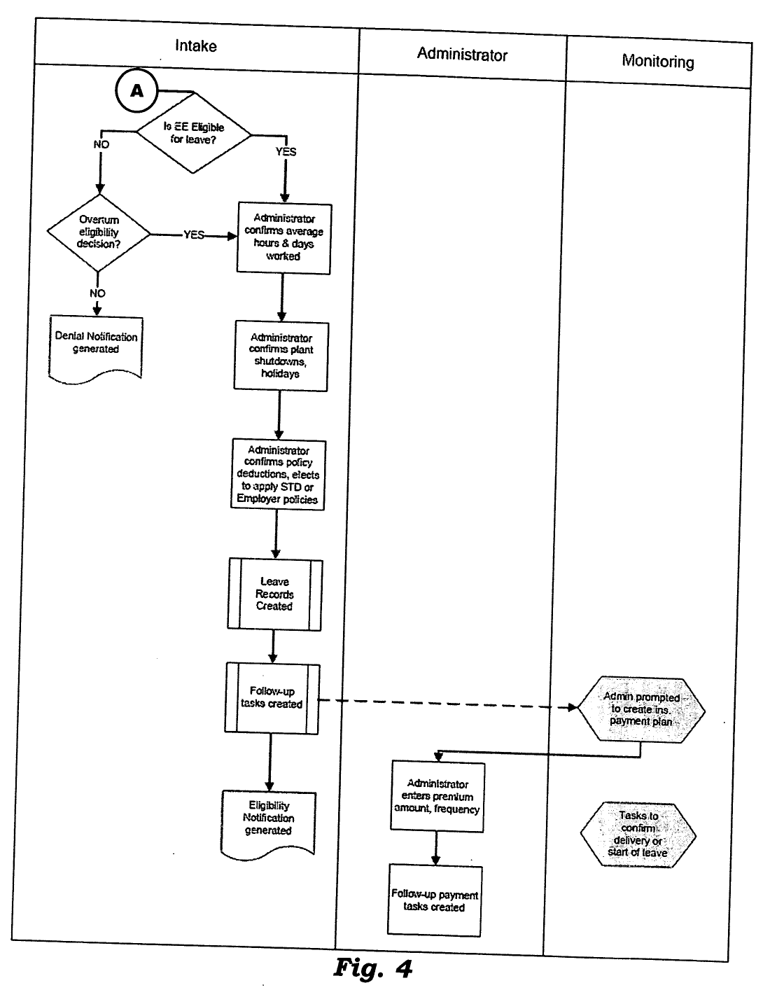

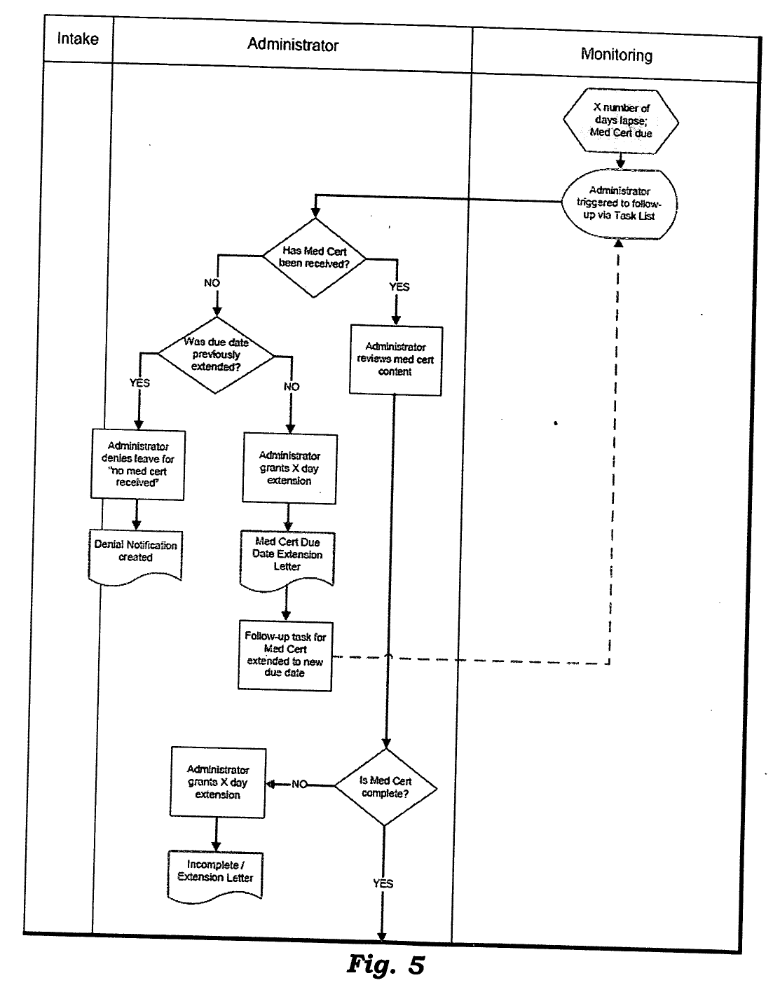

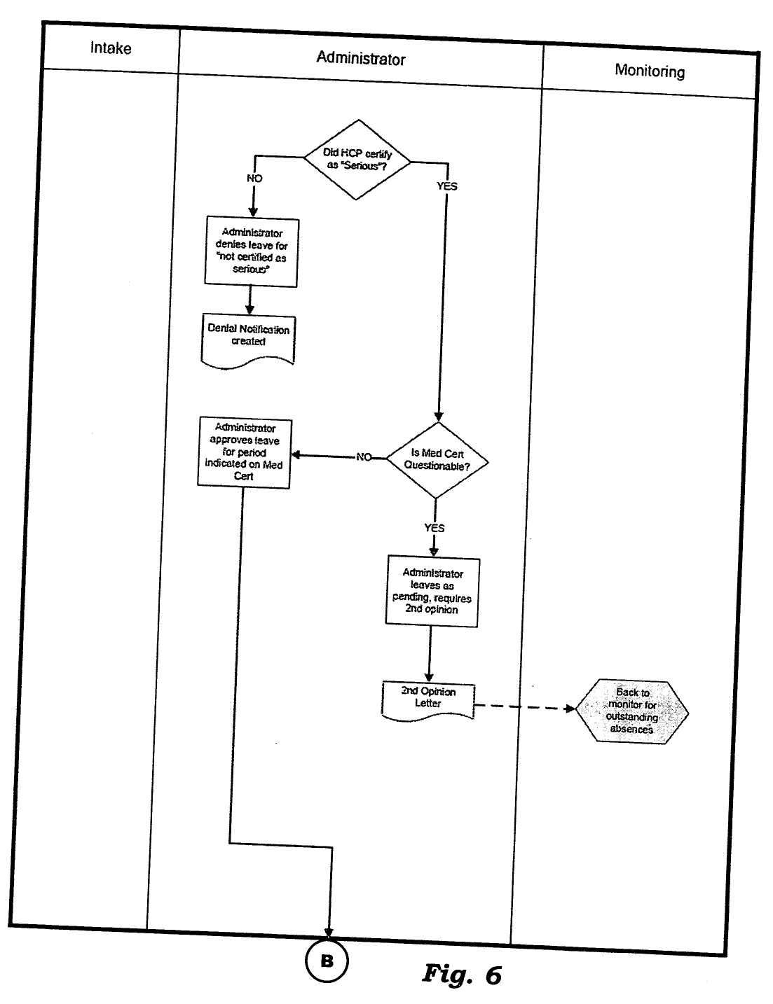

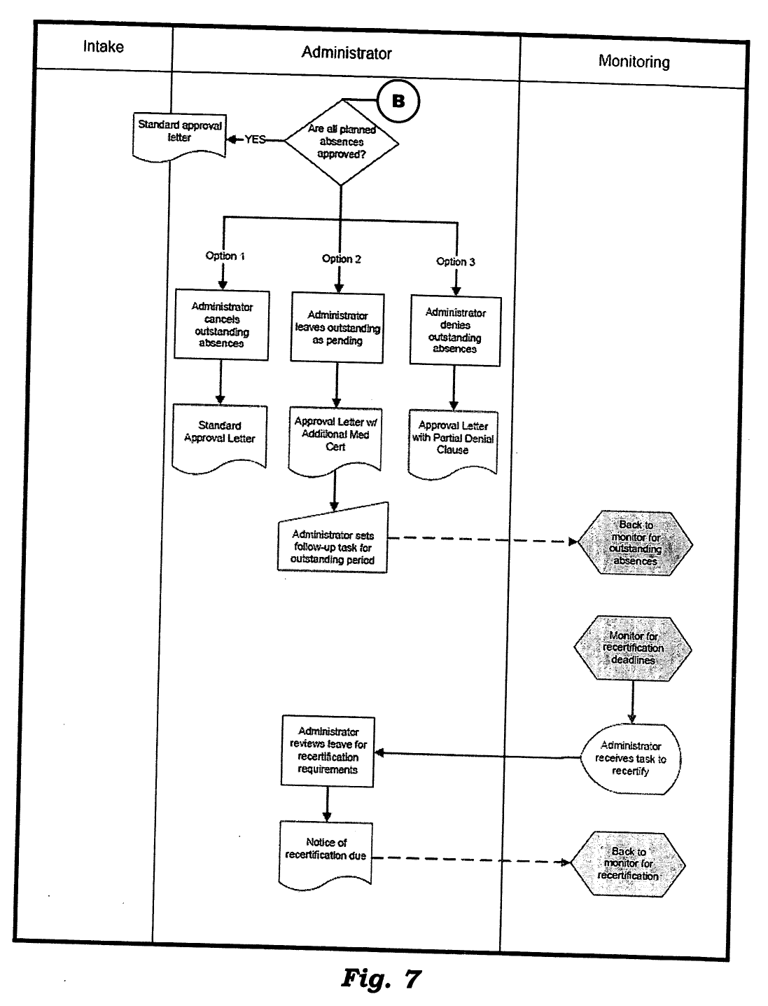

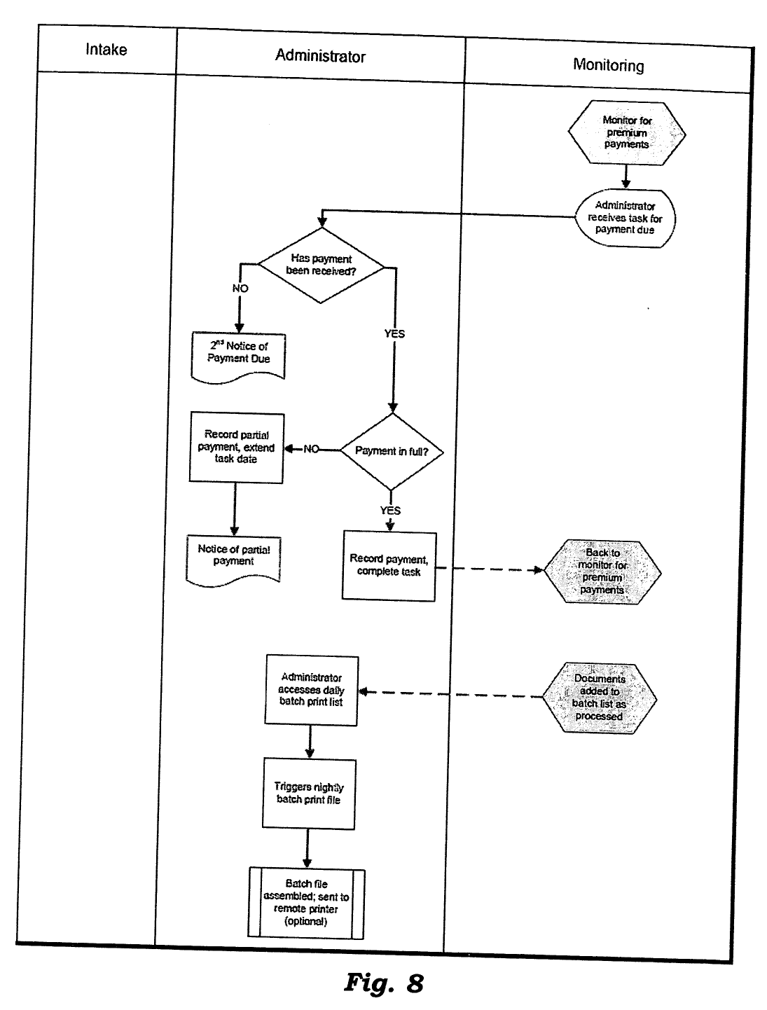

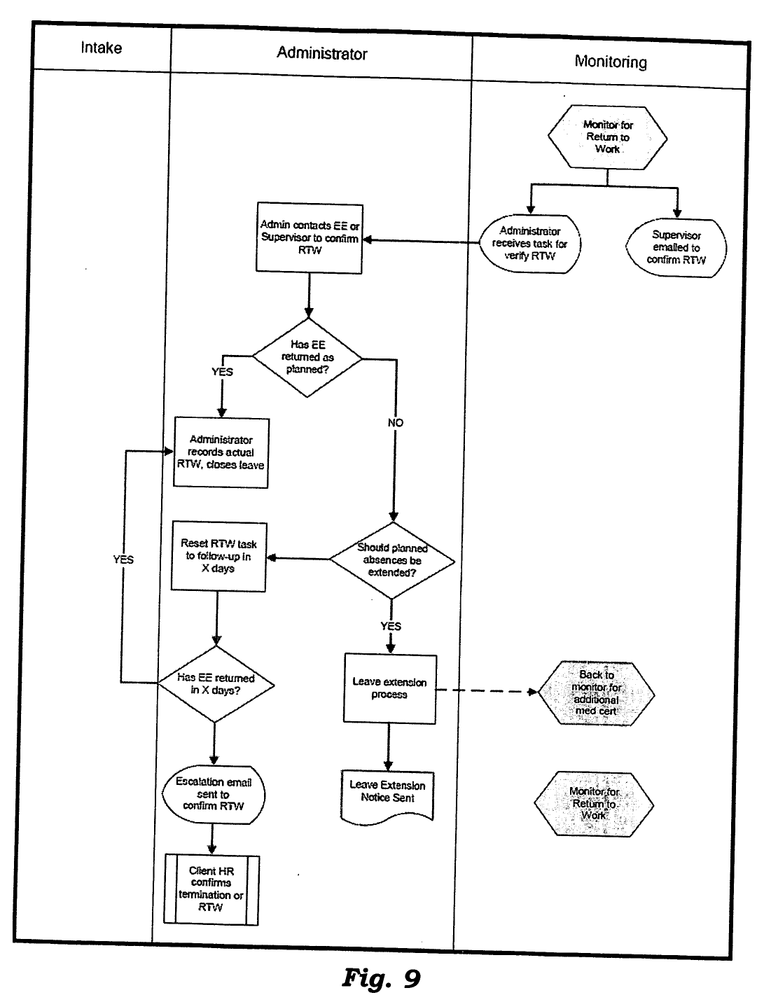

FIGS. 3-9 depict functional flow diagrams that provide a broad overview of operations carried out by the system 10. Generally, FIGS. 3 and 4 describe intake operations executed in receiving requests for employee leave, determining eligibility for leave and generating documentation for communicating approval or denial of leave requests. FIGS. 5-7 generally describe administration operations executed in monitoring absences associated with medical leave, determining extensions for medical leave and administering medical certifications for medical leave. FIG. 8 describes operations executed in monitoring, recording and reporting insurance premium payments. FIG. 9 describes operations executed in monitoring, administrating and reporting “return to work” (RTW) of employees on leave. These and other operations are described further in examples of system operation set forth hereinafter.

Thus, the system 10 performs several processes in tracking, managing, administering and reporting employee absences. These processes, which are described below, include leave request processes, leave certification processes, leave modification processes and task list processes.

In a preferred embodiment of the invention, the system 10 provides a self-service access mode wherein a client user, such as an employee or manager, can log into the system 10 via a Web portal. Administrators preferably access the system 10 via a web based network connection. Using the login information, the system 10 distinguishes between manager-level, employee-level and administrator-level access, and the functions available to the user are tailored based on the access level. For example, employee-level access allows an employee to make new leave requests and inquire regarding leave and absence history. Manager-level access, among other things, allows a manager to inquire regarding all the manager's employees on leave. Administrator-level access provides various functions as set forth in more detail herein.

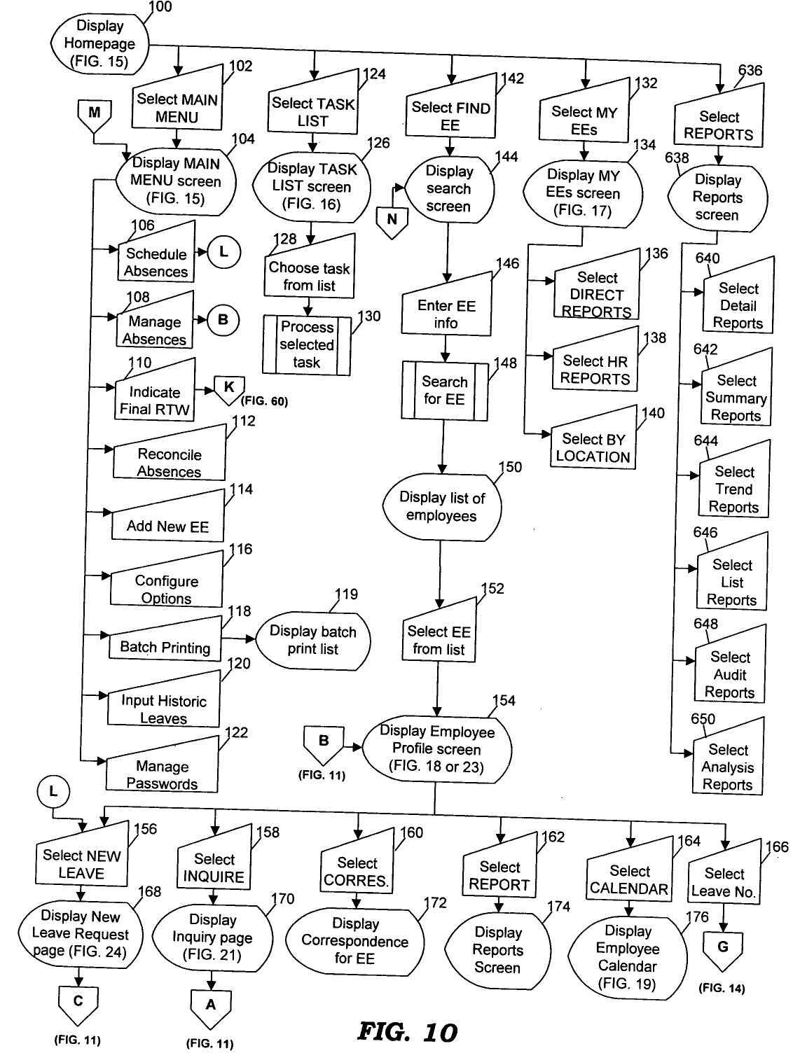

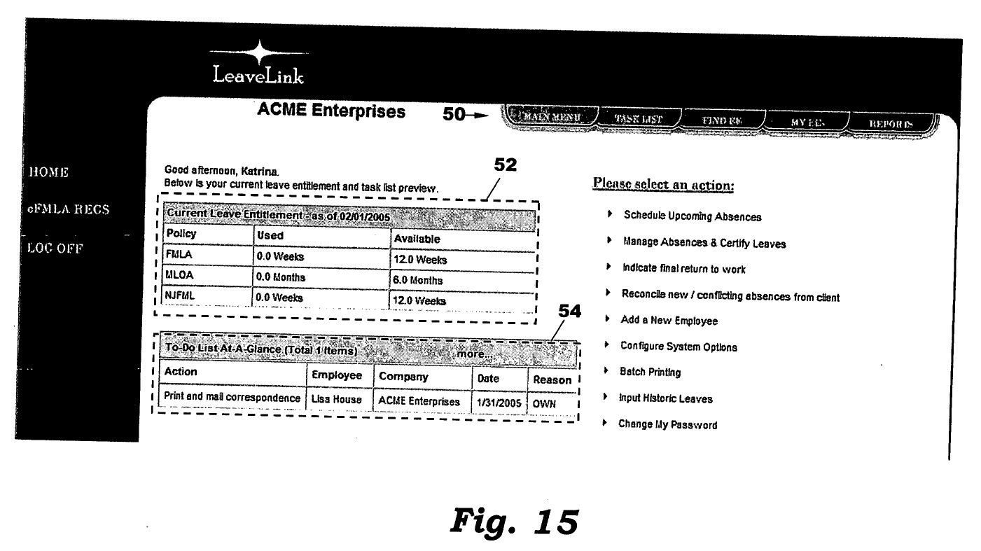

With reference to FIG. 10, when a client logs into the system, the system home page is displayed (step 100). As shown in FIG. 15, across the top of the home page screen are five tabs 50 for accessing a main page (MAIN MENU), a task list (TASK LIST), the employee search screen (FIND EE), a list of employees on leave (MY EEs) and a report selection screen (REPORTS). In the preferred embodiment, these tabs 50 are available from any area of the program. The leave entitlement section 52 displays the amount of leave taken and available under each of the employer's policies. A portion of the task list is displayed in the To-Do List At-A-Glance section 54 of the screen.

Main Menu

Based upon the user's access level, the following menu items are displayed (step 104) when the MAIN MENU page is selected (step 102) as shown in FIG. 15:

Schedule Upcoming Absences—This option allows the user to enter a leave for an employee (step 106).

Manage Absences & Certify Leaves—This option takes the user to the employee profile record where the user can select the applicable absence or leave (step 108).

Indicate Final Return to Work—This option allows the user to enter the return to work date for employees with open leaves (step 110).

Reconcile new/conflicting absences from client—This option allows the user to view and reconcile information about imported absences that conflict with current information in the system (step 112).

Add a New Employee—This option allows the user to enter a new employee into the system (step 114).

Configure System Options—This option allows the user to configure the system to meet the client's policy parameters, report groupings and correspondence (step 116).

Batch Printing—This option allows the user to print letters for multiple employees at one time, instead of printing each letter individually (step 118). Letters are added to the batch print list immediately after they are created during administrative workflow (step 119). Preferably, only those documents that have never been batch printed will appear on this screen. Batch prints include a cover page for the batch and separator sheets in between the employees' letters.

Input Historical Leaves—This option allows the user to enter absences associated with past leaves that are closed (step 120).

Change MY Password—This option allows the user to change the password associated with a user name (step 122).

Task List

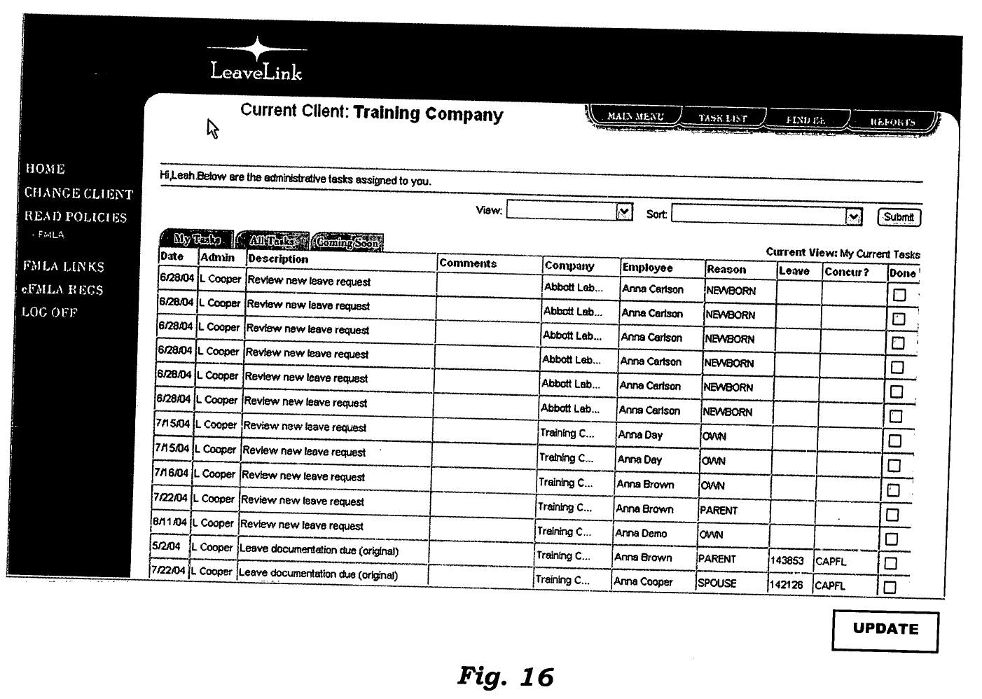

In a preferred embodiment, the system 10 creates system-generated tasks as leaves are entered and processed. When the task list tab is selected (step 124), these tasks are displayed in a task list screen (step 126) such as shown in FIG. 16. Some of these tasks are automatically completed as the user processes leave in the system, while others are manually removed from the user's task list. Table I provides a list of system-generated tasks, how they are created in the system and how they are removed from the user's task list.

TABLE I

| System-Generated | | |
|---|---|---|
| Task | Created When: | Completed & Removed: |
| Review new leave | A leave request with the planned | Automatically after the eligibility review is |
| request | absences is entered in the system. | completed and the leave is added to the |
| | | system. |
| Leave documentation | A leave requiring a medical | Automatically when the “Complete Received” |
| due (original) | certification is entered in the system. | date is entered on the Medical Certification |
| | | screen. |
| Leave documentation | The request for a 2^{nd} opinion is entered | Automatically when the “Complete Received” |
| due (2^{nd} opinion) | on the Medical Certification screen. | date is entered on the Medical Certification |
| | | screen for the 2^{nd} opinion. |
| 5-Day | A leave requiring a medical | Automatically completed when the “Complete |
| Documentation | certification or another certification is | Received” date is entered on the Medical |
| Reminder | entered in the system. | Certification screen; otherwise manually |
| | | completed. |
| 10-Day | A leave requiring a medical | Automatically completed when the task is |
| Documentation | certification or another certification is | clicked to generate the 10-day reminder letter |
| Reminder | entered in the system. | or the “Complete Received” date is entered on |
| | | the Medical Certification screen. |
| Print and mail | Correspondence is generated in the | Manually completed after the user prints and |
| correspondence | system. | mails the correspondence packet. |
| EE scheduled for | A nightly batch cycle runs and places | Automatically completed when the “Actual |
| RTW | the task on the list if the last date of | Return Date” is completed on the Back to |
| | leave is the current date and the leave is | Work tab on the Leave Details screen. |
| | still open. | |
| Create insurance | A leave is entered with continuous | Manually removed from the list when the user |
| premium payment | absences greater than 30 days. | creates the insurance payment plan or when |
| plan | | the user doesn't need to create a plan. |
| Internal messaging | Manually entered by a user as a | Manually completed after the user checks to |
| | message to him/herself or another user | remove it from his worklist. |
| | to follow up on a leave. | |
| Recertification | Based on system settings, a nightly | Manually removed after the user determines |
| Required | batch cycle runs to determine which | need for recertification and appropriate |
| | leaves are due for recertification. | correspondence on longer leaves of absence. |
| | Typically creates task every 30 days of | |
| | leave on continuous absences, every 60 | |
| | days of leave on intermittent absences. | |
| Insurance premium | A nightly batch cycle runs to evaluate | Manually removed from the list after the user |
| payment due | & create task for premium payments | takes appropriate action to process or follow- |
| | (created at the leave record level) that | up for premium payments due. |
| | are due that date. | |

To process a to-do item in the task list, the user simply clicks on the link in the description column (step 128). The user is then re-directed to the appropriate area of the software to perform the action required. Most tasks will be removed from the task list when the required information is entered or processed (step 130). Items can also be removed from the task list by clicking the associated box in the “Done” column and clicking the UPDATE button. (See FIG. 16.)

The system 10 allows the user to create ad-hoc tasks in addition to the system-generated tasks. The user can also send messages to other administrators or users that will appear on their task lists.

MY EEs

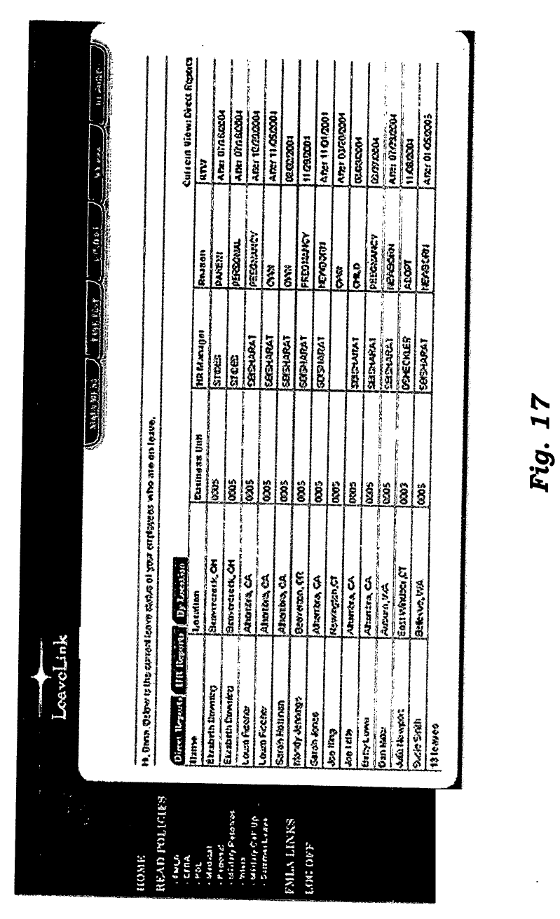

The user may click on the MY EEs tab (step 132) located in the upper right-hand corner of any screen to display the MY EEs screen (step 134). From this screen, as shown in FIG. 17, the user can access three tabs: Direct Reports, HR Reports, and By Location. Selecting the Direct Reports tab (step 136) provides the user a view of the current status of all employees on leave for whom the user is the direct supervisor. Selecting the HR Reports tab (step 138) provides the user a view of the current status of all employees on leave for whom the user is the human resources administrator. Selecting the By Location tab provides the user a view of the current status of all employees on leave for whom the user is the direct supervisor at a specific location and business unit. The user may change the location and business unit by selecting a different one from the drop-down menu located in the upper right corner, and then click FILTER.

To locate an employee's record in the system 10 the user clicks the FIND EE tab at the top of any screen (step 142). A search screen will appear for the user to enter information to find the employee's record (step 144). At this point the user enters any or all of the employee's first name, last name, employee id or social-security number (step 146). The user then clicks the SUBMIT button, the system 10 searches for all employees matching the user's search criteria (step 148) and displays a list of the matching employees (step 150). The user clicks on an employee's name to access his/her record (step 152) on the employee profile screen (step 154).

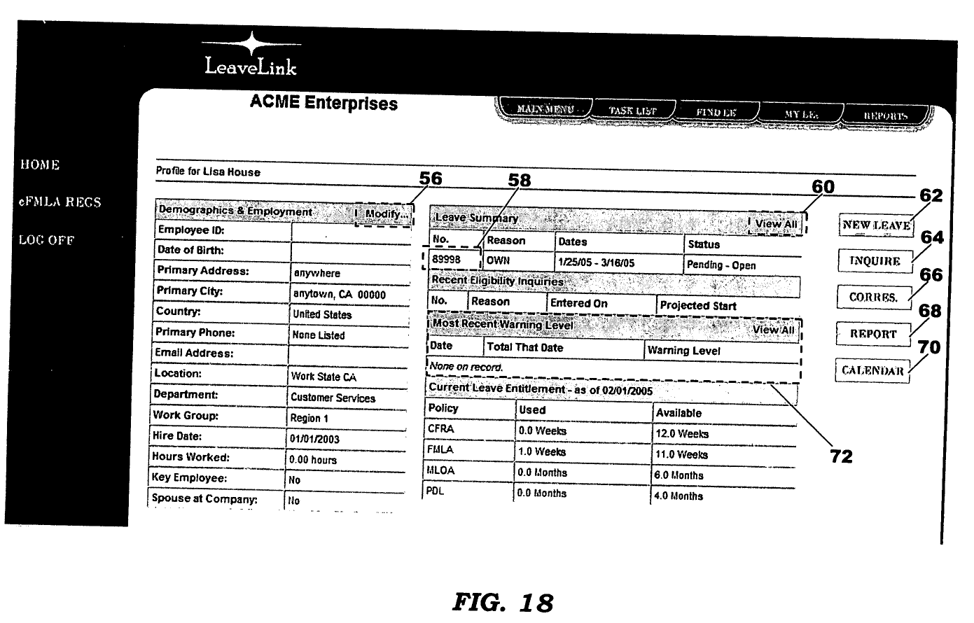

As shown in FIG. 18, the employee profile screen displays a summary of the selected employee's demographic information (including the employee's work state) and leave data. It also displays the employee's current leave entitlement as of the current date. From this screen, the user can access the employee's record by clicking the Modify link 56 in the “Demographics & Employment” area of the screen. The user can also access the details for a leave by clicking on the leave number 58 in the “Leave Summary” area of the screen. The View All link 60 in the “Leave Summary” area allows the user to view the employee's leave and absence history.

The user can enter a leave request for the employee by clicking the New Leave button 62 (step 156). To review the paperwork generated for this employee (step 172), the user clicks the Corres. button 66 (step 160). The user can create a employee profile report (step 174) by clicking the Report button 68 (step 162).

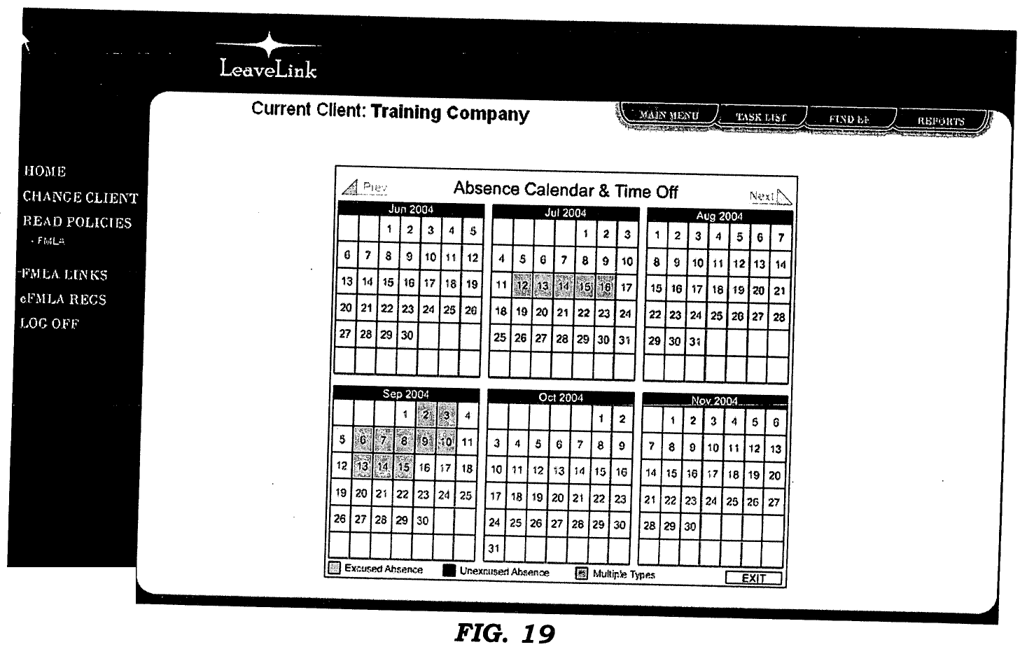

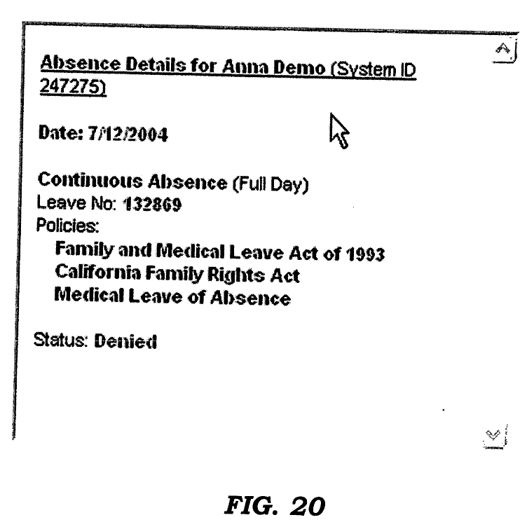

When the user clicks the Calendar button 70 (step 164), a calendar with all of the employee's absences is displayed (step 176). An example of an employee calendar is shown in FIG. 19. The user may view details about each absence by clicking on the day of the absence in the calendar. A pop-up box as shown in FIG. 20 will appear listing the date of the absence, the type of absence (continuous, reduced schedule or intermittent), the leave number associated with the absence, the policies that apply to the absence, and the status of the absence.

As shown in FIG. 18, the “Most Recent Warning Level” box 72 shows information about any infractions the employee has received. It indicates the date of the most recent incident, the total number of occurrences the employee has received, and the warning level the employee has reached.

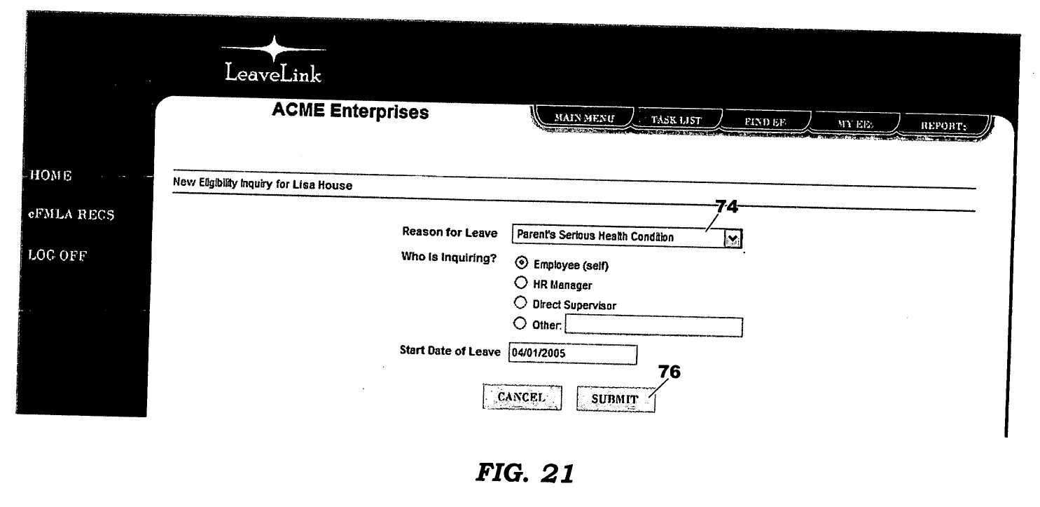

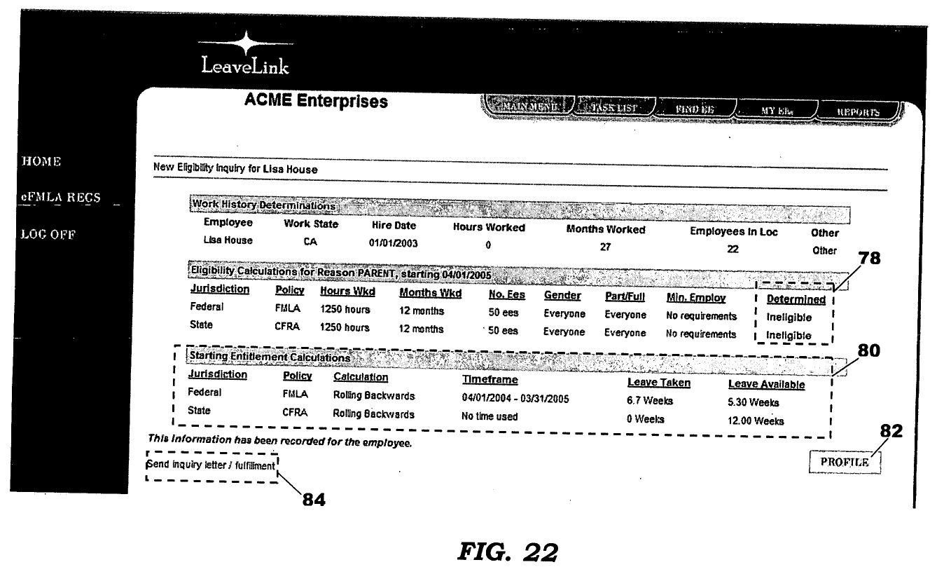

To determine if an employee has time available for leave, the user clicks the Inquire button 64 (step 158) located on the right side of the employee profile screen. This brings up the inquiry screen (step 170) as depicted in FIG. 21. From the inquiry screen, the user selects the reason for leave from the dropdown menu 74 (step 178) and selects who is inquiring about the leave (step 180). The user then enters the start date of the leave (step 182). If no date is entered, the default date, which is the current date, will be used. When the user clicks the SUBMIT button 76 (step 184), the system determines what leave policies apply for this employee (step 186). The applicable polices are then displayed (step 188) as shown in FIG. 22.

If the user does not have a time and attendance feed in the system, the policies will preferably show up as ineligible. (See 78 in FIG. 22.) As described below, this can be overturned during the process of adding a new leave for the employee. The amount of leave an employee has available under the applicable policies appears in the “Starting Entitlement Calculations” section 80. The user clicks the Profile button 82 to return to the employee's profile (step 190), or the “Send inquiry letter/fulfillment” link 84 (step 192) to generate correspondence regarding the availability of time under the policies (step 193).

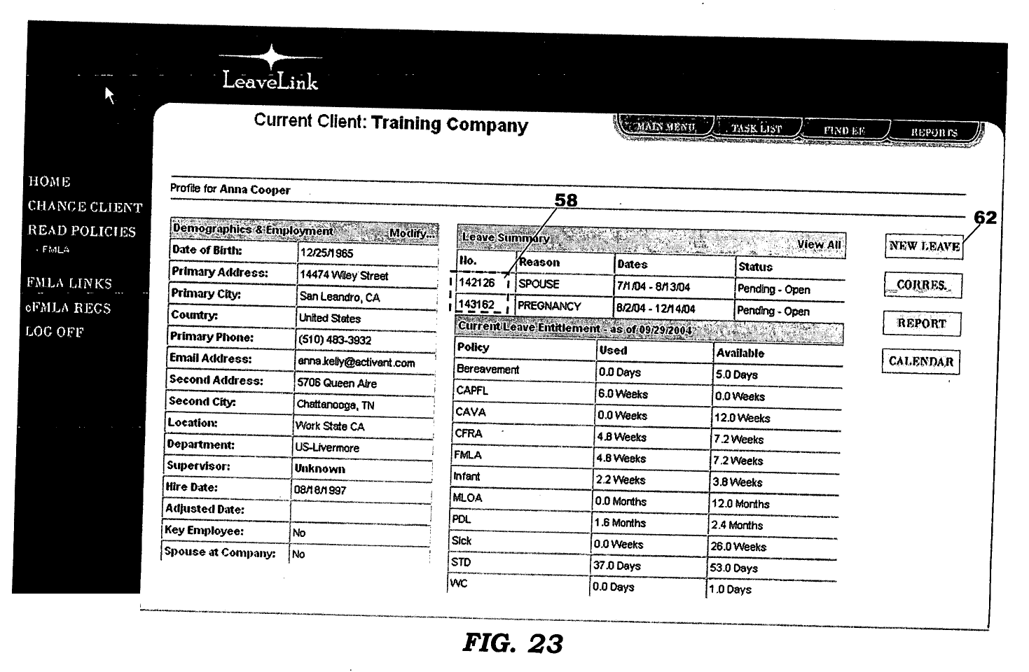

Before adding a new leave, the user may consult the Leave Summary box on the employee profile page (such as shown in FIGS. 18 and 23) to ensure that the employee does not already have leave scheduled for the time period (or part of the time period) during which the user would like schedule a new leave.

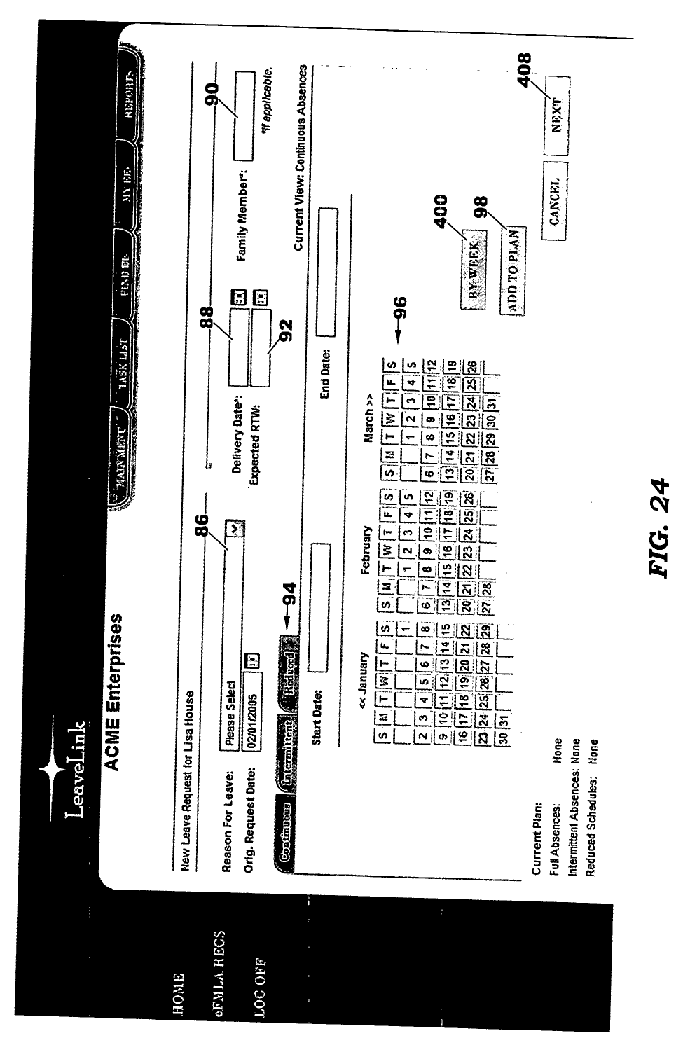

To request a new leave for an employee from the Employee Profile screen, the user clicks the New Leave button 62 (step 156) as shown in FIG. 23. The New Leave Request screen will appear as shown in FIG. 24 (step 168). The user selects why the employee is requesting leave by selecting an option from the “Reason for Leave” drop-down menu 86 (step 194). In the preferred embodiment, the drop-down list 86 is created dynamically based upon the policies that apply to the employee's location. If the reason for leave is not displayed in the list 86, then it is not covered by any policies. The user selects the “Other” reason from the drop-down list 86 and the system will deny this request because it is not a covered reason. The user can document the specific reason for leave in the denial process.

If the reason for leave is Pregnancy or Pre-Natal Care (step 196), then the user must enter an expected due date in the “Delivery Date” field 88 (step 198). The user can use the pop-up calendar to select the date. If the reason for leave is Child's Serious Health Condition, Spouse's Serious Health Condition or Parent's Serious Health Condition (step 200), then the user must enter the person's name in the “Family Member” field 90 to distinguish between the employee's leaves (step 202). The “Original Request Date” field is preferably defaulted to the current date. The user may change the date by entering a new date or selecting a date using the pop-up calendar feature. If known, the user can enter the date the employee is scheduled to return to work in the “Expected RTW” field 92 (step 204). The tabbed portion 94 of the screen allows the user to enter the three different types of leave that the FMLA regulations authorize: continuous, intermittent or reduced schedule.

Continuous Leave

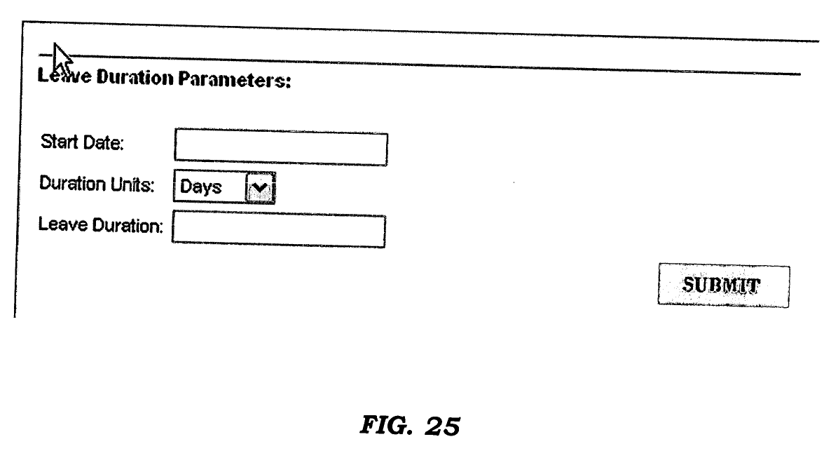

To schedule a block of continuous leave (step 206) the user selects the start and end dates on the calendar 96 or enters the dates in the fields provided (step 208), and clicks the Add to Plan button 98 (step 210). The selected dates appear under the current plan section of the screen. The user can add another block of continuous leave the same way, or add intermittent or reduced schedule leave. Alternatively, the user may click the By Week button 400 and a pop-up window will appear asking for the start date and duration of the leave as shown in FIG. 25. The user enters the start date and selects the duration unit from the dropdown list. The default unit is “days.” The user enters the numerical duration of the leave (e.g., if the employee is taking seven days, enter 7), and clicks the Add to Plan button 98 (step 210). If no end date is provided, the leave duration preferably defaults to 30 days. The selected dates will appear under the current plan section of the screen. The user can add another block of continuous leave the same way, or add intermittent or reduced schedule leave.

Intermittent Leave

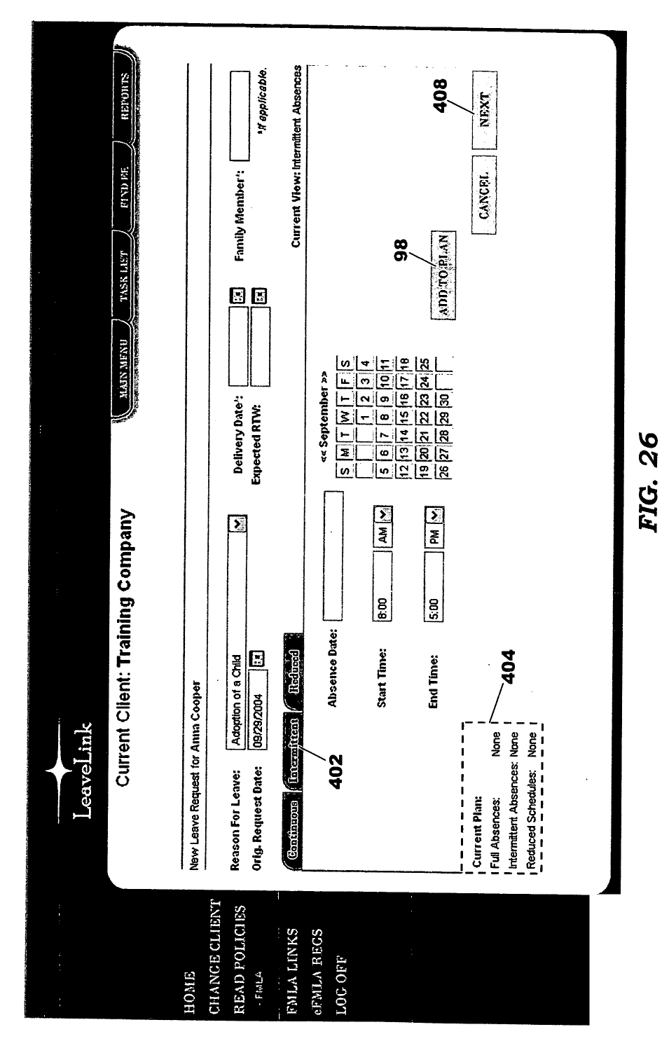

As shown in FIG. 26, to enter intermittent leave dates the user clicks the Intermittent tab 402 (step 212). The user clicks the appropriate date on the calendar or enters the date, and enters the start time of the absence and the end time of the absence (step 214). The system 10 then calculates the time taken based on the time worked and the employee's work schedule (step 216). If the user doesn't know the exact times of the absence, the user enters a time period that approximates the employee's time off. The user clicks the Add to Plan button 98 (step 218). The intermittent absence will appear under the current plan section 404 of the screen. The user can add another block of intermittent leave the same way, or add continuous or reduced schedule leave.

Reduced Schedule Leave

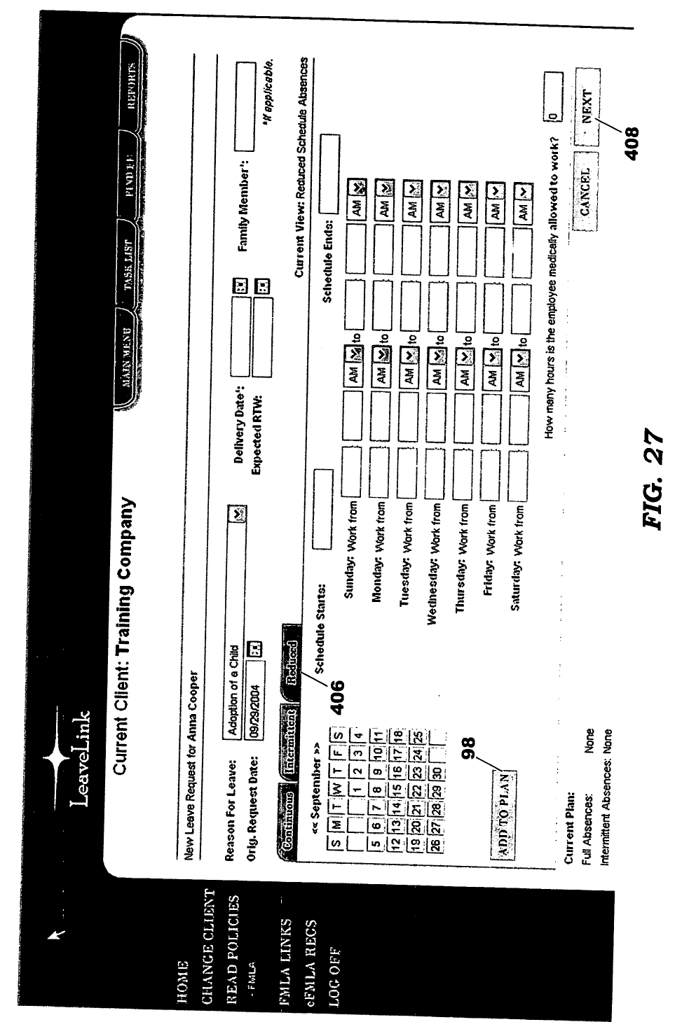

As shown in FIG. 27, to enter reduced schedule leave the user clicks the Reduced tab 406 (step 220). Unlike the other tabs, the user here enters the employees scheduled work hours rather than hours missed on this tab. The user selects the reduced schedule start and end dates on the calendar or enters the dates in the fields provided (step 222). The user enters the start and end times for each day the employee is schedule to work (step 224), and clicks the Add to Plan button 98 (step 226). The reduced schedule leave will appear under the current plan section of the screen. The user can add another block of reduced schedule leave the same way, or add continuous or intermittent leave. After the user has entered all of the planned absences for the employee's leave, the user clicks the Next button 408 to proceed (step 228).

Canceling Conflicting (Duplicate) Planned Absences

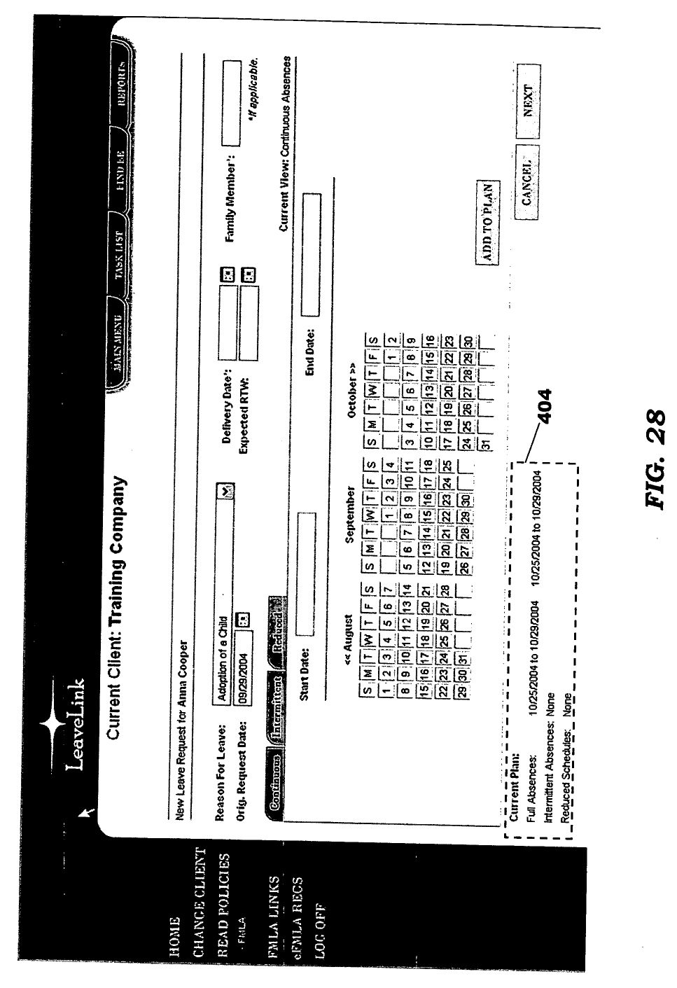

When entering the dates for a new leave, the user checks under current plan 404 at the bottom of the screen (as shown in FIG. 28) to ensure that none of the dates for a particular type of absence (full, intermittent, or reduced) overlap. If there are overlapping dates entered, the user clicks on the dates under current plan that the user wishes to cancel. A box will pop up asking the user if the user is sure the user wishes to cancel the planned absence(s). If so, the user clicks the OK button.

STD/WC Intake Screen

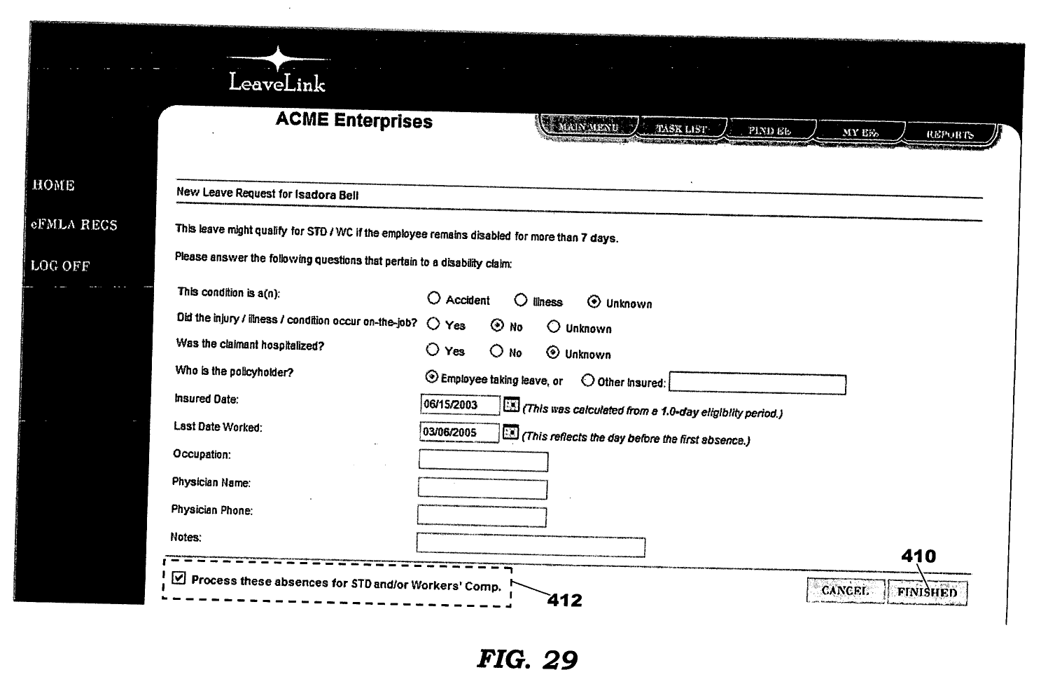

If the reason for the requested leave is the employee's own serious health condition (SHC), pregnancy/prenatal care or post-delivery disability (step 230) and the employer's short-term disability (STD) policy and/or workers' compensation (WC) policy applies (step 232), then a STD/WC intake screen is provided (step 234) as shown in FIG. 29. In the preferred embodiment of the invention, this screen is used to gather information to send to third-party STD and WC providers, and to determine which policy (STD or WC) may apply. If the client (employer) does not have a STD and/or WC policy in the employer's system, the STD/WC intake screen is bypassed.

To complete the STD/WC intake screen, the user indicates if the employee's condition is an accident or illness (step 236) and whether the accident/illness occurred on the job (step 238). Using this information, the system 10 determines whether STD or WC should be applied. The user indicates if the employee was hospitalized, or if it's unknown (step 240). The system 10 uses this information to determine elimination period qualifications for STD. The user indicates whether the insured policyholder is the employee taking leave or another insured person (step 242). If another insured person, the user enters the name of the person in the associated field. The user verifies the insured date of the employee or enters the correct data (step 244). The user verifies the last date worked or enters the correct data (step 246), and enters the employee's occupation or enters the correct data (step 248). The user enters the physician's name and phone number, if known, and enters any associated notes (step 250). Once the user has entered the applicable information, the user clicks the Finished button 410 (step 252). If the user does not wish to process the entered absences for STD and/or WC, the user clicks the option 412 at the bottom of the screen.

Two-Week Scheduler

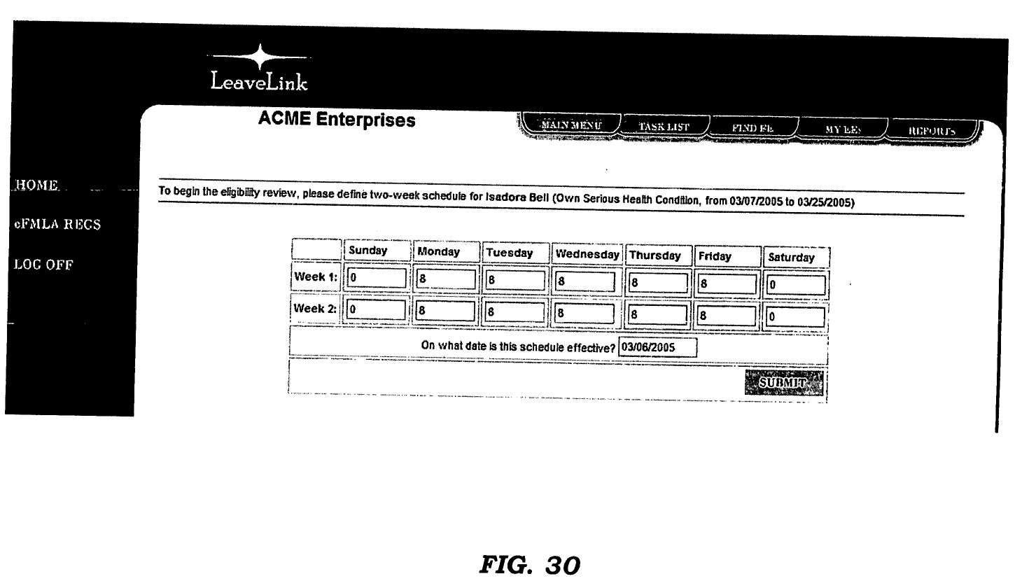

Next, the system 10 provides a screen as shown in FIG. 30 for the user to enter the employee's two-week schedule (step 254). The schedule defaults to 8 hours a day, Monday through Friday for both weeks. It also defaults the beginning date of the schedule to the Sunday prior to the first day of leave requested. To change the employee's schedule, the user enters the hours scheduled on each day and verifies the schedule begin date or enters a new date (step 256). Once the weeks accurately reflect the employee's schedule, the user clicks the Next button (step 258).

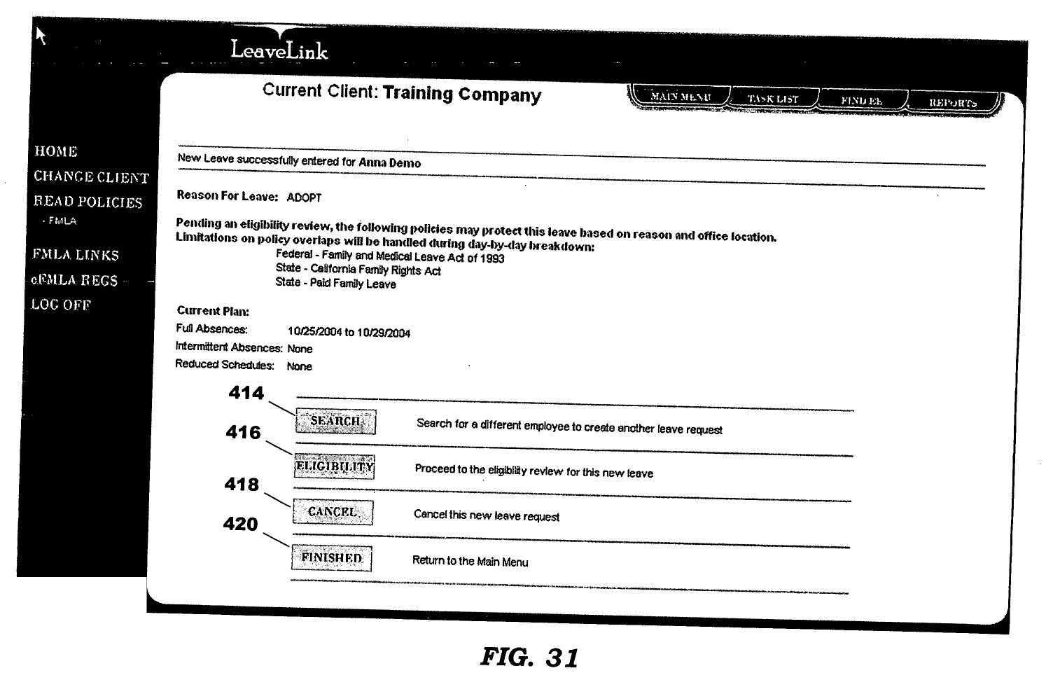

As shown in FIG. 31, the system 10 next provides a leave request completion screen (step 260). This screen provides the user four options: search for a different employee (Search button 414), proceed to the eligibility review for this leave (Eligibility button 416), cancel the leave (Cancel button 418) and return to the Main Menu (Finished button 420).

Eligibility Review

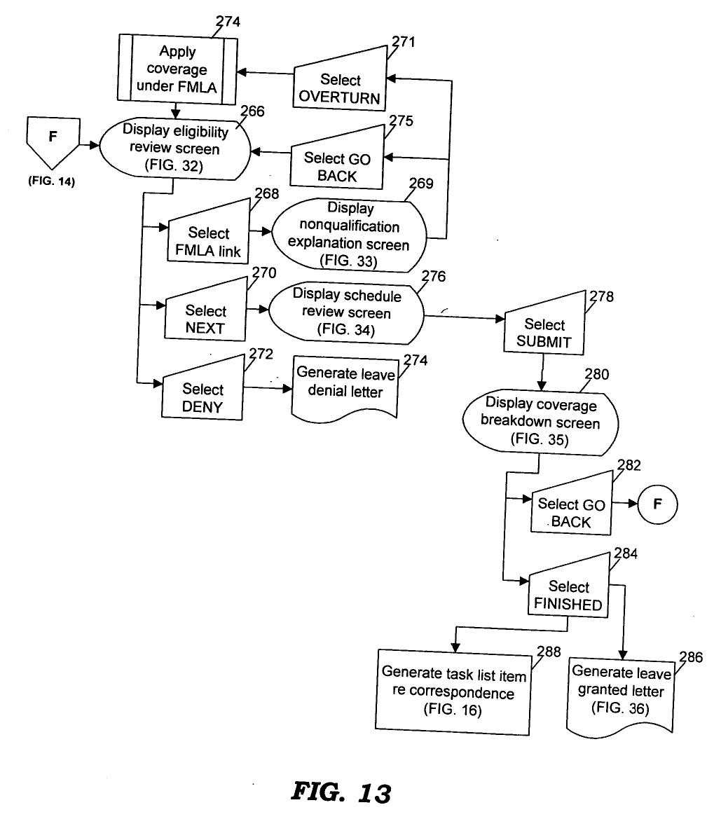

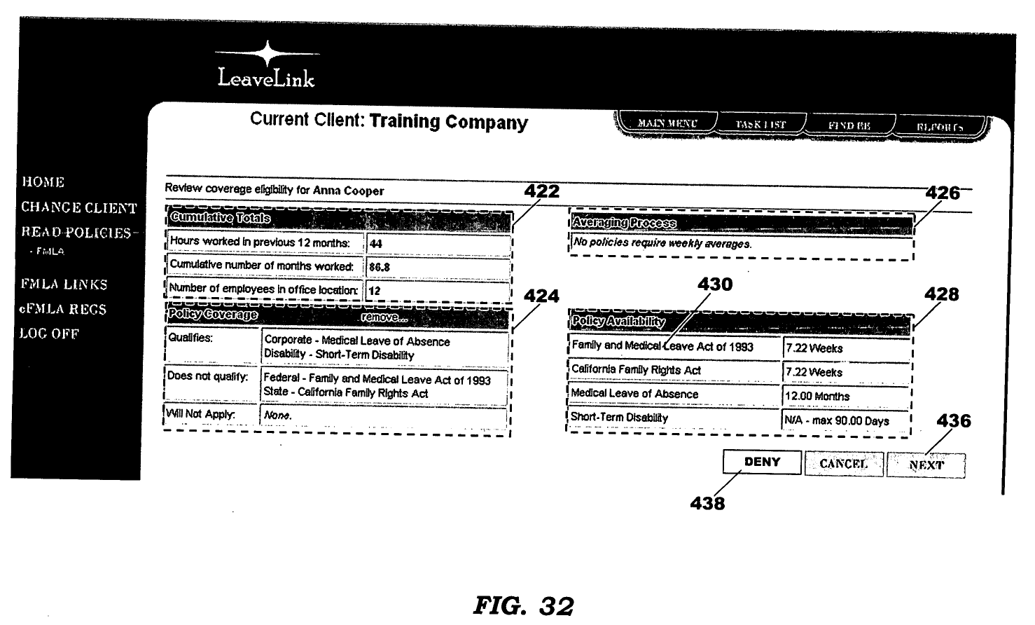

By clicking the Eligibility button 416 (step 264), the system 10 provides an eligibility review screen (step 266 in FIG. 13) to review an employee's leave eligibility. As shown in FIG. 32, this screen includes four areas of information: Cumulative Totals 422, Policy Coverage 424, Averaging Process 426 and Policy Availability 428. The Cumulative Totals section 422 shows the user the calculations for the employee's hours worked in the previous 12 months, the cumulative number of months worked, and the number of employees at the office location.

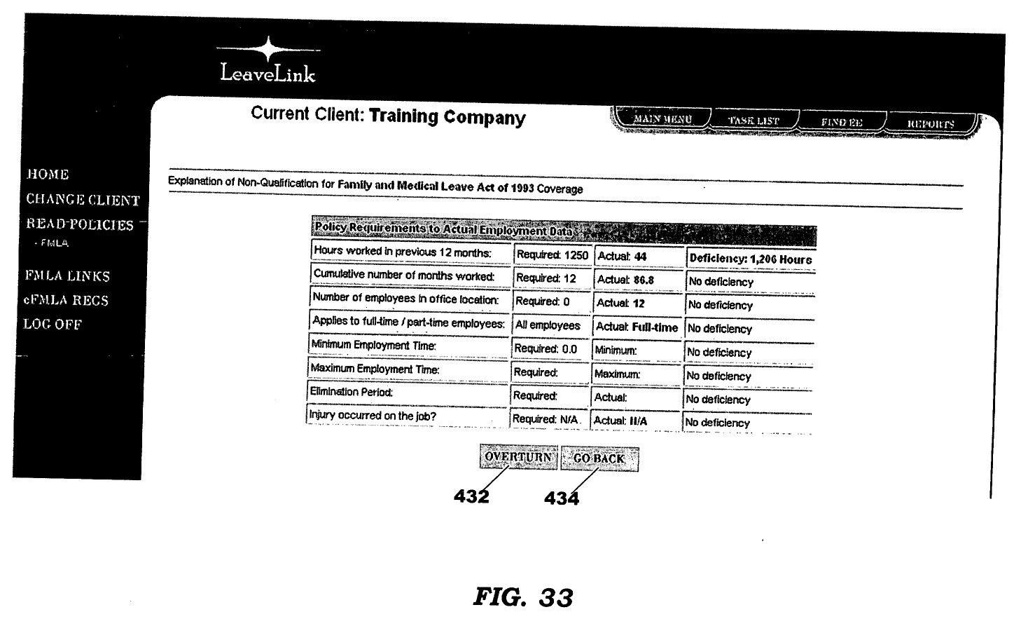

The Policy Coverage 424 section displays the policies that apply to the reason why the employee is taking leave, and determines if the employee qualifies or does not qualify for each policy. As shown in FIG. 32, the screen indicates that the employee does not qualify for leave under the federal FMLA or the California Family Rights Act (CFRA). To view the information the system 10 used to make this determination for FMLA, the user clicks the “Federal-Family and Medical Leave Act of 1993” link 430 (step 268). In response, the system 10 provides the Explanation of Non-Qualification screen will appear as shown in FIG. 33 (step 270). The policy requirements listed on this screen reflect the policy configuration. If the user knows that an employee really does meet the requirements for the policy, the user clicks the Overturn button 432 (step 271) to proceed with applying coverage under this policy (step 274). The user can follow the same process for each policy. If more than one deficiency exists, the employee must meet the requirements for all deficiencies for the user to overturn policy coverage. The overturned policies will appear as qualified when the user returns to the screen. In the preferred embodiment, all overturned denials are tracked as part of the auditing process. If the user does not want to overturn the determination, the user may click the Go Back button 434 (step 275).

With reference to FIG. 32, the Averaging Process section 426 of the eligibility review screen includes calculated values, if required by a leave policy and the user has a time and attendance import. Otherwise, default values of 40 hours and 5 days are displayed. This calculation determines proper leave entitlement.

The Policy Availability section 428 of the screen shows the employee's available time under each policy that might apply to this leave.

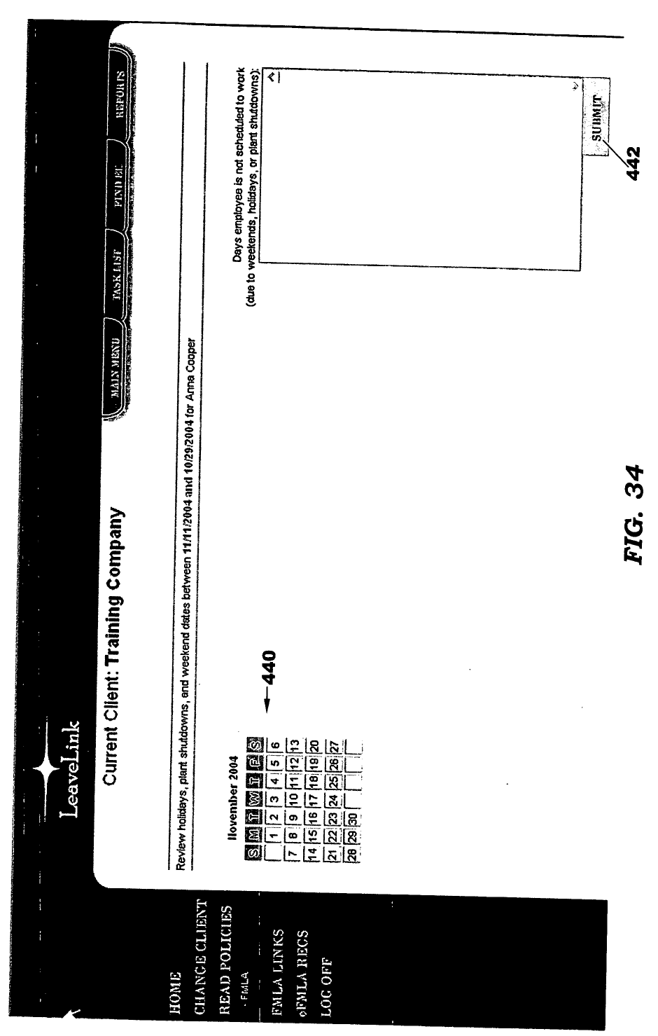

To proceed with the leave request process, the user clicks the Next button 436 (step 270). If an employee is not eligible for coverage under any of the applicable policies, the user clicks the Deny button 438 (step 272), the leave will be denied and the leave denial letter will be generated (step 274). If the employee is eligible for at least one policy, a screen as shown in FIG. 34 will appear for the user to verify the employee's schedule (step 276), including holidays, weekends and plant shutdowns. If the user needs to add days that the employee is not scheduled to work, the user clicks on the date on the calendar that the user would like to add. To proceed, the user clicks the Submit button 442 (step 278).

Coverage Breakdown

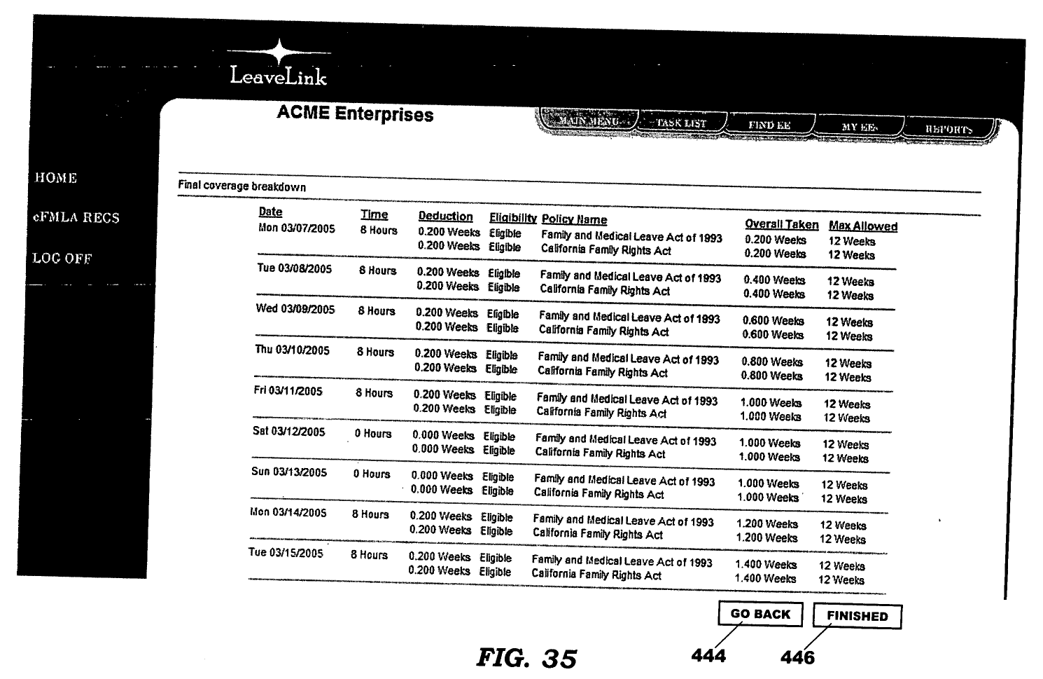

At this point, the system 10 displays the final coverage breakdown screen (step 280). As shown in FIG. 35, the final coverage breakdown screen shows the user each absence date, the hours taken per day, the applicable policies, amount taken per day, overall deductions and maximum amount allowed. The starting count for overall deductions reflects the employee's previous leave balance. If something needs to be changed, the user can click the Go Back button 444 (step 282) to return to the eligibility review screen (step 226). If the user confirms that no changes are needed, the user clicks the Finished button 446 at the bottom of the screen to proceed (step 284).

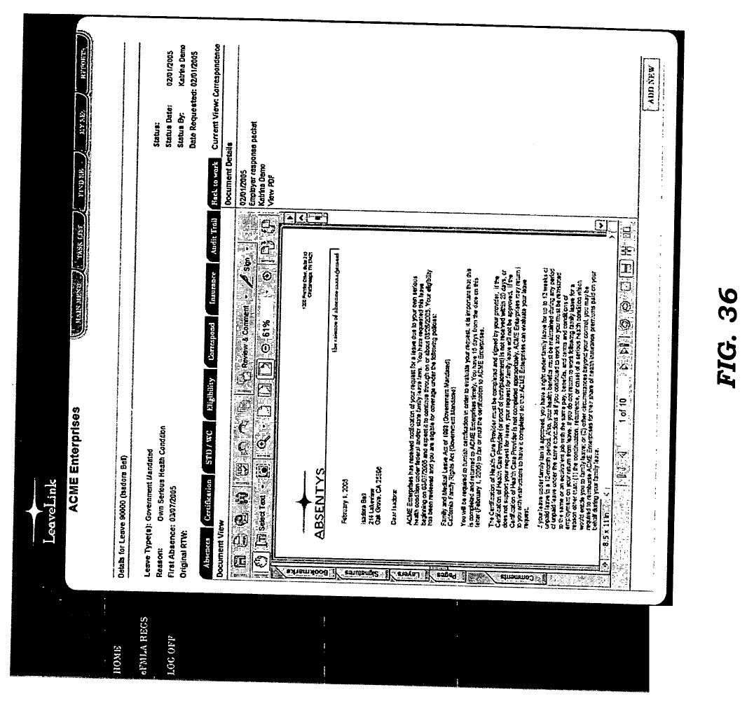

At this point, the system 10 generates and displays the appropriate correspondence packet for the user to print, such as in portable document format (step 286). An example of such correspondence is depicted in FIG. 36. An item will also appear on the user's task list (see FIG. 16) to remind the user to print and mail the correspondence (step 288). The user can print the letter by clicking on the link in the user's task list. Preferably, printing the letter does not cause this task item to be automatically removed from the user's task list. Once the user has mailed the correspondence, the user clicks the checkbox in the “Done” column beside the task and clicks the Update button. This removes the item from the task list and records the mailing date in the audit trail.

At this point, the preferred embodiment also certifies an audit history of the eligibility review process.

Bypass Generating Tasks and Correspondence for Sick Leave

In a preferred embodiment of the invention, a bypass button is dynamically added to the Eligibility Review screen when administrators review leaves that do not typically require certification to approve the absences. For example, Personal Leaves, Sick leaves (less than 3 days), or Vacation leaves are examples of the leave types that could be “bypassed”. By using this button, all absences are entered into LeaveLink with “approved” status, indicating that the leave needs no further documentation/certification to validate it. Also at that time an approval letter is generated for distribution to the employee, outlining his authorized leave of absence. Preferably, there are no certification or reminder tasks created for “bypassed” leaves except for an “Employee scheduled for RTW” created on the administrator's task list on the last date of leave.

Leave Details Screen

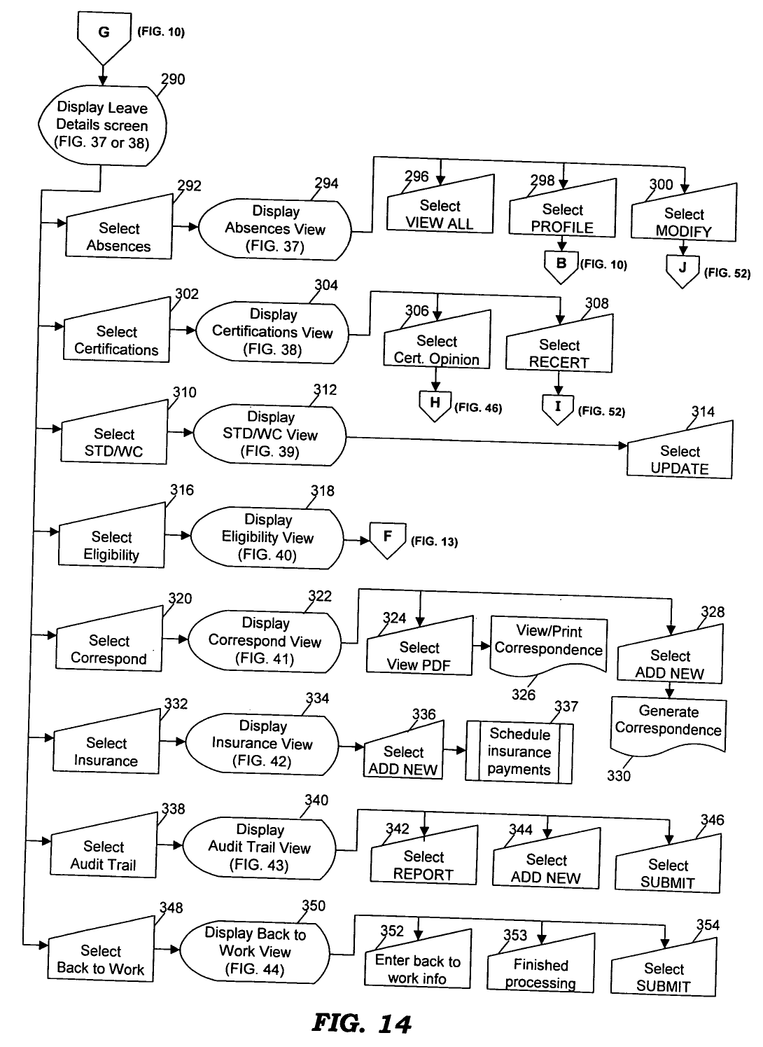

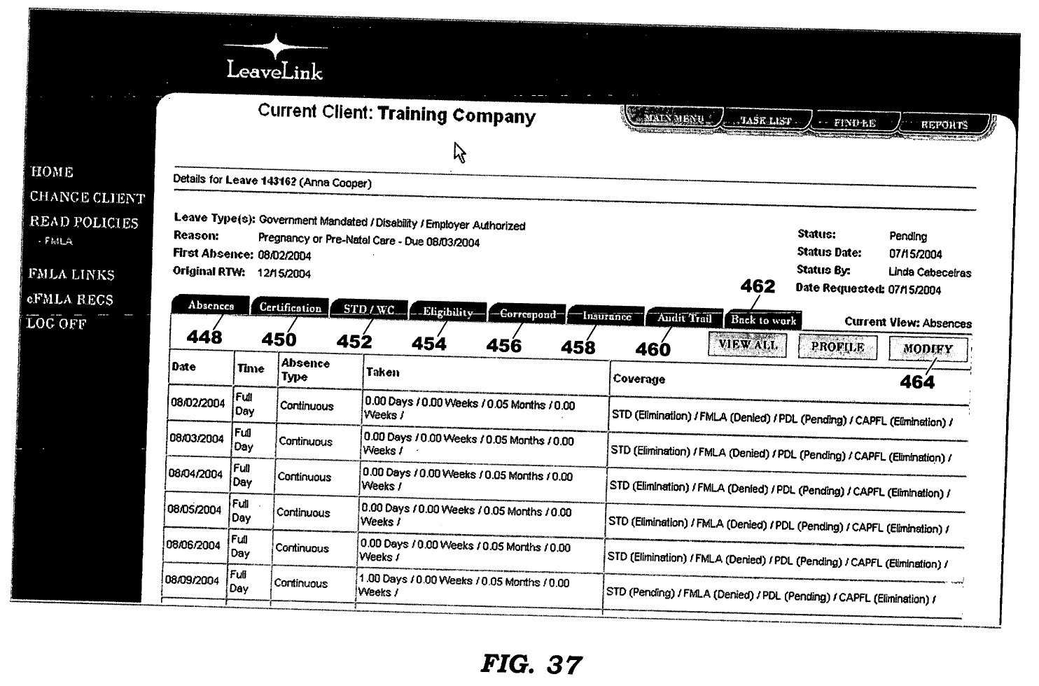

The system 10 generates the Leave Details screen (step 290 in FIG. 14) when the user clicks on the associated leave number 58 (step 166 in FIG. 10) in the Employee Profile screen (see FIG. 18). As shown in FIG. 37, the Leave Details screen contains all the information about a leave in one place. At the top of the Leave Details screen, the leave number, leave type(s), reason for leave, first absence and original return to work are displayed. The user can also view the status of the leave, status dates, who created the latest status and the date the leave was requested. In the preferred embodiment of the invention, there are eight tabs on this screen: the Absences tab 448, the Certification tab 450, the STD/WC tab 452, the Eligibility tab 454, the Correspond tab 456, the Insurance tab 458, the Audit Trail tab 460 and the Back to Work tab 462.

When the Absences tab 448 is selected (step 292), the Absences View is displayed (step 294) which lists each date associated with the leave, the time taken, absence type, the amount taken and the policy coverage. (See FIG. 37.) The user can edit or cancel a single day by clicking on its date in the list. The user can edit other areas of the leave by clicking the Modify button 464 (step 300).

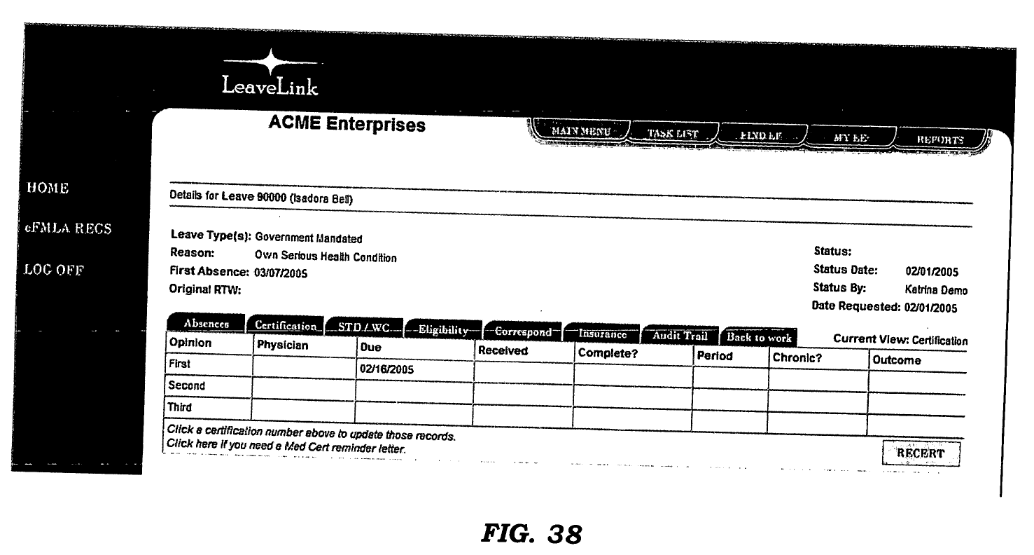

When the Certification tab 450 is selected (step 302), the Certification View screen is displayed (step 304) as shown in FIG. 38. Using this screen, the user can access medical certification opinions (step 306) and recertification records (step 308). (See FIG. 38.) To access a certification record, the user clicks the appropriate opinion number (first, second, third) in the list. Once a certification has been received, the physician name, received date, time period and outcome will be listed along with an indication whether it is complete or certifies a chronic serious health condition.

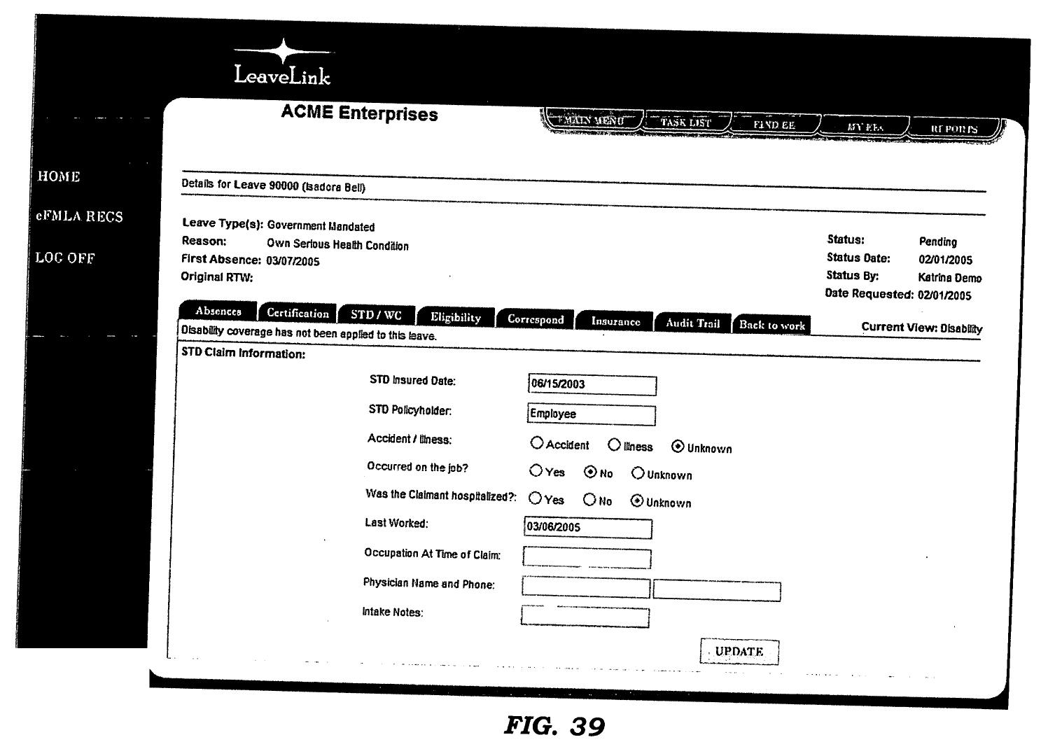

When the STD/WC tab 452 is selected (step 310), the STD/WC View screen is displayed (step 312) as shown in FIG. 39. Using this screen, the user may update information received regarding short-term disability or workers' compensation as it applies to the leave (step 314). It also shows the information the user entered during the leave request process.

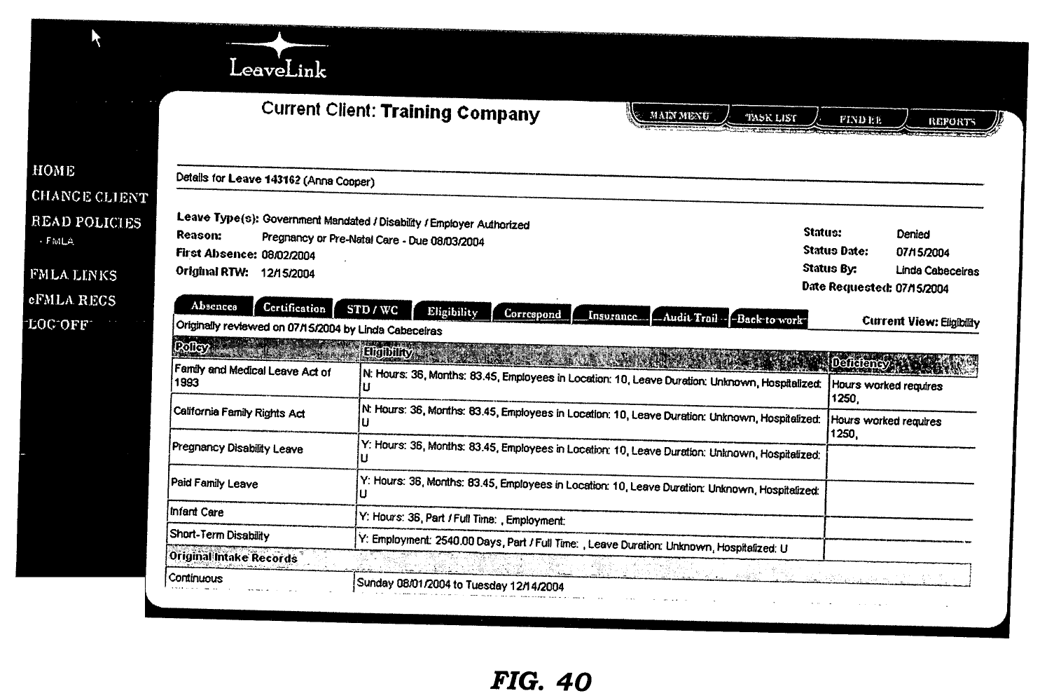

When the Eligibility tab 454 is selected (step 316), the Eligibility View screen is displayed (step 318) as shown in FIG. 40. This screen provides information regarding the calculations used to determine the employee's eligibility for each applicable policy. It shows the policy name, calculated values and any deficiencies.

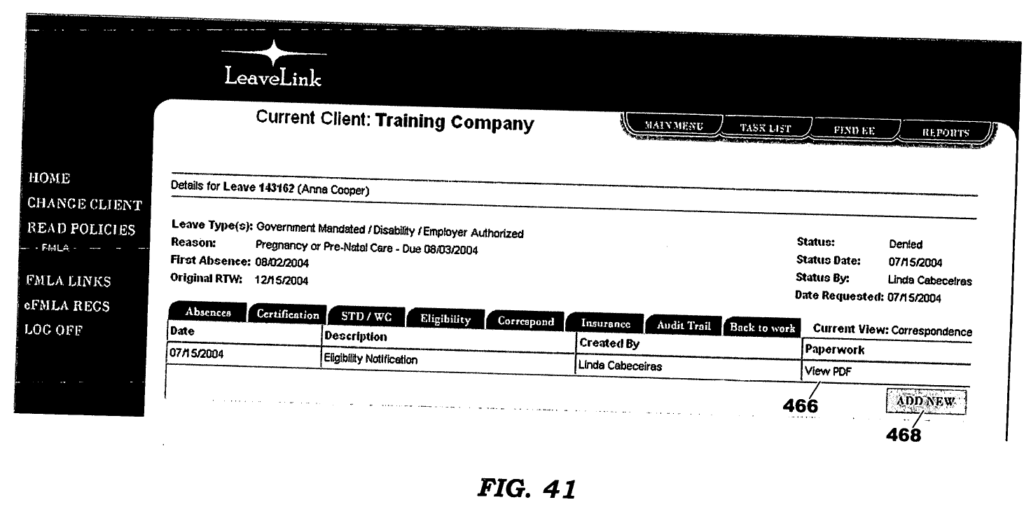

When the Correspond tab 456 is selected (step 320), the Correspond View screen is displayed (step 322) as shown in FIG. 41. This screen provides a list of all correspondence that has been generated for the current leave. When the user clicks the View PDF link 466 (step 324), the system displays the selected correspondence and provides the user means to print it, such as by using Adobe Acrobat (step 326). Additional correspondence may be generated if it is tied to a leave. To generate new correspondence, the user clicks on the Add New button 468 (step 326), selects the correspondence the user would like to generate and clicks the Submit button to generate the correspondence (step 330).

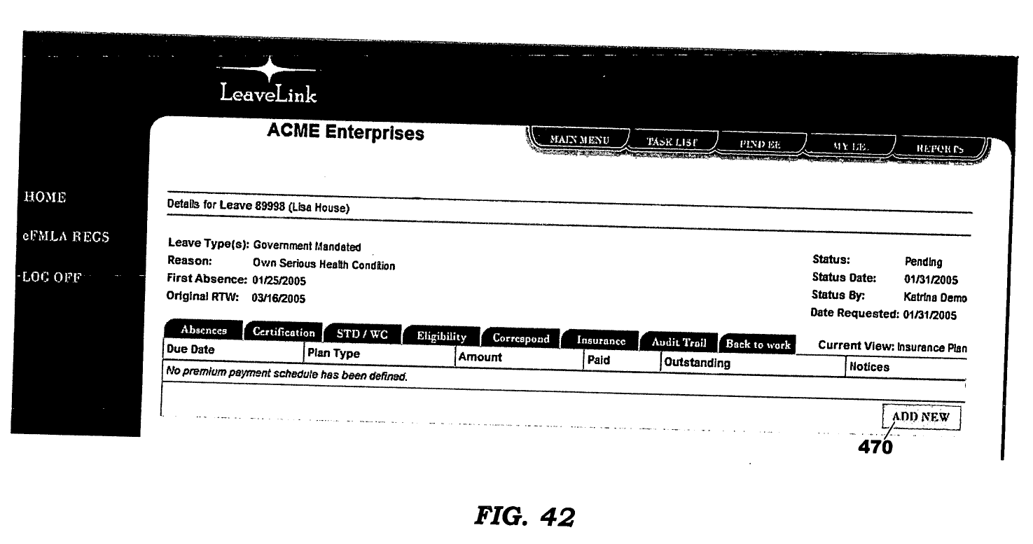

When the Insurance tab 458 is selected (step 332), the Insurance View screen is displayed (step 334) as shown in FIG. 42. Using this screen, the user may establish an insurance premium payment plan for an employee on unpaid leave. Once a payment plan is created, information regarding the plan appears on this screen. To create an insurance premium payment plan, the user clicks the Add New button 470 (step 336), selects from a dropdown list the method by which the payment will be made, and enters information regarding the payment plan. Generally, the required information will vary depending on how the payment is to be made. The system 10 schedules the payments when the user clicks the Submit button (step 337).

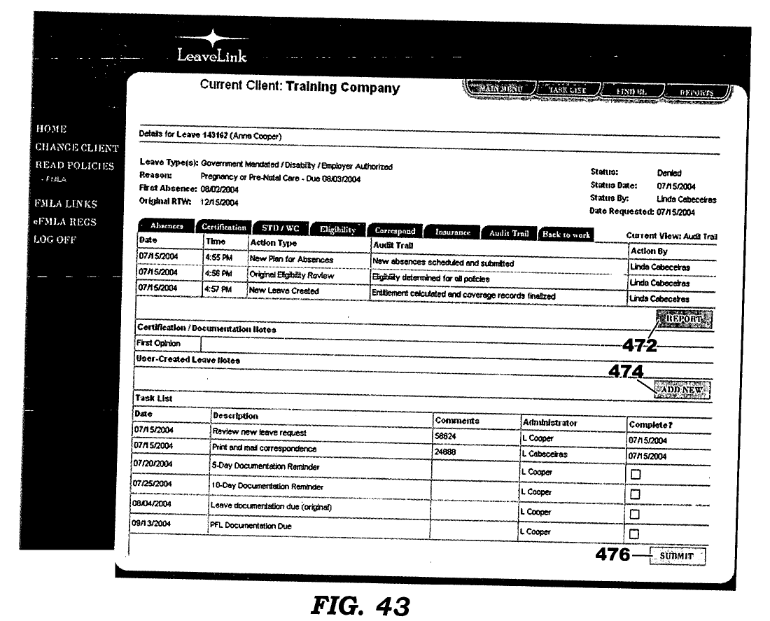

When the Audit Trail tab 460 is selected (step 338), the Audit Trail view screen is displayed (step 340) as shown in FIG. 43. On this screen, the system 10 provides a comprehensive list of all actions taken, certification notes, user created leave notes, and tasks associated with the leave. The first section of the screen is system-generated and lists each step in the leave process, from request to closure, along with the date and time it occurred and who did it. The user can create a Leave Activity/Audit Trail report by clicking the Report button 472 (step 342).

The second section contains any notes that were entered on the medical certification screen. The third section of the screen contains user created leave notes. The user can add information about a leave here by clicking the Add New button 474 (step 344). Each entry is date and user stamped. The fourth section of the screen contains a list of all tasks associated with the leave, the date due, the date completed, and who completed it. The user can complete a task on this screen by clicking the appropriate check box in the “Complete?” column and clicking the Submit button 476 (step 346).

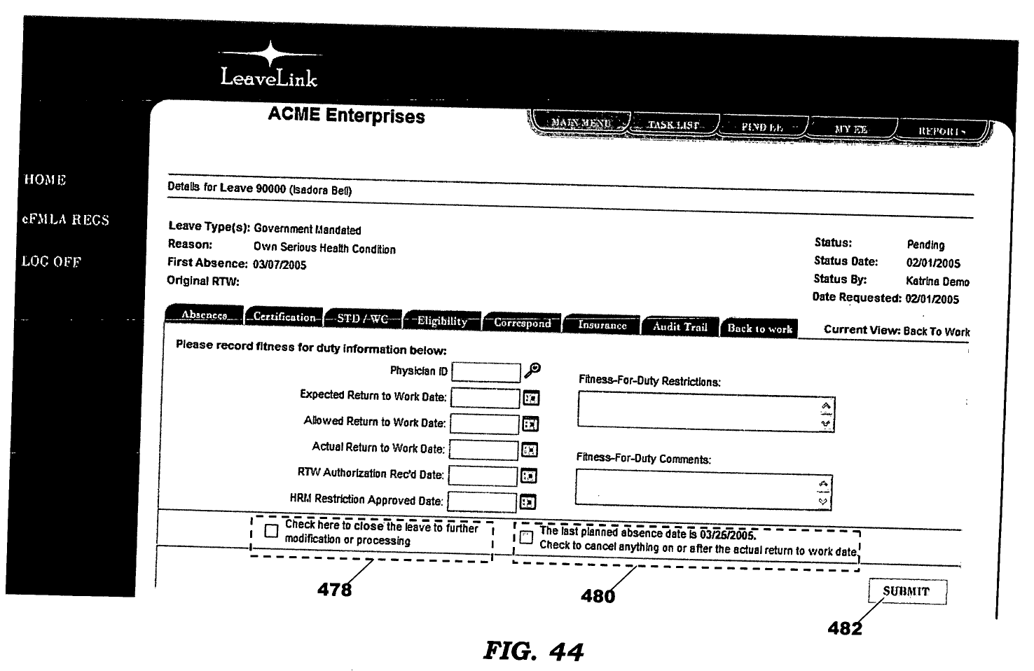

When the Back to Work tab 462 is selected (step 348), the Back to Work view screen is displayed (step 350) as shown in FIG. 44. In this screen, the system 10 provides the user means to enter information regarding when an employee returns to work from leave (step 352). The “Physician ID” number for the health care provider that submitted the medical certification will be displayed. The user can change this by selecting another physician using the search feature or adding a new physician. The user can enter the “Allowed Return to Work” and “Actual Return to Work” dates. If there are any restrictions or comments on the fitness-for-duty certification, then the user can enter them in the appropriate fields.

The user can close the leave to further processing by clicking that option 478 at the bottom of the screen. If the actual return to work date is prior to the last scheduled absence, the user can delete any absences after the actual return to work date by clicking that option 480 at the bottom of the screen. The user clicks the Submit button 482 to process the entries (step 354). The user can then use the Absences tab 448 to review the dates associated with the leave. If the appropriate days are not cancelled, the user clicks on the day and cancels that absence.

Certifying a Leave

In the preferred embodiment, a leave request must be present in the system 10 before a certification record can be created. When the user receives a medical certification form back from an employee or the employee's physician, there are several ways to access the medical certification screen to certify that the requested leave is medically necessary. For example, from the Task List (FIG. 16) the user may click the “Leave documentation due” task on the My Tasks or Coming Soon tab and then click the associated link for the medical certification. From the home page (FIG. 15), the user can click the Find EE tab or the Manage Absences & Certify Leaves option. A search screen will appear in which the user can enter information to find the employee's record. When the user clicks the Submit button, a list of employees matching the user's search criteria will appear under the entry fields. The user then clicks on the employee's name to access the employee's employee profile screen, examples of which are depicted in FIGS. 18 and 23. In the employee profile screen, the user clicks the associated leave number 58 in the “Leave Summary” section and then clicks the Certification tab 450 in the leave details screen (FIG. 37). In the certification view (FIG. 38), the user clicks the associated link for the medical certification (first, second or third opinion)(step 306 in FIG. 14) or the RECERT button to process a recertification form (step 308 in FIG. 14).

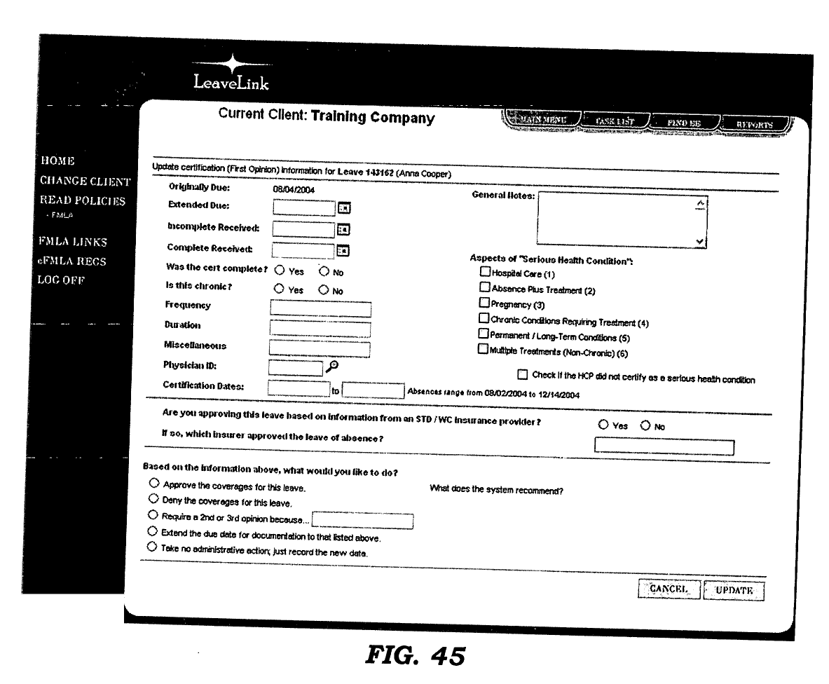

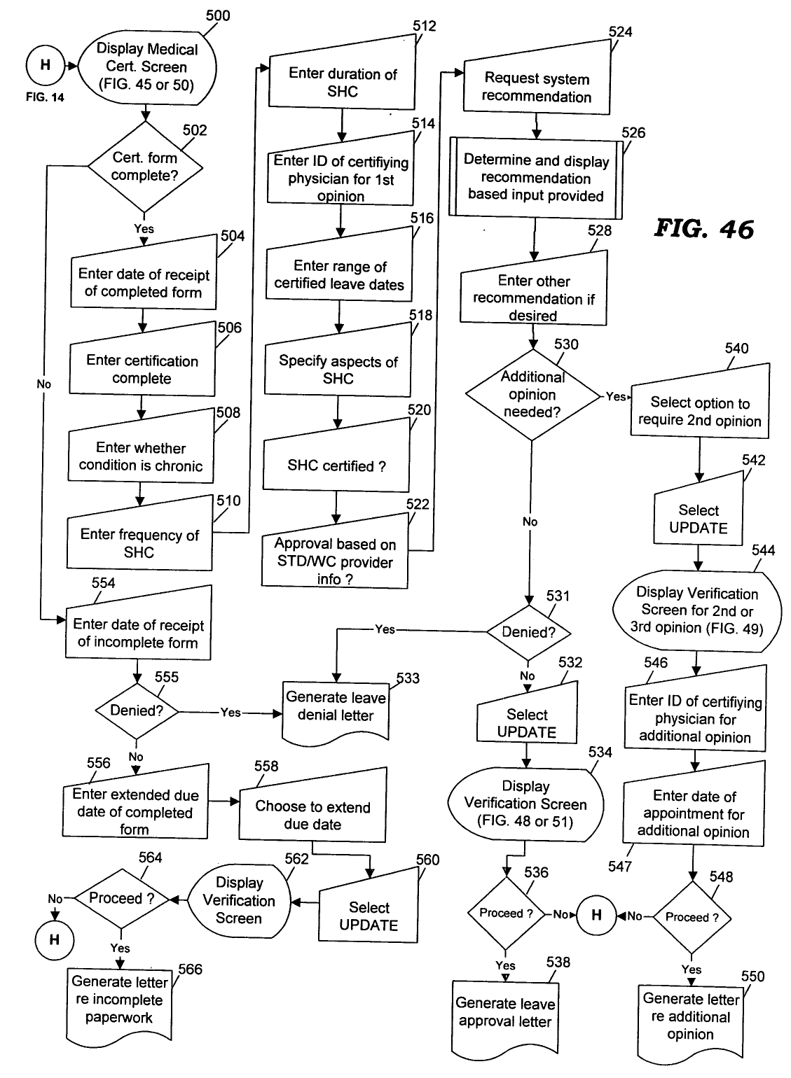

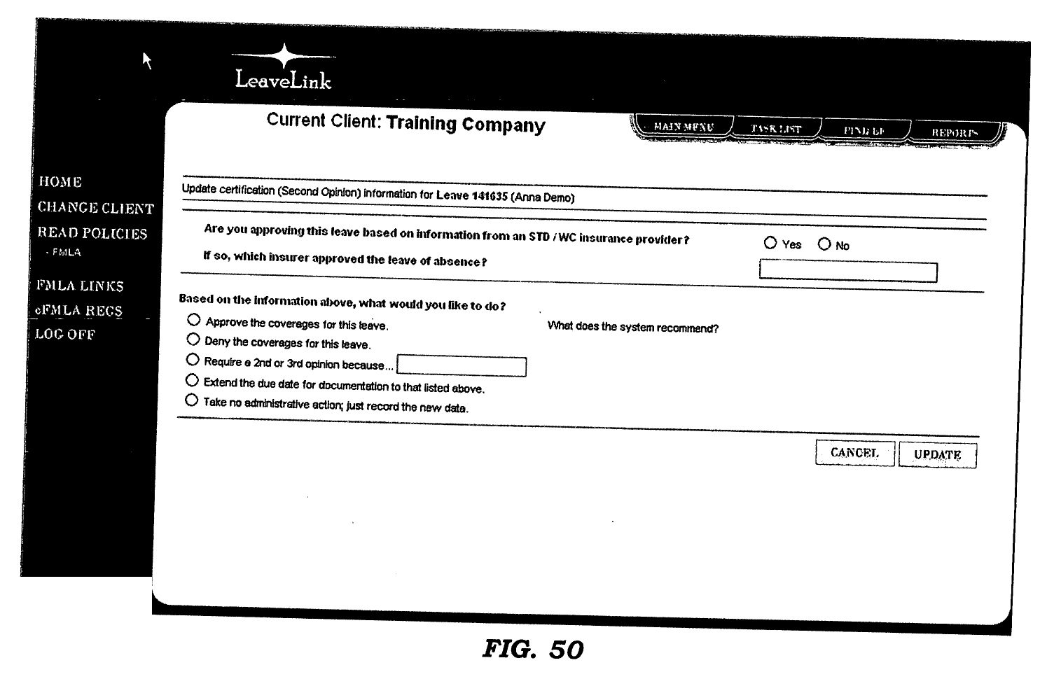

In the preferred embodiment of the invention, the system 10 receives and provides information regarding medical certification of leave requests through the medical certification screen, examples of which are shown in FIGS. 45 and 50. FIG. 45 depicts the situation wherein a medical certification is processed based on a first opinion, and FIG. 50 depicts the situation wherein a medical certification is processed based on a second opinion. FIG. 46 depicts a flow diagram representing an exemplary process for receiving, recording and processing data related to medical certifications. For purposes of this description, a “medical certification form” is a form completed by an employee and the employee's physician documenting the existence of a medical condition and whether the nature of the condition requires the employee to miss work to recover. As set forth in more detail below, the medical certification screen provides an interface for:

(1) recording receipt of a complete medical certification form and approving or denying leave based on the form;

(2) recording the receipt of an incomplete medical certification form, entering a new due date for a completed form and generating a letter outlining the employee's responsibilities in that regard;

(3) recording the receipt of a compete medical certification form and requesting another physician's opinion;

(4) extending the due date to give the employee more time to return a completed medical certification form;

(5) denying requested leave because the employee never returned the medical certification form; and

(6) entering notes or recording information without taking any further action.

In a first example situation, the user has received a complete certification from the employee or the employee's physician, and the user does not need to request a second opinion. FIG. 46 depicts steps implemented in a preferred embodiment of the invention to process a medical certification in this situation. Once the system 10 has displayed the medical certification screen (step 500), such as by one of the paths discussed above, the user enters the date that the form was returned in the “Complete Received” field (step 504), selects the “Yes” option for “Was the cert complete?” (step 506) and checks “Yes” or “No” to indicate whether the physician determined the illness to be a “chronic serious health condition” (step 508). The user also enters the frequency of the serious health condition in the “Frequency” field (step 510) and the duration of the serious health condition in the “Duration” field (step 512).

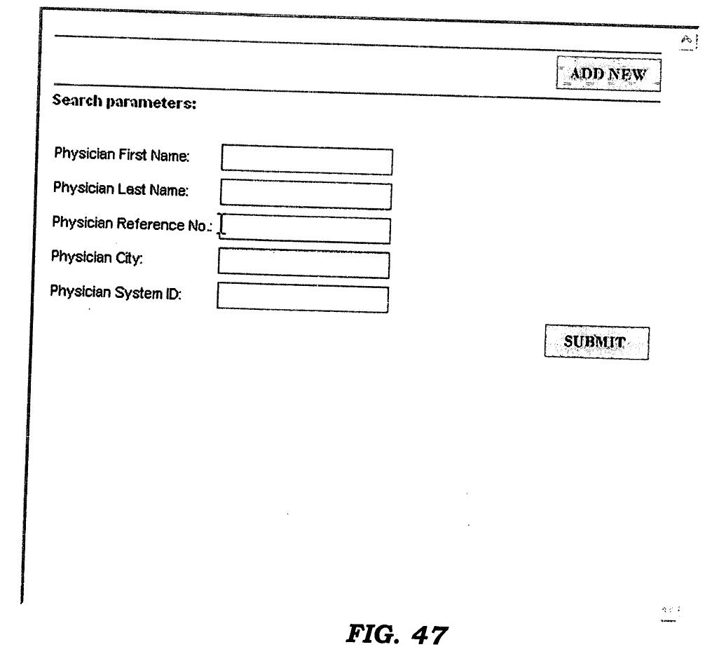

The user then enters the physician ID number of the certifying physician using the “Physician ID” field (step 514). If the user does not know the number, the user may search for the physician in the system database using the search icon. When the search icon is clicked, a search screen will appear as shown in FIG. 47 in which the user may enter any or all of the physician's name, reference number, city or system ID. A list of physicians matching the user's search criteria will appear. If the employee's physician appears in the list, the user clicks his/her name. If the physician's name does not appear in the list, the user clicks the Add New button and a screen will appear for the user to enter the information about the physician. A screen will appear displaying the physician's ID number to be entered in the “Physician ID” field.

The user next enters the leave dates for which the physician certified the serious health condition in the “Certification Dates” fields (step 516). These fields default to the leave dates requested by the employee. The user can change those dates by clicking on the date links provided to the right of the “Certification Dates” field. The user may enter any notes or comments about the certification in the “General Notes” field. The user then selects the applicable aspects of the employee's serious health condition based on the information the physician provided on the medical certification form (step 518), or checks the box indicating the physician did not certify a serious health condition (step 520).

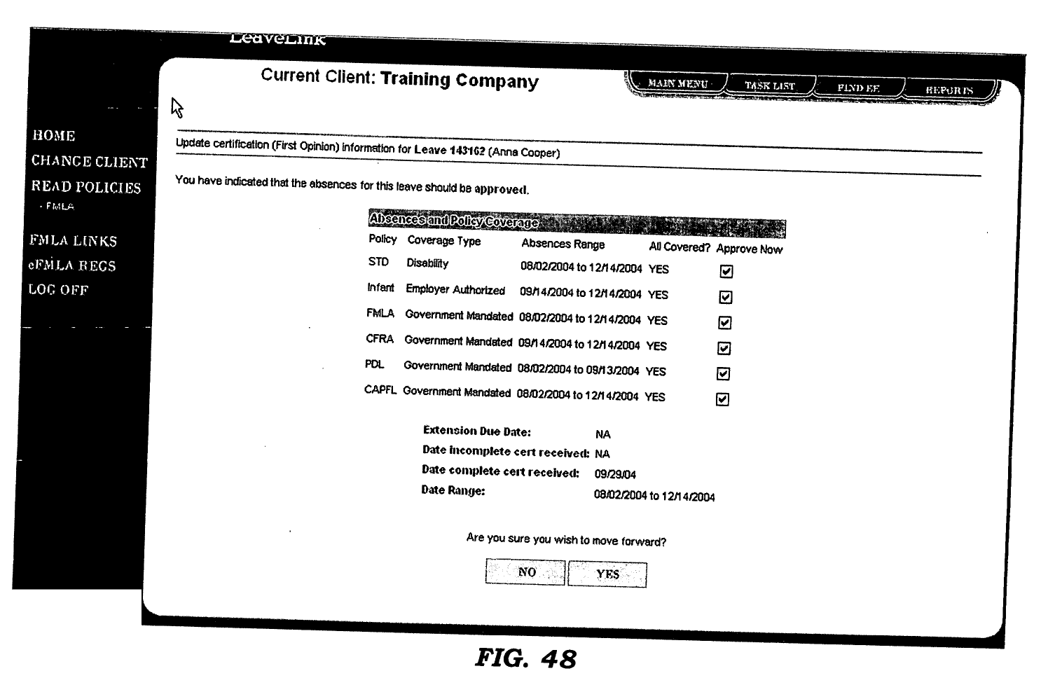

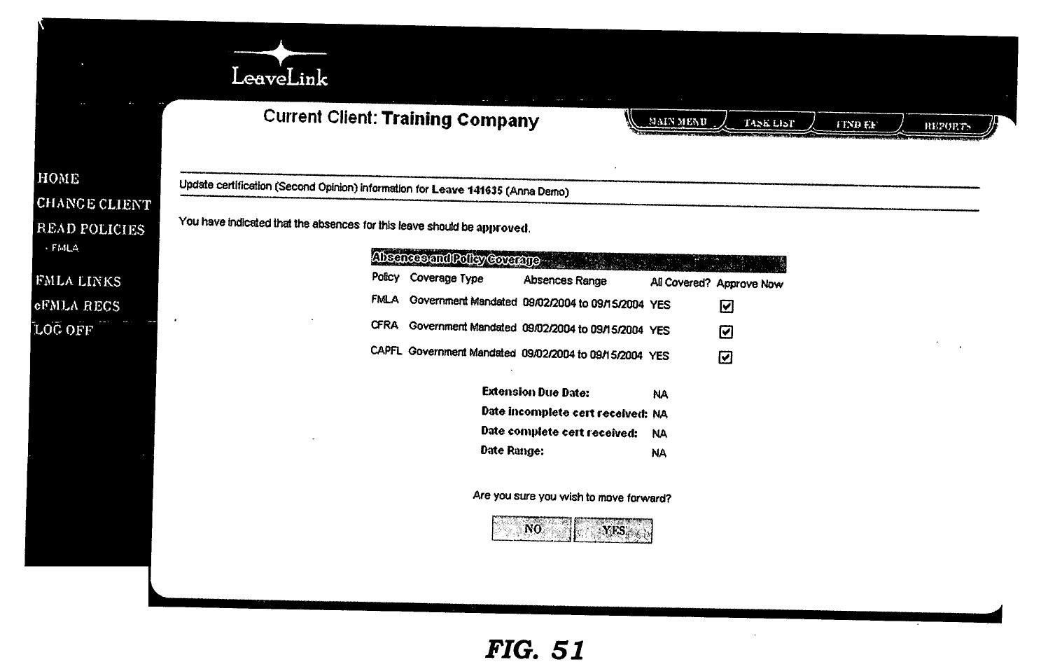

The user indicates whether the user is approving the leave based upon information from an STD/WC provider by clicking the “Yes” or “No” option (step 522). When the user clicks the link “What does the system recommend?” (step 524), the system 10 verifies that all required information has been entered and then determines and displays a recommendation based on the information provided (step 526). The user can overturn the system's determination by clicking a different option (step 528). If no additional opinion is needed (530) and the leave is not denied (step 531), the user clicks the Update button (step 532). At this point, the system 10 generates a verification screen for the user's review (step 534), such as shown in FIG. 48 in the case of a first opinion and FIG. 51 in the case of a second opinion. At this point, the user decides whether or not to proceed (step 536). If the user decides not to proceed, the user can the click “No” button to go back to the Medical Certification screen. If the user wants to proceed to approve the leave, the user clicks the “Yes” button to move forward. At this point, the approval letter will be generated (step 538) and the system will print the letter and send it to the employee.

Preferably, the system 10 records all the certification actions in an audit trail and writes related information back to the client system, if applicable.

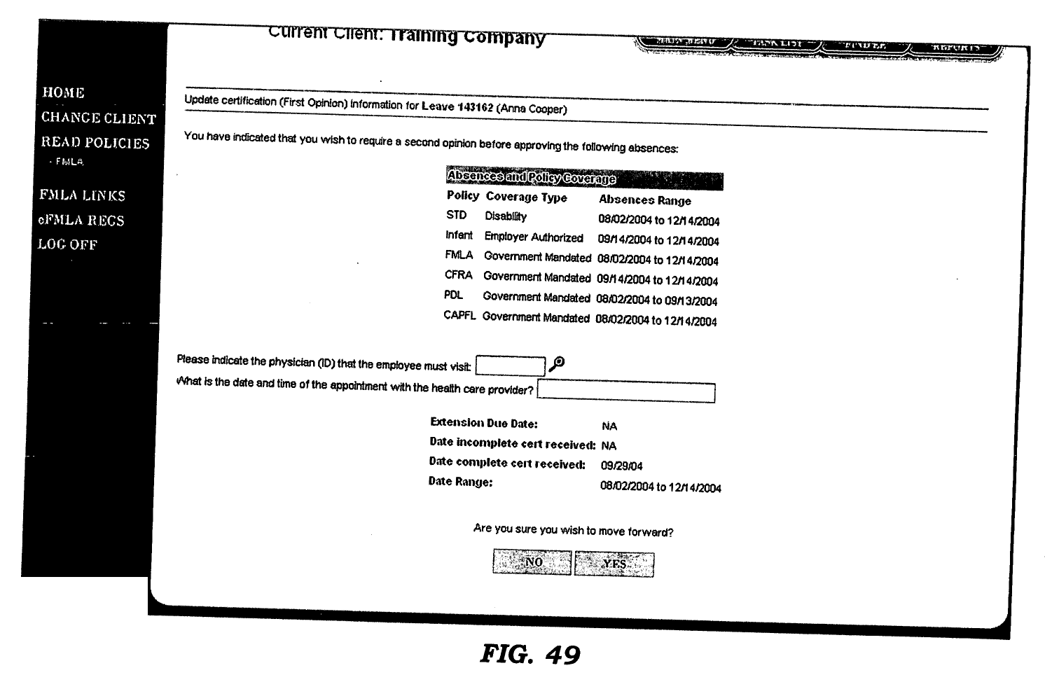

If after reviewing a medical certification form the user wants to request another physician's opinion about the employee's condition (step 530), the user selects the “Require a second or third opinion because . . . ” option on the medical certification screen and enters why an additional opinion is being requested (step 540). After the user clicks the Update button (step 542), the system 10 generates a verification screen for the user's review (step 544) as shown in FIG. 49. In this screen, the user enters the physician ID of the physician the employee is to see for the additional opinion (step 546). Preferably, this process is completed in the same manner as that for the first opinion. If known, the user enters the date and time of the appointment for the additional opinion in the appropriate field (step 547). If the user wants to proceed with requesting an additional opinion, the user clicks the Yes button to move forward (step 548). In this case, the additional opinion letter will be generated, printed and sent to the employee (step 550). If the user wants to go back to the Medical Certification screen without requesting the additional opinion, the user clicks the No button at step 548.

In another example, the user has received an incomplete certification from the employee or his/her physician. The process steps for handling this situation are also depicted in FIG. 46. In this case, the user selects the “No” option in response to “Was the cert complete?” (step 502) and enters the date the incomplete form was received (step 554) in the “Incomplete Received field.” The user can also select the date using the calendar feature. If the leave request is not denied due to the certification form being incomplete (step 555), the user proceeds to enter the extended due date for the employee to return the completed form (step 556) in the “Extended Due” field, and to select the “Extend the due date for documentation to that listed above” option under the action list (step 558). The user then clicks the Update button (step 560) and a verification screen appears that summarizes the user's entries (step 562).

The user may indicate whether or not to generate a notice of incomplete paperwork by selecting the “Yes” or “No” option next to “Do you wish to generate a notice of incomplete paperwork?” If the user wishes to proceed based on the summary provided on the verification screen (step 564), the user clicks the “Yes” button to generate the letter (step 566). If the user wants to go back to the Medical Certification screen, the user clicks the “No” button at step 564.

In a situation where the user is processing a medical certification form based on a second or third opinion, the system 10 proceeds in a fashion as set forth above. When processing the second or third opinion, much of the information regarding the requested leave is already in the system as a result of the processing of the certification based on the first opinion.

Partial Approval

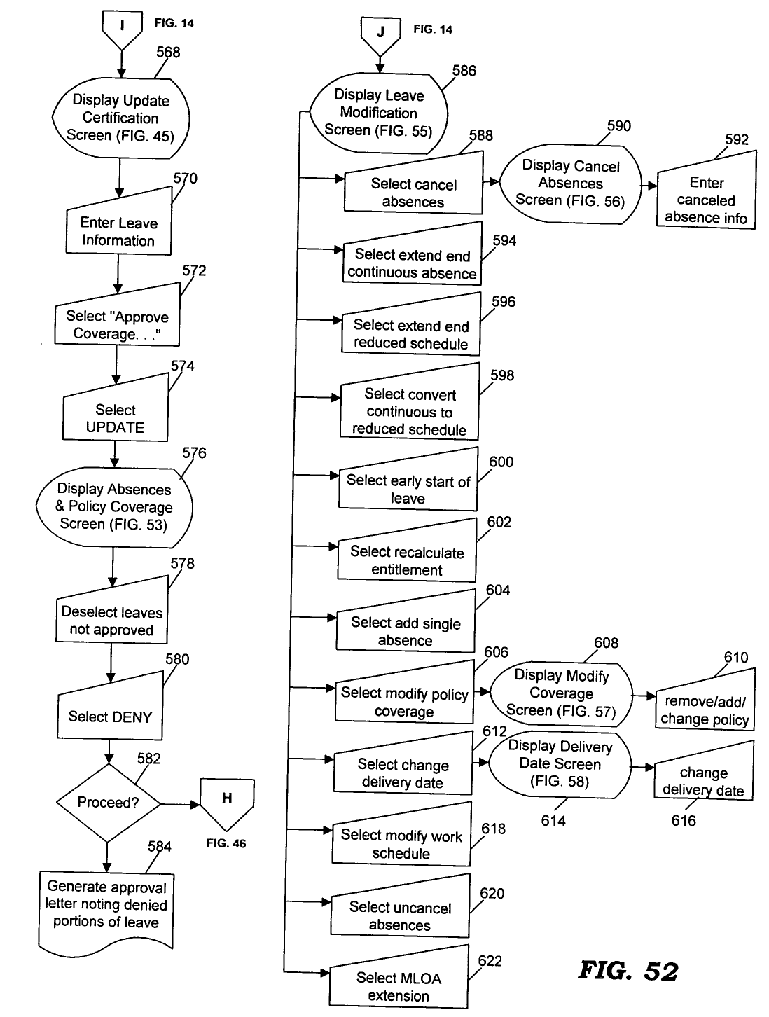

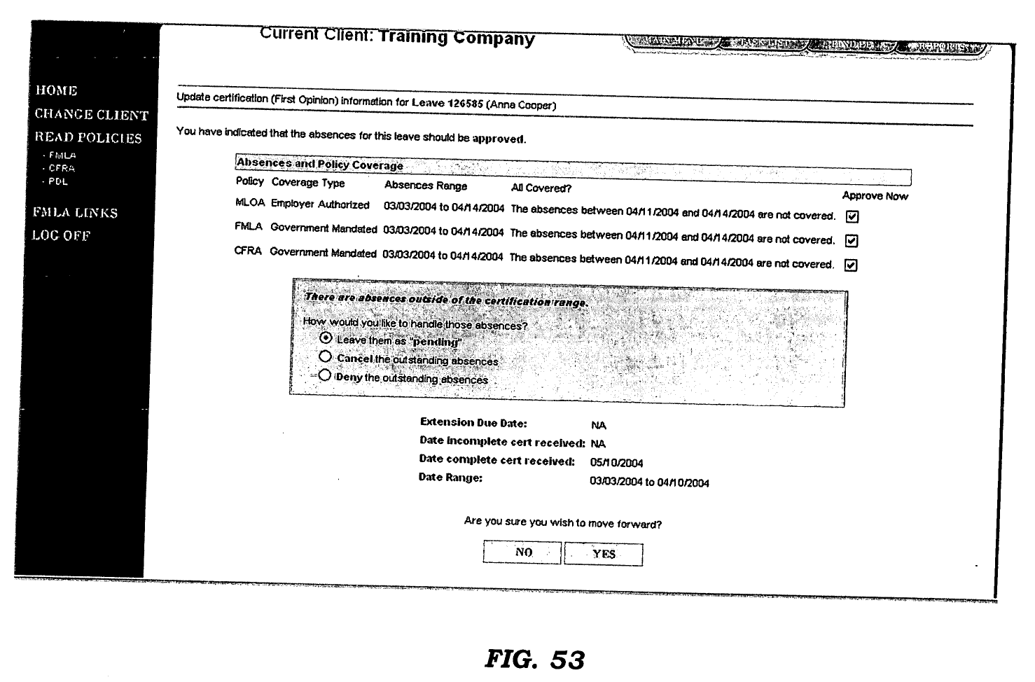

To approve some, but not all, of the policies associated with an employee's leave request, the user clicks on the leave number 58 of the leave request in the “Leave Summary” section of the employee profile screen as depicted in FIG. 18. (Step 166 in FIG. 10.) This transfers the process to the Leave Detail screen as depicted in FIG. 37. (Step 290 in FIG. 14.) The user clicks on the Certification tab 450 (step 302) which brings up the Certification View screen as depicted in FIG. 38 (step 304). In this screen the user clicks on Recert for the new certification (step 308) which brings up the Certification screen as depicted in FIG. 45. (Step 568 in FIG. 52.) The user enters the appropriate information on the top half of the screen (step 570), selects “Approve the coverage for this leave” from the list at the bottom of the screen (step 572) and clicks UPDATE (step 574). This brings up the Absences and Policy Coverage screen as depicted in FIG. 53 (step 576).

In this screen, the user deselects the leave(s) that are not to be approved (step 578), and selects whether the user would like to leave the outstanding absences Pending, cancel them, or deny them. When the user chooses to deny the remainder of the absences (step 580) and move forward (step 582), the system 10 generates a leave approval letter that includes a clause regarding the partial approval. In the preferred embodiment of the invention, the clause says: “The period from {DATE} through {DATE} was not certified. This denial pertains only to the family leave portion of your leave and does not affect any other benefits you may be eligible for. If you have additional information to consider regarding your leave request, contact {company name}.” The dates inserted into this clause are preferably the dates for which the status is denied (not exhausted) and the policy is not a disability, workers' compensation, or salary continuation policy.

Denying a Leave

The system provides five ways to deny leave while the user is processing leaves. Each denial reason is listed below.

Denial Due to Reason for Leave

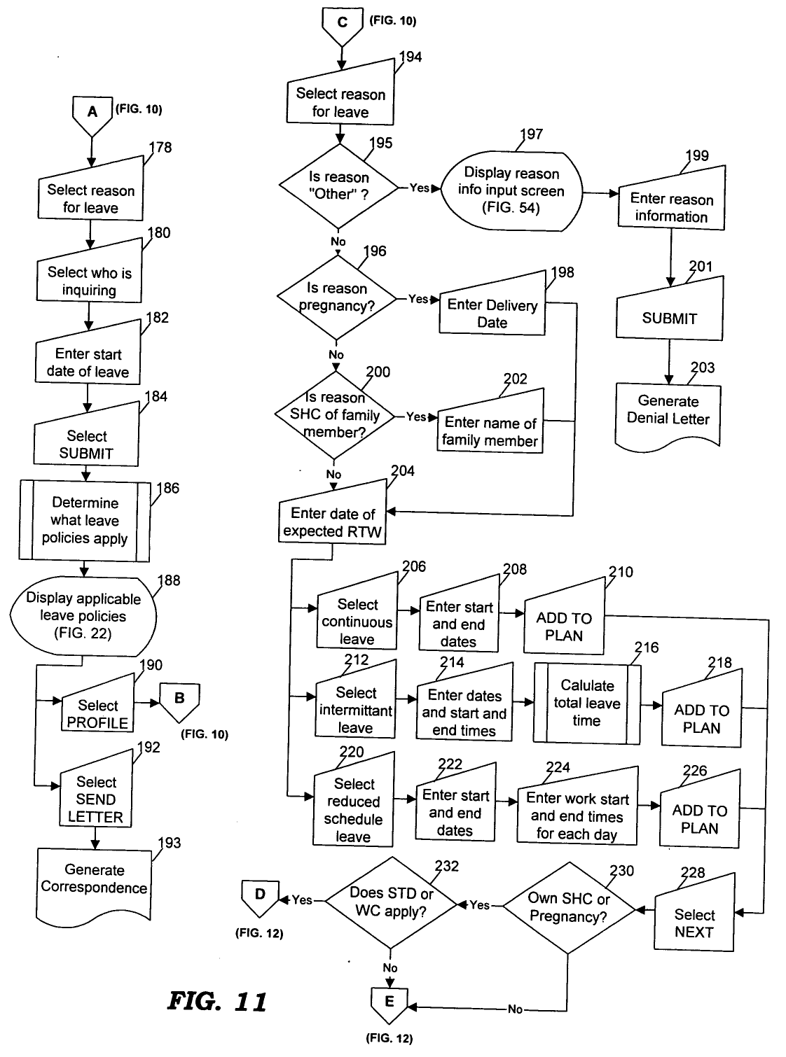

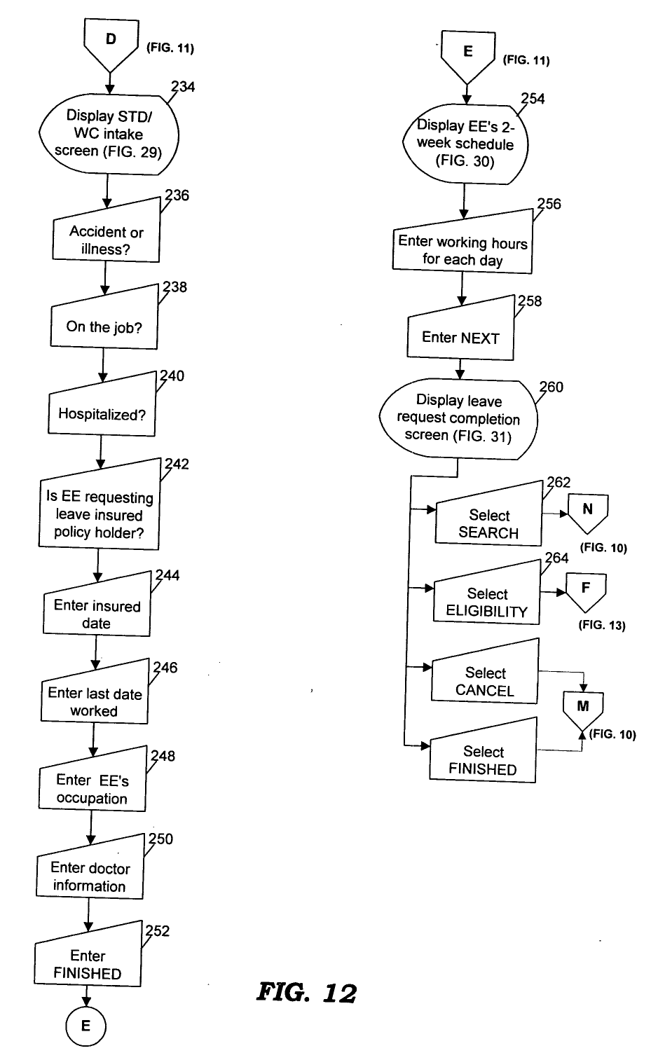

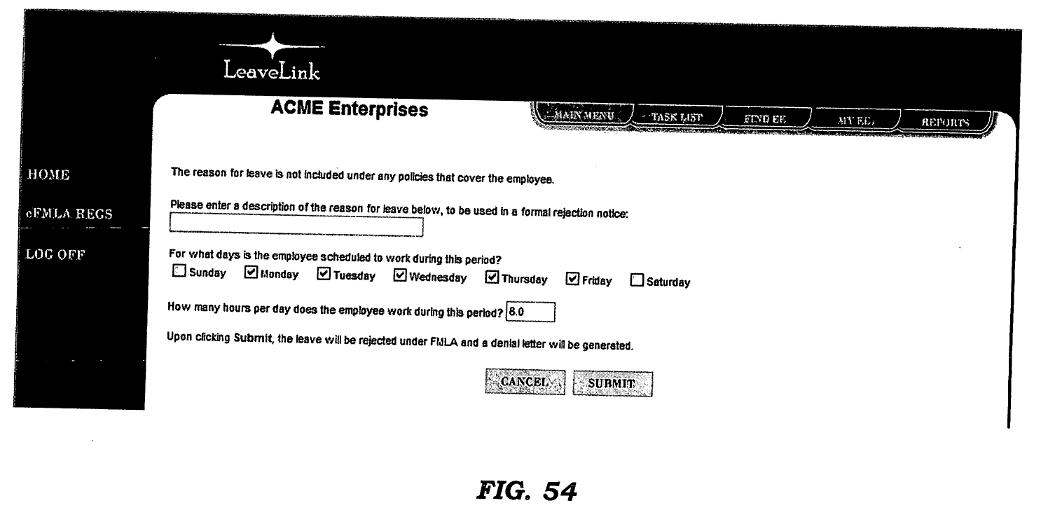

With reference to FIG. 24, if the user selects the “Other” option from the “Reason for Leave” drop-down list 86 on the Leave Request screen (step 195 in FIG. 11), the system 10 generates a screen such as depicted in FIG. 54 in which the user records additional information regarding the leave (step 197). Here the user enters a description of the reason why the employee is requesting leave (step 199). This will appear on the leave record and in the denial correspondence. The user indicates the days the employee was scheduled to work during this period by clicking the boxes beside the appropriate days, and enters the hours the employee was scheduled to work per day. The user clicks the SUBMIT button (step 201) to deny the leave and generate the appropriate paperwork (step 203). To cancel the leave request, the user clicks the CANCEL button. To return to the leave request screen (FIG. 24), the user clicks on the user's web browser back button.

Denial Due to Ineligibility

If the Eligibility Review screen (FIG. 32) indicates the employee is not eligible for any policy during the leave eligibility review (step 266 in FIG. 13), the user clicks the DENY button (step 272) to generate the denial correspondence packet (step 275). In the preferred embodiment, the denial letter lists all the policies for which the employee was denied leave. If the employee is eligible for at least one policy, the user proceeds with the leave process as described previously.

Denial for Non-Certification of a Serious Health Condition

If the user selects the “HCP did not certify a serious health condition” option on the medical certification screen (step 520 in FIG. 46), the system will recommend that the leave be denied (step 526). If the denial is confirmed (step 531), the system 10 will generate the denial letter accordingly (step 533).

Denial for Not Returning Complete Documentation

If the user never receives a complete medical certification form from the employee or his/her physician, then the user can deny the leave from the medical certification screen and generate the denial letter accordingly.

Denial Due to Exhaustion

If the employee has exhausted his/her leave entitlement as indicated in the Policy Availability section 428 of the Eligibility Review screen (FIG. 32), the leave the system 10 generates a denial letter indicating exhaustion of leave when the leave is processed.

Modifying a Leave

If an employee's leave changes, there are several ways to modify the leave, including canceling some or all of the absences, extending the end date of the leave, adding a single absence to the leave, modifying the policy coverage and changing the delivery date for a pregnancy leave.

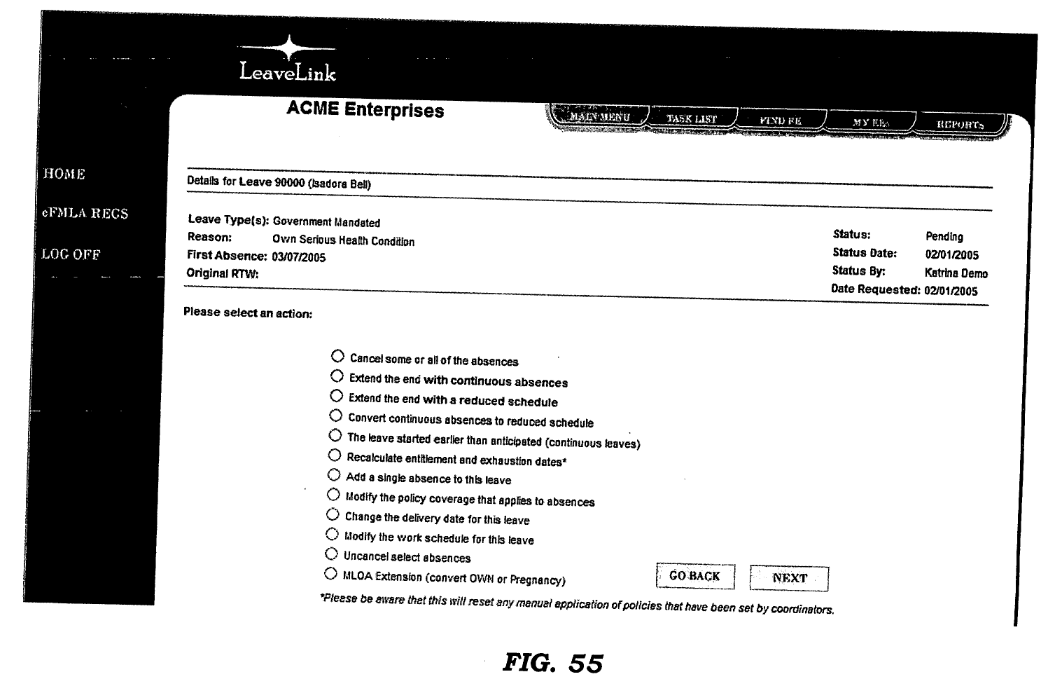

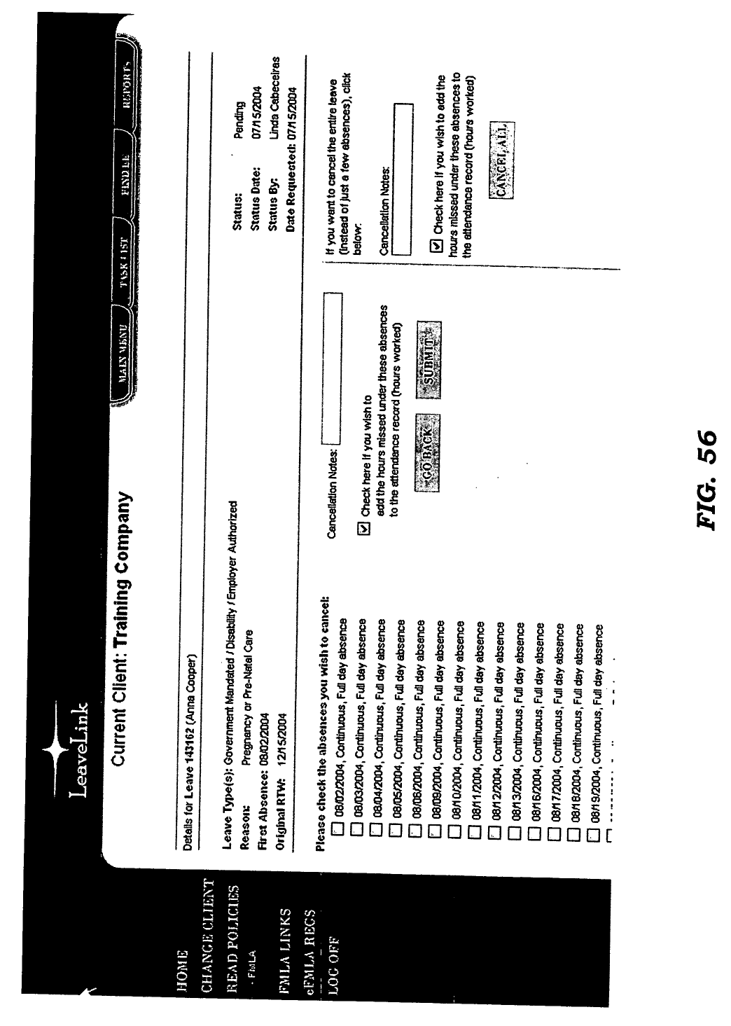

To modify a leave, the user clicks the FIND EE tab on the home page as depicted in FIG. 15. (Step 142 in FIG. 10.) The system 10 generates a search screen (step 144) in which the user enters information to find the employee's record (step 146). Based on any or all of the employee's name, employee number or social-security number, the system 10 searches the employee database (step 148) and generates a list of employees matching the user's search criteria (step 150). The user clicks on the employee's name to access the employee's record (step 152) which brings up the Employee Profile screen, examples of which are depicted in FIGS. 18 and 23 (step 154). The user clicks the associated leave number 58 in the “Leave Summary” section of the Employee Profile screen (step 166) which brings up the Leave Details screen as depicted in FIG. 37. (Step 290 in FIG. 14.) Under the Absences view, the user clicks the MODIFY button (step 500) and the system 10 generates a Leave Modification screen such as shown in FIG. 55. (Step 586 in FIG. 52.) In this screen, the system provides several options for modifying the leave. These leave modification options according to a preferred embodiment of the invention are depicted in FIG. 52.

Canceling Selected Absences

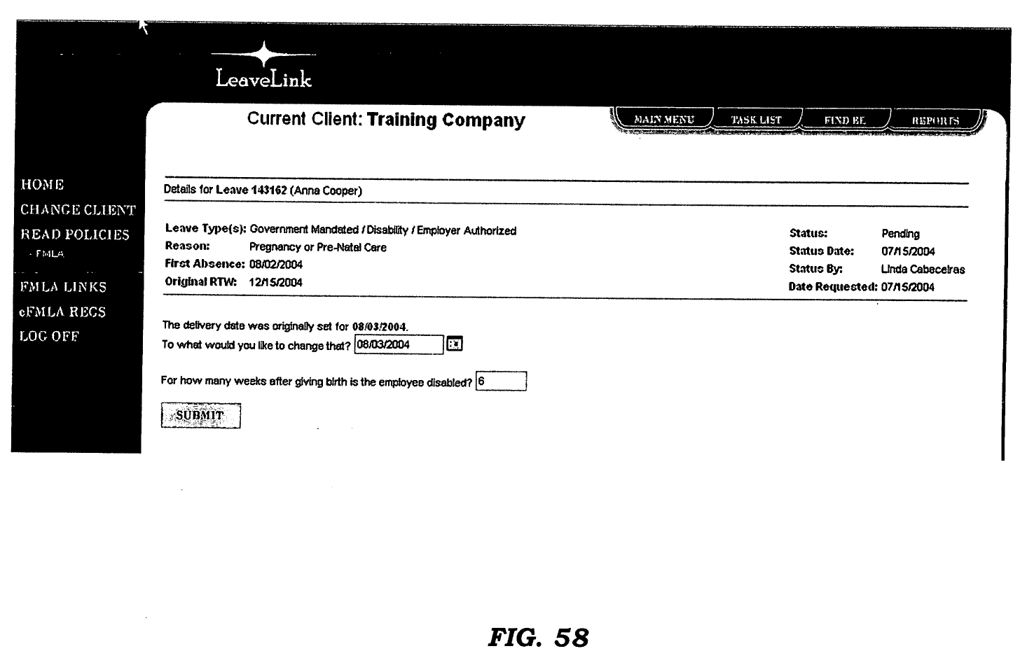

If the user needs to modify the leave because the employee will not be taking one or more of the scheduled absences, the user selects the “Cancel some or all of the absences” option (see FIG. 55) and clicks the NEXT button (step 588 in FIG. 52). The system 10 then generates the Cancel Absences screen (step 590), such as the screen depicted in FIG. 58, which provides the user several fields for entering absence cancellation information (step 592). On the left side of the screen, the user clicks the checkbox beside each absence that the user wants to cancel. The user enters notes or comments about why the user is canceling the absences in the “Cancellation Notes” field on the left side of the screen. Since the employee will not be taking leave on the days the user is canceling, the user leaves the “Check here if you wish to add the hours missed under these absences to the attendance record (hours worked)” option selected on the left side of the screen. The user then clicks the SUBMIT button.

Extending a Leave with Continuous Absences

If an employee is taking continuous leave and needs more time than originally requested, the user selects the “Extend the end with continuous absences” option as shown in FIG. 55. (Step 594 in FIG. 52.)

Modifying Policy Coverage

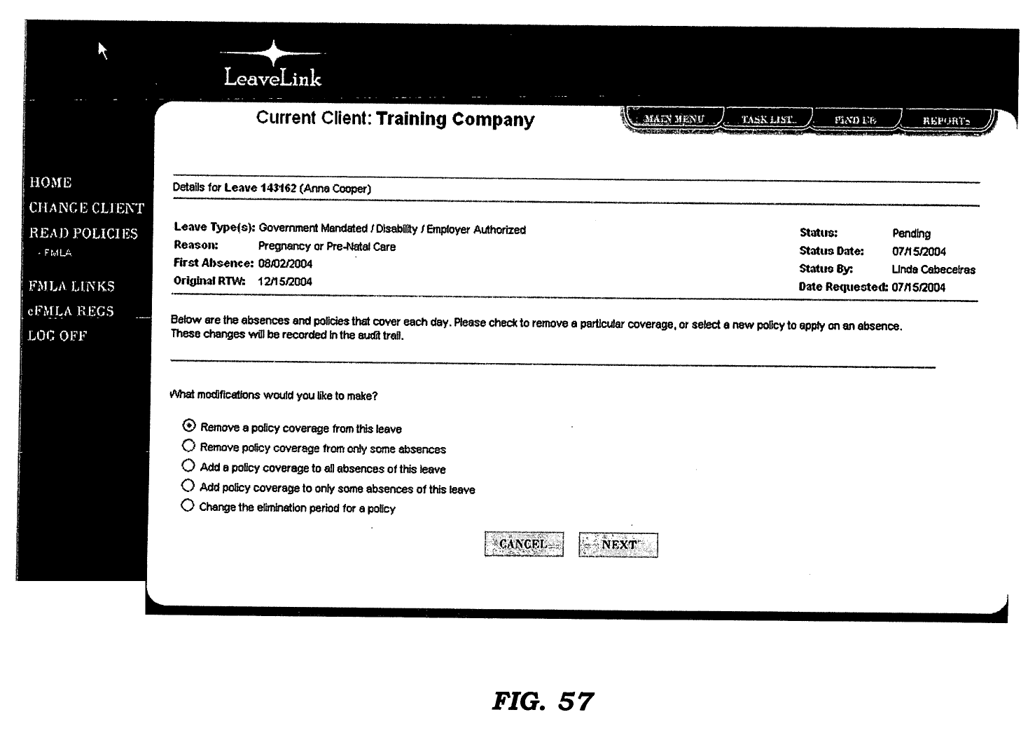

If the user needs to change the policies that cover the leave absences, the user selects the “Modify the policy coverage that applies to the absences” option as shown in FIG. 55. (Step 606 in FIG. 52.) The user clicks the NEXT button and the screen for modifying policy coverage will appear as shown in FIG. 57. (Step 608 in FIG. 52.) The user can select whether to remove a policy, add a policy or change a policy's elimination period (step 610).

Changing the Delivery Date for a Pregnancy Leave

If an employee's actual delivery date is different from the expected delivery date entered during the leave request process, the user selects the “Change the delivery date for this leave” option as shown in FIG. 55. (Step 612 in FIG. 52.) The system 10 then generates the screen as shown in FIG. 58 (step 614 in FIG. 52) in which the user may enter the new delivery date and other related information. The original delivery date is displayed for the user's review. The user enters the new delivery date in the “To what would you like to change that?” field. The user can also use the calendar feature to select the date. The number of weeks the employee will be disabled after giving birth is displayed. The default number of weeks is six. If necessary, the user may change the number of weeks. When the user clicks the SUBMIT button, a screen appears indicating the final coverage breakdown for the leave. (See FIG. 35.)

In all cases, the modified information is written back the client system.

Closing Leave

The preferred embodiment of the invention provides two different methods for closing out an employee's leave.

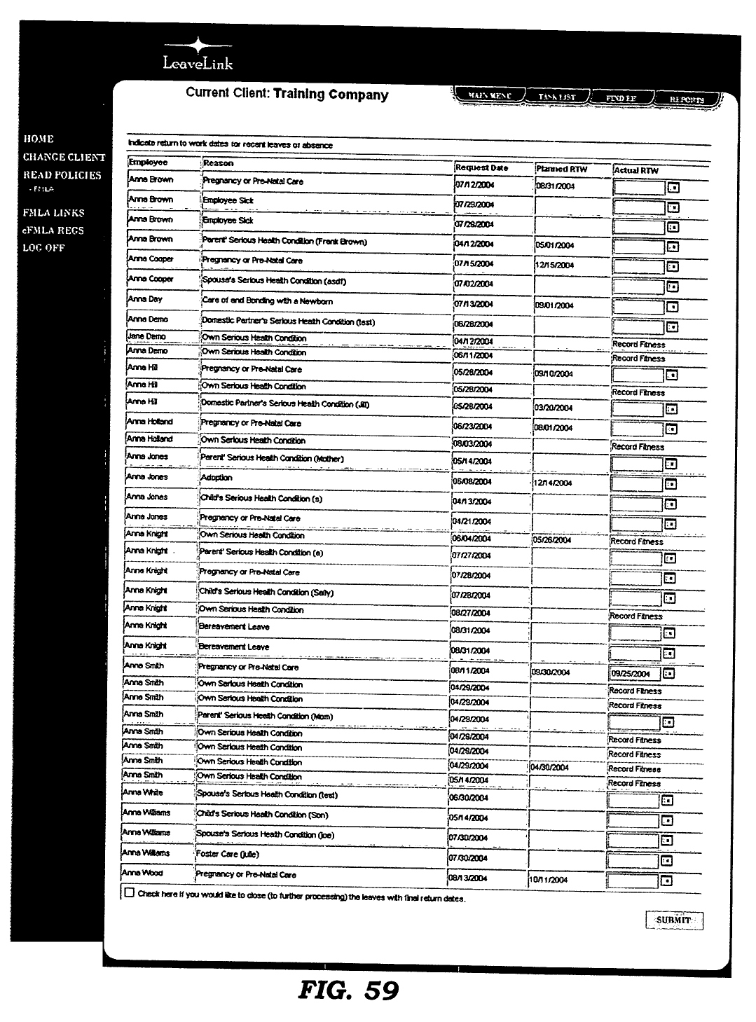

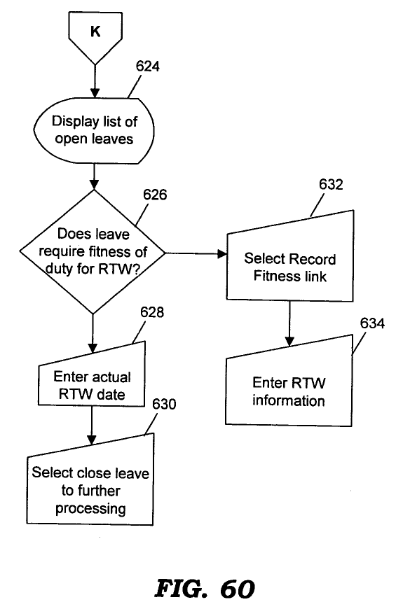

In a first method, the user clicks on the MAIN MENU tab in at the top of the homepage screen shown in FIG. 15. (Step 102 in FIG. 10.) When the user clicks on “Indicate final return to work” (step 110) in the action list on the right side of the screen, the system generates a list of the user's open employee leaves as shown in FIG. 59. (Step 624 in FIG. 60.) If the leave that the user wishes to close does not require fitness of duty (step 626), the user enters the actual return to work date in the space provided in the “Actual RTW” column shown (step 628). To close the leave, the user checks the box next to “Check here if you would like to close (to further processing) the leaves with final return dates” and clicks SUBMIT (step 630). If the leave requires fitness of duty (step 626), the user clicks on Record Fitness link in the Actual RTW column (step 632), enters the appropriate information into the fields (step 634) and clicks SUBMIT.

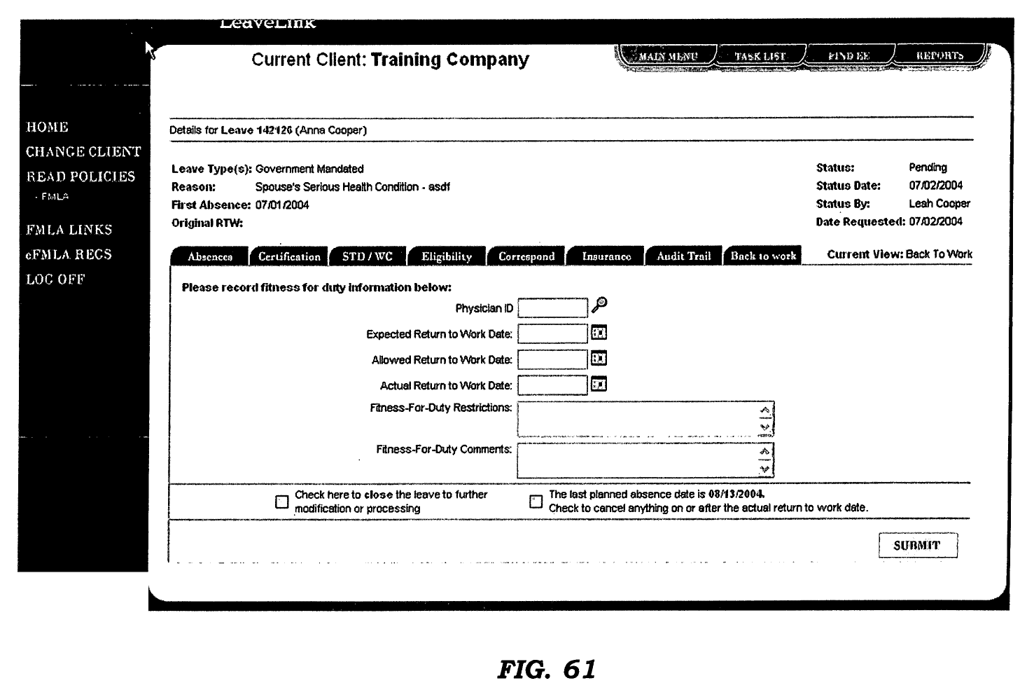

In a second method, the user clicks on the leave number 58 of the leave the user wants to close in the leave summary box of employee profile page (step 166 in FIG. 10) and clicks the Back to Work tab (step 348 in FIG. 14). The user enters the appropriate information into the fields depicted in FIG. 61 (step 352), checks the box next to “Check here to close the leave to further modification or processing” (step 353) and clicks SUBMIT (step 354).

Reports

The preferred embodiment of the invention provides six different types of reports: detailed, summary, trend, lists, audit, and analysis. Preferably, the reports can be generated in the web browser or exported to a spreadsheet application, such as Microsoft Excel. Many of the reports contain filter options that allow the user to customize the report and create multiple different reports from the same screen.

With reference to FIG. 10, the user may generate a report by selecting the REPORTS tab at the top of any screen (step 636) which brings up the reports screen (step 638). The user then selects the appropriate report format listed therein, including Details (step 640), Summaries (step 642), Trends (step 644), Lists (step 646), Audit (step 648), or Analysis (step 650), and clicks the Create button (step 652). Following is a description of some of the report formats.

Detailed Reports

The Detailed Absence report lists all absences for each employee in the selected report grouping and totals the time taken for each policy. The Employee Profile report summarizes the employee's leave and absence history and also graphs the employee's absences by day of the week.

Summary Reports

The Summary Absence report is similar to the Detailed Absence report, except it gives a summary of each leave rather than the individual detail. The Open Leave/RTW report shows all open leaves with a last day of absence, planned or actual return to work date during the date range. The Absence Totals (Ratios) per Location report shows each report grouping, the number of employees in it and the number of approved, pending, denied and total leaves. The Leave Denial report provides a summary of all denied leaves including the denial reason. The Disciplinary Level report provides a list of all employees who have reached a disciplinary action level in the system.

Trend Reports

The Demographic Breakdown report shows the reasons why leave has been taken and the percentage taken by age group and gender. The Day of Week Analysis report graphs the workforce's absences by day of the week. The Reason for Leave Analysis report shows the number of leaves/absences taken for each reason. The Physician Analysis report lists the physicians who have submitted medical certification forms, the number they have approved or denied, their first certification, last certification, the average they certify per month and the number of chronic conditions certified. The Medical Certification (Timeframe) Analysis report shows each medical certification requested, the date it was due and returned. It calculates the timeframe for each med cert to be returned and an average timeframe. It also lists the average timeframe by administrator.

List Reports

The Reason Codes report lists all the reason codes in the system. The Employer-Specified Policies report lists all policies for that employer, not including government mandate policies such as FMLA and CFRA. The Report Groupings (and Locations) report lists all report groupings in the system. The Supervisors report lists all supervisors in the system. The Pay Periods report lists all pay periods in the system.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated.

APPENDIX I
LISTING OF FILES ON COMPACT DISK

| File Name | Bytes | Type | Date Created |
|---|---|---|---|
| Status_Form.pdf | 13 KB | Adobe Acrobat Document | 6/19/2002 1:10 PM |
| AbsenceCalendar.swf | 40 KB | Shockwave Flash Object | 11/18/2003 9:05 AM |
| Absences_Tab.gif | 469 | GIF Image | 11/18/2003 9:05 AM |
| Absences_TabO.gif | 469 | GIF Image | 11/18/2003 9:05 AM |
| AbsenteeismCosts.swf | 33 KB | Shockwave Flash Object | 11/18/2003 9:05 AM |
| Absentys.gif | 4,126 | GIF Image | 11/18/2003 9:05 AM |
| ACMod.swf | 40 KB | Shockwave Flash Object | 11/18/2003 9:05 AM |
| Add_Casual.gif | 563 | GIF Image | 11/18/2003 9:05 AM |
| All_Absence_Tab.gif | 526 | GIF Image | 11/18/2003 9:05 AM |
| AllEmployees_Tab.gif | 565 | GIF Image | 11/18/2003 9:05 AM |
| Attendance_Tab.gif | 504 | GIF Image | 11/18/2003 9:05 AM |
| Audit.gif | 415 | GIF Image | 11/18/2003 9:05 AM |
| AuditTrail_Tab.gif | 488 | GIF Image | 11/18/2003 9:05 AM |
| AuditTrail_TabO.gif | 488 | GIF Image | 11/18/2003 9:05 AM |
| BackToWork_Tab.gif | 525 | GIF Image | 11/18/2003 9:05 AM |
| BackToWork_TabO.gif | 533 | GIF Image | 11/18/2003 9:05 AM |
| Bullet.gif | 81 | GIF Image | 11/18/2003 9:05 AM |
| ByGroup.gif | 513 | GIF Image | 11/18/2003 9:05 AM |
| Certification_Tab.gif | 527 | GIF Image | 11/18/2003 9:05 AM |
| Certification_TabO.gif | 527 | GIF Image | 11/18/2003 9:05 AM |
| ChangeClient_Out.gif | 806 | GIF Image | 11/18/2003 9:05 AM |
| ChangeClient_Over.gif | 1,972 | GIF Image | 11/18/2003 9:05 AM |
| Correspond_Tab.gif | 508 | GIF Image | 11/18/2003 9:05 AM |
| Correspond_TabO.gif | 508 | GIF Image | 11/18/2003 9:05 AM |
| Correspondence.swf | 44 KB | Shockwave Flash Object | 11/18/2003 9:06 AM |
| CorrespondenceEditor.swf | 42 KB | Shockwave Flash Object | 11/18/2003 9:06 AM |
| Current_Tab.gif | 427 | GIF Image | 11/18/2003 9:06 AM |
| dayofweekforpic.swf | 23 KB | Shockwave Flash Object | 11/18/2003 9:06 AM |
| Delete.gif | 408 | GIF Image | 11/18/2003 9:06 AM |
| Descriptions_Tab.gif | 523 | GIF Image | 11/18/2003 9:06 AM |
| Details_Tab.gif | 430 | GIF Image | 11/18/2003 9:06 AM |
| Details_TabO.gif | 430 | GIF Image | 11/18/2003 9:06 AM |
| Disciplinary_Tab.gif | 517 | GIF Image | 11/18/2003 9:06 AM |
| DueDate_Tab.gif | 465 | GIF Image | 11/18/2003 9:06 AM |
| Eligibility.gif | 541 | GIF Image | 11/18/2003 9:06 AM |
| Eligibility_Tab.gif | 515 | GIF Image | 11/18/2003 9:06 AM |
| Eligibility_TabO.gif | 515 | GIF Image | 11/18/2003 9:06 AM |
| Extend.gif | 488 | GIF Image | 11/18/2003 9:06 AM |
| FindLeave_Tab.gif | 1,795 | GIF Image | 11/18/2003 9:06 AM |
| FMLALinks_Out.gif | 654 | GIF Image | 11/18/2003 9:06 AM |
| FMLALinks_Over.gif | 1,811 | GIF Image | 11/18/2003 9:06 AM |
| Formula.gif | 3,641 | GIF Image | 11/18/2003 9:06 AM |
| HistoricEntry.swf | 35 KB | Shockwave Flash Object | 11/18/2003 9:06 AM |
| Home_Over.gif | 1,644 | GIF Image | 11/18/2003 9:06 AM |
| horiz_line.gif | 57 | GIF Image | 11/18/2003 9:06 AM |
| Incident_Data_Tab.gif | 534 | GIF Image | 11/18/2003 9:06 AM |
| Insurance_Tab.gif | 454 | GIF Image | 11/18/2003 9:06 AM |
| Insurance_TabO.gif | 454 | GIF Image | 11/18/2003 9:06 AM |
| Javascript.cfm | 4,139 | CFM File | 11/18/2003 9:06 AM |
| Leave_Data_Tab.gif | 496 | GIF Image | 11/18/2003 9:06 AM |
| LeaveType_Tab.gif | 500 | GIF Image | 11/18/2003 9:06 AM |
| Lists_Tab.gif | 361 | GIF Image | 11/18/2003 9:06 AM |
| Lists_TabO.gif | 361 | GIF Image | 11/18/2003 9:06 AM |
| LogOff_Over.gif | 1,707 | GIF Image | 11/18/2003 9:06 AM |
| MeleeAisleTop.gif | 3,596 | GIF Image | 11/18/2003 9:06 AM |
| MyEes_Tab.gif | 1,689 | GIF Image | 11/18/2003 9:06 AM |
| MyIncidentTotal.cfm | 435 | CFM File | 11/18/2003 9:06 AM |
| MyTotals_Tab.gif | 1,748 | GIF Image | 11/18/2003 9:06 AM |
| New_Tab.gif | 363 | GIF Image | 11/18/2003 9:06 AM |
| NewCert.gif | 535 | GIF Image | 11/18/2003 9:06 AM |
| NewLevel_Tab.gif | 472 | GIF Image | 11/18/2003 9:06 AM |
| NewReport_Tab.gif | 510 | GIF Image | 11/18/2003 9:06 AM |
| O_Casual_New.cfm | 4,625 | CFM File | 11/18/2003 9:06 AM |
| O_EA_New.cfm | 5,803 | CFM File | 11/18/2003 9:06 AM |
| O_MyEmployees_All.cfm | 1,275 | CFM File | 11/18/2003 9:07 AM |
| O_MyEmployees_Disc.cfm | 706 | CFM File | 11/18/2003 9:07 AM |
| O_MyEmployees_OnLeave.cfm | 1,320 | CFM File | 11/18/2003 9:07 AM |
| O_MyEmployees_Perf.cfm | 991 | CFM File | 11/18/2003 9:07 AM |
| O_View_Attendance.cfm | 2,412 | CFM File | 11/18/2003 9:07 AM |
| O_View_Warnings.cfm | 848 | CFM File | 11/18/2003 9:07 AM |
| OnLeave_Tab.gif | 460 | GIF Image | 11/18/2003 9:07 AM |
| Overlaps.gif | 542 | GIF Image | 11/18/2003 9:07 AM |
| Overturn.gif | 562 | GIF Image | 11/18/2003 9:07 AM |
| Performance_Tab.gif | 523 | GIF Image | 11/18/2003 9:07 AM |
| PleaseSelect.gif | 808 | GIF Image | 11/18/2003 9:07 AM |
| Q_All_Correspondence.cfm | 22 | CFM File | 11/18/2003 9:07 AM |
| ReadPol_Out.gif | 778 | GIF Image | 11/18/2003 9:09 AM |
| ReadPol_Over.gif | 1,943 | GIF Image | 11/18/2003 9:09 AM |
| ReasonCode_Tab.gif | 533 | GIF Image | 11/18/2003 9:09 AM |
| Reject.gif | 455 | GIF Image | 11/18/2003 9:09 AM |
| Remove.gif | 508 | GIF Image | 11/18/2003 9:09 AM |
| Remove_Tab.gif | 432 | GIF Image | 11/18/2003 9:09 AM |
| RemoveLevel_Tab.gif | 533 | GIF Image | 11/18/2003 9:09 AM |
| Review.gif | 471 | GIF Image | 11/18/2003 9:09 AM |
| StatusCode_Tab.gif | 529 | GIF Image | 11/18/2003 9:09 AM |
| STD_Tab.gif | 507 | GIF Image | 11/18/2003 9:09 AM |
| STD_TabO.gif | 507 | GIF Image | 11/18/2003 9:09 AM |
| Summaries_Tab.gif | 496 | GIF Image | 11/18/2003 9:09 AM |
| Summaries_TabO.gif | 496 | GIF Image | 11/18/2003 9:09 AM |
| Sunken_Rectangle.gif | 4,627 | GIF Image | 11/18/2003 9:09 AM |
| T_Absence_Calendar.cfm | 5,768 | CFM File | 11/18/2003 9:09 AM |
| T_Choose_Policies.cfm | 544 | CFM File | 11/18/2003 9:09 AM |
| T_Mod_Casual.cfm | 5,590 | CFM File | 11/18/2003 9:09 AM |
| T_Modify_Reduced.cfm | 639 | CFM File | 11/18/2003 9:09 AM |
| Trends_Tab.gif | 414 | GIF Image | 11/18/2003 9:10 AM |
| Trends_TabO.gif | 414 | GIF Image | 11/18/2003 9:10 AM |
| WeekDayAnalysis.swf | 32 KB | Shockwave Flash Object | 11/18/2003 9:10 AM |
| WorkSchedule.swf | 48 KB | Shockwave Flash Object | 11/18/2003 9:10 AM |
| Matrix_Tab.gif | 416 | GIF Image | 11/19/2003 9:32 AM |
| Matrix_TabO.gif | 416 | GIF Image | 11/19/2003 9:32 AM |
| Correspondence.cfm | 713 | CFM File | 12/1/2003 4:32 PM |
| CorrespondenceEditorTPA.swf | 42 KB | Shockwave Flash Object | 12/1/2003 4:47 PM |
| WorkScheduleTPA.swf | 28 KB | Shockwave Flash Object | 12/22/2003 10:57 AM |
| O_Intake_Javascript.cfm | 10 KB | CFM File | 12/29/2003 3:57 PM |
| J_Date_Validation.cfm | 14 KB | CFM File | 1/2/2004 3:31 PM |
| ExtendSchedule.swf | 47 KB | Shockwave Flash Object | 1/3/2004 12:09 PM |
| T_ChangePass.cfm | 1,039 | CFM File | 1/5/2004 10:11 AM |
| Search.gif | 484 | GIF Image | 1/8/2004 9:32 AM |
| Authorization.pdf | 15 KB | Adobe Acrobat Document | 1/8/2004 3:59 PM |
| Rights_Obs.pdf | 10 KB | Adobe Acrobat Document | 1/9/2004 9:53 AM |
| O_Config_Help.cfm | 5,275 | CFM File | 1/12/2004 3:58 PM |
| Two WeekSched.swf | 9,966 | Shockwave Flash Object | 1/16/2004 11:25 AM |
| cntReport1.cfm | 253 | CFM File | 1/29/2004 2:48 PM |
| dspReport1.cfm | 801 | CFM File | 1/29/2004 2:48 PM |
| Blank Page Two.pdf | 6,470 | Adobe Acrobat Document | 2/17/2004 3:43 PM |
| Concurrent.pdf | 45 KB | Adobe Acrobat Document | 2/19/2004 10:00 AM |
| NewMedCert.pdf | 15 KB | Adobe Acrobat Document | 2/19/2004 10:09 AM |
| NewSHCDefPage.pdf | 14 KB | Adobe Acrobat Document | 2/19/2004 10:09 AM |
| Nonconcurrent.pdf | 44 KB | Adobe Acrobat Document | 2/19/2004 10:09 AM |
| SampleResponse.pdf | 15 KB | Adobe Acrobat Document | 2/19/2004 10:17 AM |
| SecondPage.pdf | 5,480 | Adobe Acrobat Document | 2/19/2004 10:18 AM |
| WH-380 Med Cert.pdf | 17 KB | Adobe Acrobat Document | 2/19/2004 10:27 AM |
| WH-380 Med Cert New.pdf | 38 KB | Adobe Acrobat Document | 2/22/2004 1:16 PM |
| Packet.pdf | 73 KB | Adobe Acrobat Document | 2/22/2004 1:23 PM |
| Excel.gif | 511 | GIF Image | 3/18/2004 10:26 AM |
| O_Matrix_Reports.cfm | 7,181 | CFM File | 4/22/2004 10:17 AM |
| cntEnquiry.cfm | 2,224 | CFM File | 5/14/2004 1:57 PM |
| Audit_TabO.gif | 392 | GIF Image | 5/28/2004 1:18 PM |
| Audit_Tab.gif | 392 | GIF Image | 5/28/2004 1:19 PM |
| MyToDoList.cfm | 955 | CFM File | 6/4/2004 1:33 PM |
| O_View_Incidents.cfm | 3,453 | CFM File | 6/4/2004 1:33 PM |
| O_View_Leaves.cfm | 1,986 | CFM File | 6/4/2004 1:33 PM |
| DirectReports_Tab.gif | 556 | GIF Image | 6/8/2004 1:05 PM |
| DirectReports_TabO.gif | 556 | GIF Image | 6/8/2004 1:05 PM |
| HRReports_TabO.gif | 504 | GIF Image | 6/8/2004 1:06 PM |
| HRReports_Tab.gif | 504 | GIF Image | 6/8/2004 1:06 PM |
| ByLocation_Tab.gif | 508 | GIF Image | 6/8/2004 1:07 PM |
| ByLocation_TabO.gif | 508 | GIF Image | 6/8/2004 1:07 PM |
| O_MyEmployees_Direct.cfm | 1,272 | CFM File | 6/8/2004 3:14 PM |
| FMLA Poster.pdf | 61 KB | Adobe Acrobat Document | 6/9/2004 3:00 PM |
| OD_RTW.pdf | 16 KB | Adobe Acrobat Document | 6/9/2004 3:21 PM |
| leavelink_demo_dev_20040610.txt | 15 KB | Text Document | 6/10/2004 3:35 PM |
| CA Paid Leave Brochure.pdf | 158 KB | Adobe Acrobat Document | 6/10/2004 3:36 PM |
| Application.cfmold | 1,751 | CFMOLD File | 6/11/2004 8:49 AM |
| OD_One_Page.pdf | 191 KB | Adobe Acrobat Document | 6/14/2004 10:01 AM |
| OD_Two_Page.pdf | 16 KB | Adobe Acrobat Document | 6/14/2004 10:02 AM |
| T_DenyInelig.cfm | 1,149 | CFM File | 7/12/2004 3:34 PM |
| T_DenyEntitlement.cfm | 1,203 | CFM File | 7/12/2004 3:34 PM |
| T_DenyReason.cfm | 2,128 | CFM File | 7/12/2004 3:37 PM |
| O_PopUpCalendar.cfm | 6,411 | CFM File | 7/15/2004 12:14 PM |
| OD Permission to Contact Health Care Provider.pdf | 11 KB | Adobe Acrobat Document | 7/27/2004 8:24 AM |
| Permission to Contact Health Care Provider.pdf | 11 KB | Adobe Acrobat Document | 7/27/2004 8:24 AM |
| OD_Second_Page_Response.pdf | 171 KB | Adobe Acrobat Document | 7/27/2004 8:56 AM |
| OD_Three_Page.pdf | 198 KB | Adobe Acrobat Document | 7/27/2004 8:56 AM |
| OD RTW Form.pdf | 173 KB | Adobe Acrobat Document | 7/27/2004 10:56 AM |
| Updated OD Med Cert.pdf | 247 KB | Adobe Acrobat Document | 7/27/2004 10:57 AM |
| Batch_Cover.bak.pdf | 94 KB | Adobe Acrobat Document | 7/28/2004 4:12 PM |
| Batch_Separator.bak.pdf | 94 KB | Adobe Acrobat Document | 7/28/2004 4:30 PM |
| eFMLA_Regs.gif | 693 | GIF Image | 8/3/2004 8:43 AM |
| Batch_Test.pdf | 804 KB | Adobe Acrobat Document | 8/5/2004 4:34 PM |
| O_Task_Modify.cfm | 934 | CFM File | 8/9/2004 10:13 AM |
| frmReport1.cfm | 4,453 | CFM File | 8/9/2004 12:53 PM |
| T_Access_Levels.cfm | 1,798 | CFM File | 8/9/2004 12:53 PM |
| T_AP_Options.cfm | 1,748 | CFM File | 8/9/2004 12:53 PM |
| T_Code_Setup.cfm | 1,437 | CFM File | 8/9/2004 12:53 PM |
| T_Correspondence.cfm | 1,937 | CFM File | 8/9/2004 12:53 PM |
| T_EA_Details.cfm | 10 KB | CFM File | 8/9/2004 12:53 PM |
| T_EA_Options.cfm | 1,863 | CFM File | 8/9/2004 12:53 PM |
| T_EA_Overlaps.cfm | 4,794 | CFM File | 8/9/2004 12:53 PM |
| T_Exception_List.cfm | 2,070 | CFM File | 8/9/2004 12:53 PM |
| T_Exception_Review.cfm | 833 | CFM File | 8/9/2004 12:53 PM |
| T_FMLA_Links.cfm | 1,158 | CFM File | 8/9/2004 12:53 PM |
| T_Location_Setup.cfm | 1,751 | CFM File | 8/9/2004 12:53 PM |
| T_New_Customer.cfm | 3,242 | CFM File | 8/9/2004 12:53 PM |
| T_New_GroupCodes.cfm | 851 | CFM File | 8/9/2004 12:54 PM |
| T_New_Groups.cfm | 1,537 | CFM File | 8/9/2004 12:54 PM |
| T_Notes_New.cfm | 1,375 | CFM File | 8/9/2004 12:54 PM |
| T_Pay_Period.cfm | 1,452 | CFM File | 8/9/2004 12:54 PM |
| T_Performance_New.cfm | 1,855 | CFM File | 8/9/2004 12:54 PM |
| T_Plant_Shutdowns.cfm | 1,755 | CFM File | 8/9/2004 12:54 PM |
| T_Policy_Definition.cfm | 4,960 | CFM File | 8/9/2004 12:54 PM |
| T_Remove_Coverage.cfm | 2,774 | CFM File | 8/9/2004 12:54 PM |
| T_Report_Setup.cfm | 1,760 | CFM File | 8/9/2004 12:54 PM |
| T_STD_Options.cfm | 1,896 | CFM File | 8/9/2004 12:54 PM |
| T_Task_Modify.cfm | 2,464 | CFM File | 8/9/2004 12:54 PM |
| T_UN_Assessment.cfm | 15 KB | CFM File | 8/9/2004 12:54 PM |
| T_UN_Options.cfm | 1,887 | CFM File | 8/9/2004 12:54 PM |
| T_Verbiage_Mod.cfm | 1,277 | CFM File | 8/9/2004 12:54 PM |
| T_Performance_Review.cfm | 1,902 | CFM File | 8/9/2004 2:29 PM |
| O_Access_Current.cfm | 4,819 | CFM File | 8/9/2004 2:56 PM |
| O_Access_New.cfm | 2,281 | CFM File | 8/9/2004 2:56 PM |
| O_Accrual_Current.cfm | 3,554 | CFM File | 8/9/2004 2:56 PM |
| O_Accrual_Remove.cfm | 1,902 | CFM File | 8/9/2004 2:56 PM |
| O_Casual_Current.cfm | 1,795 | CFM File | 8/9/2004 2:56 PM |
| O_Casual_Remove.cfm | 1,679 | CFM File | 8/9/2004 2:56 PM |
| O_Code_Leave.cfm | 1,096 | CFM File | 8/9/2004 2:56 PM |
| O_Code_Reason.cfm | 2,548 | CFM File | 8/9/2004 2:56 PM |
| O_Code_Status.cfm | 1,100 | CFM File | 8/9/2004 2:56 PM |
| O_Corres_Desc.cfm | 1,083 | CFM File | 8/9/2004 2:56 PM |
| O_EA_Remove.cfm | 2,109 | CFM File | 8/9/2004 2:56 PM |
| O_Emails_Current.cfm | 2,329 | CFM File | 8/9/2004 2:56 PM |
| O_Emails_Remove.cfm | 1,681 | CFM File | 8/9/2004 2:56 PM |
| O_Groups_New.cfm | 4,834 | CFM File | 8/9/2004 2:56 PM |
| O_Reports_Current.cfm | 1,629 | CFM File | 8/9/2004 2:56 PM |
| O_Reports_New.cfm | 1,193 | CFM File | 8/9/2004 2:56 PM |
| O_Reports_Remove.cfm | 1,101 | CFM File | 8/9/2004 2:56 PM |
| O_Shutdown_New.cfm | 1,722 | CFM File | 8/9/2004 2:56 PM |
| O_STD_New.cfm | 3,610 | CFM File | 8/9/2004 2:56 PM |
| O_STD_Remove.cfm | 1,765 | CFM File | 8/9/2004 2:56 PM |
| R_Reason_Codes.cfm | 2,198 | CFM File | 8/9/2004 2:56 PM |
| R_Report_Groups.cfm | 2,807 | CFM File | 8/9/2004 2:56 PM |
| T_STD_Details.cfm | 6,298 | CFM File | 8/9/2004 2:56 PM |
| R_ClientTotals.cfm | 3,152 | CFM File | 8/9/2004 2:56 PM |
| eFMLA_Regs_O.gif | 1,848 | GIF Image | 8/11/2004 9:30 AM |
| O_Access_Remove.cfm | 2,197 | CFM File | 8/12/2004 1:27 PM |
| O_Corres_Remove.cfm | 1,706 | CFM File | 8/12/2004 1:27 PM |
| O_EA_Current.cfm | 6,279 | CFM File | 8/12/2004 1:27 PM |
| O_Emails_New.cfm | 5,539 | CFM File | 8/12/2004 1:27 PM |
| O_Groups_Current.cfm | 2,207 | CFM File | 8/12/2004 1:27 PM |
| O_Groups_Remove.cfm | 6,068 | CFM File | 8/12/2004 1:27 PM |
| O_PayPeriod_Current.cfm | 1,986 | CFM File | 8/12/2004 1:27 PM |
| O_PayPeriod_New.cfm | 2,083 | CFM File | 8/12/2004 1:27 PM |
| O_Shutdown_Current.cfm | 2,183 | CFM File | 8/12/2004 1:27 PM |
| O_Shutdown_Remove.cfm | 1,880 | CFM File | 8/12/2004 1:27 PM |
| Q_ChangePass.cfm | 173 | CFM File | 8/12/2004 1:27 PM |
| Q_New_Certification.cfm | 4,237 | CFM File | 8/12/2004 1:27 PM |
| R_Closed_Pending.cfm | 3,471 | CFM File | 8/12/2004 1:27 PM |
| R_Cost_Absenteeism.cfm | 11 KB | CFM File | 8/12/2004 1:27 PM |
| R_Disciplinary_ByEmployee.cfm | 2,494 | CFM File | 8/12/2004 1:27 PM |
| R_Honda_AR_FMLAclosed.cfm | 12 KB | CFM File | 8/12/2004 1:27 PM |
| R_Honda_AR_FMLAopen.cfm | 12 KB | CFM File | 8/12/2004 1:27 PM |
| R_Honda_AR_Medical.cfm | 8,259 | CFM File | 8/12/2004 1:27 PM |
| R_Matrix_Closed.cfm | 25 KB | CFM File | 8/12/2004 1:27 PM |
| R_Matrix_Open_Status.cfm | 27 KB | CFM File | 8/12/2004 1:27 PM |
| R_Nadia_Visa.cfm | 6,625 | CFM File | 8/12/2004 1:27 PM |
| R_Open_ByAdmin.cfm | 5,289 | CFM File | 8/12/2004 1:27 PM |
| R_Open_Summary.cfm | 4,537 | CFM File | 8/12/2004 1:27 PM |
| R_Pay_Periods.cfm | 2,043 | CFM File | 8/12/2004 1:27 PM |
| R_Physician_Detail.cfm | 6,387 | CFM File | 8/12/2004 1:27 PM |
| R_Policies.cfm | 3,528 | CFM File | 8/12/2004 1:27 PM |
| R_Task_Overdue.cfm | 3,233 | CFM File | 8/12/2004 1:27 PM |
| T_Accrual_Mod.cfm | 8,621 | CFM File | 8/12/2004 1:27 PM |
| T_AP_ByGroup.cfm | 3,795 | CFM File | 8/12/2004 1:27 PM |
| T_EA_ByGroup.cfm | 6,275 | CFM File | 8/12/2004 1:27 PM |
| T_GM_ByGroup.cfm | 5,396 | CFM File | 8/12/2004 1:27 PM |
| T_GM_Options.cfm | 3,504 | CFM File | 8/12/2004 1:27 PM |
| T_New_Certification.cfm | 12 KB | CFM File | 8/12/2004 1:27 PM |
| T_STD_ByGroup.cfm | 3,676 | CFM File | 8/12/2004 1:28 PM |
| T_System_Options.cfm | 7,213 | CFM File | 8/12/2004 1:28 PM |
| T_UN_ByGroup.cfm | 3,562 | CFM File | 8/12/2004 1:28 PM |
| A_Standard.cfm | 3,427 | CFM File | 8/12/2004 1:29 PM |
| B_RTW_Reminder.cfm | 291 | CFM File | 8/12/2004 1:29 PM |
| DeleteEverything.cfm | 937 | CFM File | 8/12/2004 1:29 PM |
| DeleteIntakeAll.cfm | 915 | CFM File | 8/12/2004 1:29 PM |
| DeleteLeave.cfm | 2,140 | CFM File | 8/12/2004 1:29 PM |
| O_Accrual_New.cfm | 5,927 | CFM File | 8/12/2004 1:29 PM |
| O_DateDetails.cfm | 2,697 | CFM File | 8/12/2004 1:29 PM |
| O_Emails_Type.cfm | 4,952 | CFM File | 8/12/2004 1:29 PM |
| O_Modify_SChedule.cfm | 4,254 | CFM File | 8/12/2004 1:29 PM |
| O_Phy_Details.cfm | 1,480 | CFM File | 8/12/2004 1:29 PM |
| O_Physicians.cfm | 4,792 | CFM File | 8/12/2004 1:29 PM |
| O_PopUpConfirm.cfm | 5,269 | CFM File | 8/12/2004 1:29 PM |
| O_PopUpEmployee_Manager.cfm | 6,269 | CFM File | 8/12/2004 1:29 PM |
| O_Sup_Details.cfm | 3,319 | CFM File | 8/12/2004 1:29 PM |
| O_View_Email.cfm | 1,580 | CFM File | 8/12/2004 1:29 PM |
| O_View_Performance.cfm | 1,385 | CFM File | 8/12/2004 1:29 PM |
| Old_Queries.cfm | 5,142 | CFM File | 8/12/2004 1:29 PM |
| P_Accural_Assessment.cfm | 9,091 | CFM File | 8/12/2004 1:29 PM |
| P_Kronos_Import.cfm | 3,819 | CFM File | 8/12/2004 1:29 PM |
| P_Sample_Exceptions.cfm | 3,163 | CFM File | 8/12/2004 1:29 PM |
| Q_20_Day.cfm | 3,782 | CFM File | 8/12/2004 1:29 PM |
| Q_Access_Current.cfm | 2,596 | CFM File | 8/12/2004 1:29 PM |
| Q_Access_New.cfm | 2,278 | CFM File | 8/12/2004 1:29 PM |
| Q_Access_Remove.cfm | 992 | CFM File | 8/12/2004 1:29 PM |
| Q_Accrual_Mod.cfm | 3,477 | CFM File | 8/12/2004 1:29 PM |
| Q_Actual_RTW.cfm | 2,404 | CFM File | 8/12/2004 1:29 PM |
| Q_AP_ByGroup.cfm | 1,874 | CFM File | 8/12/2004 1:29 PM |
| Q_AP_Get.cfm | 301 | CFM File | 8/12/2004 1:29 PM |
| Q_AP_Options.cfm | 4,742 | CFM File | 8/12/2004 1:29 PM |
| Q_Assessment_Get.cfm | 1,005 | CFM File | 8/12/2004 1:29 PM |
| Q_Cancel_Contract.cfm | 3,207 | CFM File | 8/12/2004 1:29 PM |
| Q_Cancel_Request.cfm | 1,077 | CFM File | 8/12/2004 1:29 PM |
| Q_Casual_Outside.cfm | 8,879 | CFM File | 8/12/2004 1:29 PM |
| Q_Check_STD_Duration.cfm | 2,644 | CFM File | 8/12/2004 1:29 PM |
| Q_Code_Setup.cfm | 2,200 | CFM File | 8/12/2004 1:29 PM |
| Q_Codes_Get.cfm | 2,575 | CFM File | 8/12/2004 1:29 PM |
| Q_Corres_Desc.cfm | 638 | CFM File | 8/12/2004 1:29 PM |
| Q_Corres_Pages.cfm | 1,839 | CFM File | 8/12/2004 1:29 PM |
| Q_Countries.cfm | 115 | CFM File | 8/12/2004 1:29 PM |
| Q_EA_ByGroup.cfm | 3,883 | CFM File | 8/12/2004 1:29 PM |
| Q_EA_Details.cfm | 2,284 | CFM File | 8/12/2004 1:29 PM |
| Q_EA_Get.cfm | 1,273 | CFM File | 8/12/2004 1:29 PM |
| Q_EA_Options.cfm | 4,706 | CFM File | 8/12/2004 1:29 PM |
| Q_EA_Overlaps.cfm | 915 | CFM File | 8/12/2004 1:29 PM |
| Q_Edit_Correspondence.cfm | 554 | CFM File | 8/12/2004 1:29 PM |
| Q_Email_Notices.cfm | 2,737 | CFM File | 8/12/2004 1:29 PM |
| Q_Emails_Type.cfm | 1,357 | CFM File | 8/12/2004 1:29 PM |
| Q_Employee_Delete.cfm | 1,741 | CFM File | 8/12/2004 1:29 PM |
| Q_Exception_List.cfm | 1,806 | CFM File | 8/12/2004 1:29 PM |
| Q_Exception_Modify.cfm | 2,833 | CFM File | 8/12/2004 1:29 PM |
| Q_Exceptions_Get.cfm | 1,862 | CFM File | 8/12/2004 1:29 PM |
| Q_GM_ByGroup.cfm | 1,867 | CFM File | 8/12/2004 1:29 PM |
| Q_GM_Modify.cfm | 2,206 | CFM File | 8/12/2004 1:29 PM |
| Q_GM_Options.cfm | 1,437 | CFM File | 8/12/2004 1:29 PM |
| Q_GM_Overlaps.cfm | 1,679 | CFM File | 8/12/2004 1:29 PM |
| Q_Groups_Get.cfm | 3,991 | CFM File | 8/12/2004 1:29 PM |
| Q_Groups_New.cfm | 4,267 | CFM File | 8/12/2004 1:29 PM |
| Q_Groups_Remove.cfm | 2,223 | CFM File | 8/12/2004 1:29 PM |
| Q_Handle_Warning.cfm | 834 | CFM File | 8/12/2004 1:29 PM |
| Q_Intake_STD.cfm | 1,239 | CFM File | 8/12/2004 1:29 PM |
| Q_Last_Warning.cfm | 910 | CFM File | 8/12/2004 1:29 PM |
| Q_Mod_Casual.cfm | 1,097 | CFM File | 8/12/2004 1:29 PM |
| Q_Modify_Absence.cfm | 7,529 | CFM File | 8/12/2004 1:29 PM |
| Q_Modify_Reduced.cfm | 5,535 | CFM File | 8/12/2004 1:29 PM |
| Q_New_Groups.cfm | 763 | CFM File | 8/12/2004 1:29 PM |
| Q_New_Payment.cfm | 5,426 | CFM File | 8/12/2004 1:29 PM |
| Q_NonQual_Overturn.cfm | 980 | CFM File | 8/12/2004 1:29 PM |
| Q_Notes_New.cfm | 451 | CFM File | 8/12/2004 1:29 PM |
| Q_Pay_Period.cfm | 1,284 | CFM File | 8/12/2004 1:29 PM |
| Q_Performance_New.cfm | 408 | CFM File | 8/12/2004 1:29 PM |
| Q_Performance_Review.cfm | 400 | CFM File | 8/12/2004 1:29 PM |
| Q_Pick_Client.cfm | 429 | CFM File | 8/12/2004 1:29 PM |
| Q_Plan_Delete.cfm | 225 | CFM File | 8/12/2004 1:29 PM |
| Q_Plant_Shutdowns.cfm | 2,104 | CFM File | 8/12/2004 1:29 PM |
| Q_Policy_Autolink.cfm | 979 | CFM File | 8/12/2004 1:29 PM |
| Q_Policy_Definition.cfm | 856 | CFM File | 8/12/2004 1:29 PM |
| Q_Reasons.cfm | 555 | CFM File | 8/12/2004 1:29 PM |
| Q_Remove_Coverage.cfm | 2,895 | CFM File | 8/12/2004 1:29 PM |
| Q_Report_Options.cfm | 5,646 | CFM File | 8/12/2004 1:29 PM |
| Q_Report_Setup.cfm | 1,695 | CFM File | 8/12/2004 1:29 PM |
| Q_Reports_Current.cfm | 330 | CFM File | 8/12/2004 1:29 PM |
| Q_Request_Review.cfm | 774 | CFM File | 8/12/2004 1:29 PM |
| Q_Retrieve_Casual_PTO.cfm | 5,552 | CFM File | 8/12/2004 1:29 PM |
| Q_Schedule_Review.cfm | 1,795 | CFM File | 8/12/2004 1:29 PM |
| Q_Shift_California.cfm | 15 KB | CFM File | 8/12/2004 1:29 PM |
| Q_Shift_Delivery.cfm | 816 | CFM File | 8/12/2004 1:29 PM |
| Q_States.cfm | 296 | CFM File | 8/12/2004 1:29 PM |
| Q_STD_ByGroup.cfm | 1,912 | CFM File | 8/12/2004 1:29 PM |
| Q_STD_Details.cfm | 1,037 | CFM File | 8/12/2004 1:29 PM |
| Q_STD_Options.cfm | 3,697 | CFM File | 8/12/2004 1:29 PM |
| Q_STD_Overlaps.cfm | 917 | CFM File | 8/12/2004 1:29 PM |
| Q_STD_Plan.cfm | 4,835 | CFM File | 8/12/2004 1:29 PM |
| Q_System_Options.cfm | 638 | CFM File | 8/12/2004 1:29 PM |
| Q_Task_Modify.cfm | 372 | CFM File | 8/12/2004 1:29 PM |
| Q_Task_Update.cfm | 271 | CFM File | 8/12/2004 1:29 PM |
| Q_UN_Assessment.cfm | 5,220 | CFM File | 8/12/2004 1:29 PM |
| Q_UN_ByGroup.cfm | 1,911 | CFM File | 8/12/2004 1:29 PM |
| Q_UN_Get.cfm | 366 | CFM File | 8/12/2004 1:29 PM |
| Q_UN_Options.cfm | 2,739 | CFM File | 8/12/2004 1:29 PM |
| Q_View_Attendance.cfm | 1,768 | CFM File | 8/12/2004 1:29 PM |
| qryReport1.cfm | 2,910 | CFM File | 8/12/2004 1:29 PM |
| R_Define_Absenteeism.cfm | 6,714 | CFM File | 8/12/2004 1:29 PM |
| R_Define_Costs.cfm | 5,383 | CFM File | 8/12/2004 1:29 PM |
| R_Employees.cfm | 2,934 | CFM File | 8/12/2004 1:29 PM |
| R_Honda_Audit.cfm | 7,467 | CFM File | 8/12/2004 1:29 PM |
| R_Honda_Closed.cfm | 6,769 | CFM File | 8/12/2004 1:29 PM |
| R_Honda_Current.cfm | 6,551 | CFM File | 8/12/2004 1:29 PM |
| RE_Closed_Pending.cfm | 2,707 | CFM File | 8/12/2004 1:29 PM |
| RE_Honda_AR_FMLAClosed.cfm | 12 KB | CFM File | 8/12/2004 1:29 PM |
| RE_Honda_AR_FMLAopen.cfm | 12 KB | CFM File | 8/12/2004 1:29 PM |
| RE_Honda_AR_Medical.cfm | 7,587 | CFM File | 8/12/2004 1:29 PM |
| RE_Honda_Audit.cfm | 6,800 | CFM File | 8/12/2004 1:29 PM |
| RE_Honda_Closed.cfm | 6,205 | CFM File | 8/12/2004 1:29 PM |
| RE_Honda_Currrent.cfm | 6,052 | CFM File | 8/12/2004 1:29 PM |
| RE_Mailing_List.cfm | 2,497 | CFM File | 8/12/2004 1:29 PM |
| RE_Matrix_Closed.cfm | 22 KB | CFM File | 8/12/2004 1:29 PM |
| RE_Matrix_Giant.cfm | 2,445 | CFM File | 8/12/2004 1:29 PM |
| RE_Matrix_Open_Status.cfm | 24 KB | CFM File | 8/12/2004 1:29 PM |
| RE_Nadia_Visa.cfm | 5,430 | CFM File | 8/12/2004 1:29 PM |
| RE_Open_ByAdmin.cfm | 3,278 | CFM File | 8/12/2004 1:29 PM |
| RE_Quarterly_Audit.cfm | 4,124 | CFM File | 8/12/2004 1:29 PM |
| RE_Task_Overdue.cfm | 1,546 | CFM File | 8/12/2004 1:29 PM |
| T_Actual_RTW.cfm | 3,744 | CFM File | 8/12/2004 1:29 PM |
| T_Add_Casual.cfm | 4,435 | CFM File | 8/12/2004 1:29 PM |
| T_Email_Notices.cfm | 1,971 | CFM File | 8/12/2004 1:29 PM |
| T_Employee_Delete.cfm | 3,020 | CFM File | 8/12/2004 1:29 PM |
| T_Enquiry_New.cfm | 5,125 | CFM File | 8/12/2004 1:29 PM |
| T_Exception_Approve.cfm | 1,479 | CFM File | 8/12/2004 1:29 PM |
| T_Exception_Delete.cfm | 2,673 | CFM File | 8/12/2004 1:29 PM |
| T_Exception_Modify.cfm | 9,535 | CFM File | 8/12/2004 1:29 PM |
| T_GM_Modify.cfm | 9,928 | CFM File | 8/12/2004 1:29 PM |
| T_GM_Overlaps.cfm | 5,514 | CFM File | 8/12/2004 1:29 PM |
| T_Modify_Absence.cfm | 4,770 | CFM File | 8/12/2004 1:29 PM |
| T_Modify_Early_Sched.cfm | 11 KB | CFM File | 8/12/2004 1:29 PM |
| T_New_Payment.cfm | 12 KB | CFM File | 8/12/2004 1:29 PM |
| T_NonQual_Explain.cfm | 7,612 | CFM File | 8/12/2004 1:29 PM |
| T_Pick_Client.cfm | 1,918 | CFM File | 8/12/2004 1:29 PM |
| T_Read_Message.cfm | 1,599 | CFM File | 8/12/2004 1:29 PM |
| T_Request_Review.cfm | 6,889 | CFM File | 8/12/2004 1:29 PM |
| T_Verify_Value.cfm | 7,496 | CFM File | 8/12/2004 1:29 PM |
| tablenames.cfm | 1,483 | CFM File | 8/12/2004 1:29 PM |
| Test2.cfm | 401 | CFM File | 8/12/2004 1:29 PM |
| test.cfm | 627 | CFM File | 8/12/2004 1:29 PM |
| RE_Employee_Details.cfm | 7,537 | CFM File | 8/13/2004 8:16 AM |
| T_Unlock.cfm | 2,103 | CFM File | 8/16/2004 8:48 AM |
| Q_Unlock.cfm | 656 | CFM File | 8/16/2004 8:56 AM |
| OD Non-CA Employee Checklist.pdf | 185 KB | Adobe Acrobat Document | 8/16/2004 9:51 AM |
| OD_nonCA_Med_noRTW.pdf | 334 KB | Adobe Acrobat Document | 8/16/2004 9:52 AM |
| OD_nonCA_Med_RTW.pdf | 344 KB | Adobe Acrobat Document | 8/16/2004 9:54 AM |
| OD_nonCA_Med_RTW_4pages.pdf | 345 KB | Adobe Acrobat Document | 8/16/2004 9:54 AM |
| OD_nonCA_noMed.pdf | 247 KB | Adobe Acrobat Document | 8/16/2004 9:55 AM |
| OD_RTW_Letter.pdf | 201 KB | Adobe Acrobat Document | 8/18/2004 9:30 AM |
| Updated_OD_MED_CERT.pdf | 246 KB | Adobe Acrobat Document | 8/18/2004 11:52 AM |
| OD_One_Page_wMed_Cert.pdf | 276 KB | Adobe Acrobat Document | 8/18/2004 11:53 AM |
| Test_Email.cfm | 16 KB | CFM File | 8/18/2004 1:27 PM |
| O_Audit_Reports.cfm | 2,734 | CFM File | 8/19/2004 12:55 PM |
| OD CA Employee Checklist.pdf | 185 KB | Adobe Acrobat Document | 8/19/2004 2:17 PM |
| OD_CA_Med_noRTW.pdf | 313 KB | Adobe Acrobat Document | 8/19/2004 2:18 PM |
| OD_CA_Med_RTW.pdf | 319 KB | Adobe Acrobat Document | 8/19/2004 2:18 PM |
| OD_CA_noMed.pdf | 249 KB | Adobe Acrobat Document | 8/19/2004 2:19 PM |
| OD_CA_Med_RTW_4pages.pdf | 348 KB | Adobe Acrobat Document | 8/19/2004 2:21 PM |
| R_Supervisors.cfm | 2,421 | CFM File | 8/19/2004 4:10 PM |
| O_List_Reports.cfm | 1,571 | CFM File | 8/19/2004 4:18 PM |
| Q_Email_Editor.cfm | 225 | CFM File | 8/20/2004 8:57 AM |
| Q_MyEmployees.cfm | 4,017 | CFM File | 8/23/2004 12:41 PM |
| O_Detail_Reports.cfm | 2,355 | CFM File | 8/24/2004 12:23 PM |
| R_Location_Detail.cfm | 5,175 | CFM File | 8/24/2004 3:07 PM |
| T_Leave_Submit.cfm | 4,864 | CFM File | 8/25/2004 9:56 AM |
| T_New_Correspondence.cfm | 4,919 | CFM File | 8/26/2004 11:08 AM |
| Error.cfm | 1,697 | CFM File | 8/26/2004 2:06 PM |
| T_Email_Review.cfm | 5,377 | CFM File | 8/27/2004 8:50 AM |
| RE_Demographics.cfm | 10 KB | CFM File | 8/31/2004 3:57 PM |
| Batch_Cover.pdf | 160 KB | Adobe Acrobat Document | 9/2/2004 5:25 PM |
| Batch_End_Letter.pdf | 190 KB | Adobe Acrobat Document | 9/14/2004 9:02 AM |
| O_Physicians_New.cfm | 4,686 | CFM File | 9/14/2004 1:00 PM |
| Q_Physicians_New.cfm | 3,171 | CFM File | 9/14/2004 1:01 PM |
| A_Test.cfm | 4,417 | CFM File | 9/20/2004 1:27 PM |
| T_Eligibility_Review.cfm | 9,212 | CFM File | 9/21/2004 4:40 PM |
| Q_Delay_CFRA.cfm | 1,513 | CFM File | 9/21/2004 4:40 PM |
| Q_Record_Averages.cfm | 945 | CFM File | 9/21/2004 4:40 PM |
| T_Schedule_Review.cfm | 10,238 | CFM File | 9/21/2004 4:40 PM |
| Approve.gif | 511 | GIF Image | 9/21/2004 4:40 PM |
| Deny.gif | 411 | GIF Image | 9/21/2004 4:40 PM |
| Corres.gif | 498 | GIF Image | 9/22/2004 7:45 AM |
| Enquire.gif | 497 | GIF Image | 9/22/2004 7:45 AM |
| New_Leave.gif | 562 | GIF Image | 9/22/2004 7:45 AM |
| O_View_Entitlement.cfm | 5,232 | CFM File | 9/22/2004 7:45 AM |
| O_View_LeaveSummary.cfm | 1,600 | CFM File | 9/22/2004 7:45 AM |
| Q_Coverage_Breakdown.cfm | 26 KB | CFM File | 9/22/2004 7:54 AM |
| Q_Roll_Forward.cfm | 3,812 | CFM File | 9/22/2004 8:27 AM |
| O_View_Enquiries.cfm | 969 | CFM File | 9/22/2004 8:35 AM |
| R_Duration_Report_Alt.cfm | 11 KB | CFM File | 9/22/2004 12:53 PM |
| Q_Weekday_High.cfm | 11 KB | CFM File | 9/23/2004 12:16 PM |
| R_Employee_Details.cfm | 15 KB | CFM File | 9/23/2004 12:16 PM |
| O_View_Absences.cfm | 1,777 | CFM File | 9/23/2004 12:16 PM |
| Q_Absence_History.cfm | 2,730 | CFM File | 9/23/2004 12:16 PM |
| WeekDayAnalysisBar.swf | 32 KB | Shockwave Flash Object | 9/23/2004 12:16 PM |
| WeekDayAnalysisBarStatic.swf | 31 KB | Shockwave Flash Object | 9/23/2004 12:16 PM |
| Calendar.gif | 549 | GIF Image | 9/23/2004 12:16 PM |
| R_Disciplinary_Summary.cfm | 7,593 | CFM File | 9/23/2004 12:16 PM |
| Q_Reason_Analysis.cfm | 1,057 | CFM File | 9/23/2004 12:16 PM |
| R_Matrix_Giant.cfm | 4,560 | CFM File | 9/23/2004 12:16 PM |
| R_Quarterly_Audit.cfm | 5,805 | CFM File | 9/23/2004 12:16 PM |
| R_Mailing_List.cfm | 4,205 | CFM File | 9/23/2004 12:16 PM |
| Create.gif | 369 | GIF Image | 9/23/2004 1:24 PM |
| R_Demographics.cfm | 16 KB | CFM File | 9/23/2004 6:23 PM |
| AuditDemo_Tab.gif | 391 | GIF Image | 9/24/2004 9:42 AM |
| Demographics_Tab.gif | 561 | GIF Image | 9/24/2004 9:43 AM |
| Employment_Tab.gif | 515 | GIF Image | 9/24/2004 9:43 AM |
| Q_Employee_Demo.cfm | 1,544 | CFM File | 9/24/2004 9:43 AM |
| SystemAccess_Tab.gif | 561 | GIF Image | 9/24/2004 9:43 AM |
| Q_Access_Levels.cfm | 286 | CFM File | 9/24/2004 9:44 AM |
| O_Employee_Audit.cfm | 1,413 | CFM File | 9/24/2004 10:04 AM |
| O_Employee_Access.cfm | 3,015 | CFM File | 9/24/2004 10:12 AM |
| Login.cfm | 1,566 | CFM File | 9/29/2004 9:28 AM |
| VerifyLogin_Bypass.cfm | 8,642 | CFM File | 9/29/2004 9:29 AM |
| Checkbox.gif | 196 | GIF Image | 9/30/2004 2:40 PM |
| O_Modify_Cancel.cfm | 3,091 | CFM File | 9/30/2004 2:48 PM |
| Cancel_All.gif | 558 | GIF Image | 9/30/2004 2:48 PM |
| Vert_Gray_Line.gif | 66 | GIF Image | 9/30/2004 2:48 PM |
| O_Modify_Extend_Reduced.cfm | 4,885 | CFM File | 9/30/2004 2:49 PM |
| O_Modify_Early.cfm | 4,185 | CFM File | 9/30/2004 2:49 PM |
| O_Modify_Recalc.cfm | 981 | CFM File | 9/30/2004 2:49 PM |
| O_Modify_Delivery.cfm | 1,744 | CFM File | 9/30/2004 2:49 PM |
| O_Modify_Exhaust.cfm | 1,795 | CFM File | 9/30/2004 2:49 PM |
| Q_Modify_Exhaust.cfm | 2,865 | CFM File | 9/30/2004 2:49 PM |
| O_Modify_Convert.cfm | 8,098 | CFM File | 9/30/2004 2:49 PM |
| T_No_Leave.cfm | 388 | CFM File | 9/30/2004 2:49 PM |
| T_Shift_Delivery.cfm | 889 | CFM File | 9/30/2004 2:49 PM |
| O_Modify_Uncancel.cfm | 1,071 | CFM File | 9/30/2004 2:49 PM |
| Q_Eligibility_Averaging.cfm | 9,368 | CFM File | 9/30/2004 2:49 PM |
| Q_Eligible_List.cfm | 509 | CFM File | 9/30/2004 2:49 PM |
| AddNew.gif | 509 | GIF Image | 9/30/2004 3:06 PM |
| Report.gif | 479 | GIF Image | 9/30/2004 3:06 PM |
| Modify.gif | 477 | GIF Image | 9/30/2004 3:06 PM |
| O_Leave_Eligibility.cfm | 1,025 | CFM File | 9/30/2004 3:06 PM |
| Profile.gif | 416 | GIF Image | 9/30/2004 3:06 PM |
| Q_Absence_Details.cfm | 1,507 | CFM File | 9/30/2004 3:06 PM |
| Recert.gif | 477 | GIF Image | 9/30/2004 3:06 PM |
| View_All.gif | 501 | GIF Image | 9/30/2004 3:06 PM |
| O_Leave_STD.cfm | 8,851 | CFM File | 9/30/2004 3:06 PM |
| Q_Leave_STD.cfm | 3,281 | CFM File | 9/30/2004 3:06 PM |
| Q_STDInfo_Update.cfm | 708 | CFM File | 9/30/2004 3:06 PM |
| O_Modify_Extend.cfm | 4,293 | CFM File | 9/30/2004 3:08 PM |
| O_OneMonth_Review.cfm | 2,723 | CFM File | 9/30/2004 3:18 PM |
| Q_All_Administrators.cfm | 433 | CFM File | 10/1/2004 7:22 AM |
| T_Mod_Cert.cfm | 17 KB | CFM File | 10/1/2004 7:27 AM |
| Q_Leave_Details.cfm | 4,347 | CFM File | 10/1/2004 7:27 AM |
| T_Mod_Confirm.cfm | 15 KB | CFM File | 10/1/2004 7:27 AM |
| No.gif | 332 | GIF Image | 10/1/2004 7:27 AM |
| Yes.gif | 352 | GIF Image | 10/1/2004 7:27 AM |
| T_ToDo.cfm | 3,998 | CFM File | 10/1/2004 7:36 AM |
| All_Tasks_Tab.gif | 469 | GIF Image | 10/1/2004 7:36 AM |
| All_Tasks_TabO.gif | 469 | GIF Image | 10/1/2004 7:36 AM |
| Coming_Soon_Tab.gif | 541 | GIF Image | 10/1/2004 7:36 AM |
| Coming_Soon_TabO.gif | 541 | GIF Image | 10/1/2004 7:36 AM |
| My_Tasks_Tab.gif | 479 | GIF Image | 10/1/2004 7:36 AM |
| My_Tasks_TabO.gif | 479 | GIF Image | 10/1/2004 7:36 AM |
| New_Task.gif | 540 | GIF Image | 10/1/2004 7:36 AM |
| Q_ToDo.cfm | 1,279 | CFM File | 10/1/2004 7:36 AM |
| Update.gif | 469 | GIF Image | 10/1/2004 7:36 AM |
| Q_New_Task.cfm | 5,061 | CFM File | 10/1/2004 7:41 AM |
| FindEE_Tab.gif | 1,709 | GIF Image | 10/1/2004 7:53 AM |
| LeaveLinkTop.gif | 1,409 | GIF Image | 10/1/2004 7:53 AM |
| Left_Corner.gif | 16 KB | GIF Image | 10/1/2004 7:53 AM |
| Main_Menu.gif | 1,762 | GIF Image | 10/1/2004 7:53 AM |
| Menu_Spacer.gif | 154 | GIF Image | 10/1/2004 7:53 AM |
| Reports_Tab.gif | 1,765 | GIF Image | 10/1/2004 7:53 AM |
| Task_Tab.gif | 1,781 | GIF Image | 10/1/2004 7:53 AM |
| Top_Spacer.gif | 76 | GIF Image | 10/1/2004 7:53 AM |
| Home_Out.gif | 492 | GIF Image | 10/1/2004 7:53 AM |
| LogOff_Out.gif | 553 | GIF Image | 10/1/2004 7:53 AM |
| O_Help_Text.cfm | 10 KB | CFM File | 10/1/2004 7:53 AM |
| Right_Corner.gif | 1,861 | GIF Image | 10/1/2004 7:53 AM |
| Right_Spacer.gif | 70 | GIF Image | 10/1/2004 7:53 AM |
| Q_Insert_IntakeID.cfm | 1,302 | CFM File | 10/1/2004 7:53 AM |
| Search_Lookup.gif | 359 | GIF Image | 10/1/2004 7:53 AM |
| Submit.gif | 468 | GIF Image | 10/1/2004 7:53 AM |
| T_Select_Employee.cfm | 2,910 | CFM File | 10/1/2004 7:53 AM |
| Cal_Lookup.gif | 240 | GIF Image | 10/1/2004 7:53 AM |
| Continuous_TabO.gif | 479 | GIF Image | 10/1/2004 7:53 AM |
| Intermittent_Tab.gif | 479 | GIF Image | 10/1/2004 7:53 AM |
| Reduced_Tab.gif | 447 | GIF Image | 10/1/2004 7:53 AM |
| Continuous_Tab.gif | 479 | GIF Image | 10/1/2004 7:53 AM |
| lntermittent_TabO.gif | 479 | GIF Image | 10/1/2004 7:53 AM |
| Reduced_TabO.gif | 447 | GIF Image | 10/1/2004 7:53 AM |
| Cancel.gif | 472 | GIF Image | 10/1/2004 7:53 AM |
| Left_Bottom.gif | 1,113 | GIF Image | 10/1/2004 7:53 AM |
| Next.gif | 407 | GIF Image | 10/1/2004 7:53 AM |
| O_Reduced.cfm | 5,981 | CFM File | 10/1/2004 7:53 AM |
| Bottom_Spacer.gif | 103 | GIF Image | 10/1/2004 7:53 AM |
| Right_Bottom.gif | 193 | GIF Image | 10/1/2004 7:53 AM |
| J_Form_Validation.cfm | 1,312 | CFM File | 10/1/2004 7:55 AM |
| J_Calendar.cfm | 570 | CFM File | 10/1/2004 7:56 AM |
| invis.gif | 49 | GIF Image | 10/1/2004 7:58 AM |
| O_TriCalendar.cfm | 8,267 | CFM File | 10/1/2004 7:58 AM |
| AddToPlan.gif | 579 | GIF Image | 10/1/2004 12:43 PM |
| O_Intermittent.cfm | 1,668 | CFM File | 10/1/2004 12:43 PM |
| O_UnoCalendar.cfm | 5,592 | CFM File | 10/1/2004 12:43 PM |
| vssver.scc | 11 KB | SCC File | 10/4/2004 11:47 AM |
| T_Reason_Mod.cfm | 2,299 | CFM File | 10/7/2004 10:30 AM |
| T_Corres_Template.cfm | 2,109 | CFM File | 10/7/2004 10:32 AM |
| T_Link_Correspondence.cfm | 3,265 | CFM File | 10/7/2004 11:02 AM |
| O_Employee_Demo.cfm | 11 KB | CFM File | 10/7/2004 12:51 PM |
| O_Leave_BackToWork.cfm | 7,314 | CFM File | 10/7/2004 1:21 PM |
| O_Corres_Current.cfm | 2,038 | CFM File | 10/7/2004 3:51 PM |
| Q_New_Customer.cfm | 6,938 | CFM File | 10/8/2004 12:34 PM |
| Accruals_Tab.gif | 439 | GIF Image | 10/8/2004 1:00 PM |
| T_Absence_History.cfm | 2,785 | CFM File | 10/8/2004 1:02 PM |
| Q_STD_Paperwork.cfm | 903 | CFM File | 10/12/2004 8:43 AM |
| O_Corres_New.cfm | 2,958 | CFM File | 10/18/2004 9:05 AM |
| Q_Correspondence.cfm | 7,713 | CFM File | 10/18/2004 9:06 AM |
| T_UN_Reasons.cfm | 3,341 | CFM File | 10/28/2004 9:37 AM |
| Q_UN_Reasons.cfm | 3,555 | CFM File | 10/28/2004 9:37 AM |
| T_Configure_Menu.cfm | 5,971 | CFM File | 10/29/2004 8:07 AM |
| T_Email_New.cfm | 3,049 | CFM File | 10/29/2004 9:35 AM |
| T_Email_Variables.cfm | 1,047 | CFM File | 10/29/2004 9:42 AM |
| Q_Email_New.cfm | 1,277 | CFM File | 10/29/2004 9:49 AM |
| T_Email_Editor.cfm | 1,549 | CFM File | 10/29/2004 9:54 AM |
| O_Modify_Coverage.cfm | 19 KB | CFM File | 11/4/2004 10:43 AM |
| T_Convert_Sick.cfm | 7,330 | CFM File | 11/4/2004 3:29 PM |
| T_Cancel_Request.cfm | 3,216 | CFM File | 11/9/2004 10:36 AM |
| Q_Leave_Submit.cfm | 3,298 | CFM File | 11/10/2004 9:54 AM |
| T_Administrators.cfm | 2,033 | CFM File | 11/10/2004 10:06 AM |
| O_Administrator_Reassign.cfm | 1,555 | CFM File | 11/10/2004 10:08 AM |
| O_Administrator_New.cfm | 2,544 | CFM File | 11/10/2004 10:13 AM |
| O_Administrator_Current.cfm | 4,000 | CFM File | 11/10/2004 10:16 AM |
| Q_Add_Casual.cfm | 5,639 | CFM File | 11/10/2004 11:52 AM |
| CD_Attendance_Policy.cfm | 1,904 | CFM File | 11/10/2004 1:37 PM |
| T_STD_Overlaps.cfm | 4,797 | CFM File | 11/10/2004 3:36 PM |
| Q_STD_Get.cfm | 1,085 | CFM File | 11/10/2004 3:38 PM |
| O_STD_Current.cfm | 4,076 | CFM File | 11/10/2004 3:40 PM |
| Q_Send_Email.cfm | 9,470 | CFM File | 11/11/2004 12:46 PM |
| R_Absence_Rates.cfm | 12 KB | CFM File | 11/12/2004 4:13 PM |
| AttendYellow_Tab.gif | 504 | GIF Image | 11/17/2004 2:04 PM |
| T_Mod_Demographics.cfm | 3,003 | CFM File | 11/18/2004 2:05 PM |
| O_Employee_Attendance.cfm | 2,137 | CFM File | 11/18/2004 2:21 PM |
| Q_Mod_Attendance.cfm | 1,317 | CFM File | 11/18/2004 3:24 PM |
| T_Mod_Attendance.cfm | 5,272 | CFM File | 11/18/2004 3:25 PM |
| Announcement_mainenance.cfm | 338 | CFM File | 11/19/2004 9:23 AM |
| Announcement_mainenance.html | 3,985 | HTML File | 11/19/2004 9:30 AM |
| Q_Eligibility_Policies.cfm | 9,785 | CFM File | 11/23/2004 10:39 AM |
| T_All_Correspondence.cfm | 4,634 | CFM File | 11/29/2004 10:01 AM |
| T_Report_Options.cfm | 11 KB | CFM File | 12/1/2004 9:23 AM |
| R_Absences_Detail.cfm | 23 KB | CFM File | 12/2/2004 10:34 AM |
| RE_Absences_Summary.cfm | 6,616 | CFM File | 12/2/2004 10:47 AM |
| RE_Absences_Detail.cfm | 6,825 | CFM File | 12/2/2004 10:48 AM |
| R_Absences_Summary.cfm | 20 KB | CFM File | 12/2/2004 10:51 AM |
| R_Leave_Activity.cfm | 15 KB | CFM File | 12/2/2004 11:08 AM |
| RE_Leave_Activity.cfm | 5,777 | CFM File | 12/2/2004 11:09 AM |
| O_PopUpLeave.cfm | 5,264 | CFM File | 12/2/2004 11:35 AM |
| R_Return_To_Work.cfm | 15 KB | CFM File | 12/2/2004 11:43 AM |
| RE_Return_To_Work.cfm | 5,302 | CFM File | 12/2/2004 11:44 AM |
| R_Location_Totals.cfm | 14 KB | CFM File | 12/2/2004 11:54 AM |
| RE_Location_Totals.cfm | 4,857 | CFM File | 12/2/2004 11:54 AM |
| RE_Duration_Report.cfm | 5,202 | CFM File | 12/2/2004 12:05 PM |
| RE_Denial_Report.cfm | 5,352 | CFM File | 12/2/2004 12:05 PM |
| R_Denial_Report.cfm | 18 KB | CFM File | 12/2/2004 12:08 PM |
| R_Duration_Report.cfm | 12 KB | CFM File | 12/2/2004 1:39 PM |
| R_Select_Detail.cfm | 27 KB | CFM File | 12/2/2004 1:49 PM |
| R_Physician_High.cfm | 9,231 | CFM File | 12/2/2004 1:53 PM |
| R_MedCert_Analysis.cfm | 13 KB | CFM File | 12/2/2004 1:55 PM |
| O_Plan_View.cfm | 3,048 | CFM File | 12/10/2004 4:55 PM |
| By_Weeks.gif | 507 | GIF Image | 12/13/2004 4:01 PM |
| O_Continuous.cfm | 2,103 | CFM File | 12/13/2004 4:04 PM |
| R_Audit.cfm | 11 KB | CFM File | 12/14/2004 4:19 PM |
| Re_TaskList.cfm | 2,959 | CFM File | 12/14/2004 4:28 PM |
| Q_Load_Paperwork.cfm | 46 KB | CFM File | 12/15/2004 9:53 AM |
| T_Modify_Extend_Sched.cfm | 19 KB | CFM File | 12/16/2004 11:01 AM |
| Q_Corres_Current.cfm | 700 | CFM File | 12/20/2004 10:17 AM |
| O_Reduced_Alt.cfm | 4,885 | CFM File | 12/20/2004 10:39 AM |
| Q_Input_Schedule.cfm | 12 KB | CFM File | 12/20/2004 11:28 AM |
| R_Client_FMLA.cfm | 26 KB | CFM File | 12/22/2004 3:22 PM |
| RE_Client_FMLA.cfm | 15 KB | CFM File | 12/22/2004 3:23 PM |
| T_TwoWeek_Sched.cfm | 8,314 | CFM File | 1/3/2005 10:07 AM |
| Q_Evaluate_Enquiry.cfm | 10 KB | CFM File | 1/4/2005 9:58 AM |
| Batch_Separator.pdf | 158 KB | Adobe Acrobat Document | 1/4/2005 10:09 AM |
| Q_Batch_Select.cfm | 6,667 | CFM File | 1/4/2005 10:11 AM |
| RE_FMLA_Denied.cfm | 4,052 | CFM File | 1/5/2005 10:21 AM |
| DeleteHistory.cfm | 518 | CFM File | 1/5/2005 10:21 AM |
| T_Batch_Select.cfm | 3,971 | CFM File | 1/5/2005 11:43 AM |
| RE_Approved_FMLA.cfm | 4,235 | CFM File | 1/5/2005 5:44 PM |
| RE_Approved_FMLA_RTW_14.cfm | 4,320 | CFM File | 1/5/2005 5:46 PM |
| RE_WC_FMLA.cfm | 4,233 | CFM File | 1/5/2005 5:49 PM |
| Q_Fitness.cfm | 7,113 | CFM File | 1/6/2005 1:42 PM |
| Q_Mod_Demographics.cfm | 15 KB | CFM File | 1/6/2005 4:35 PM |
| O_PopUp_Group_Configs.cfm | 2,998 | CFM File | 1/6/2005 4:51 PM |
| O_Summary_Reports.cfm | 4,714 | CFM File | 1/7/2005 10:51 AM |
| O_Administrator_Remove.cfm | 1,723 | CFM File | 1/10/2005 10:59 AM |
| O_Modify_Single.cfm | 8,067 | CFM File | 1/10/2005 11:39 AM |
| O_Leave_Absences.cfm | 5,329 | CFM File | 1/10/2005 11:48 AM |
| R_Weekday_High.cfm | 6,711 | CFM File | 1/10/2005 2:28 PM |
| Q_Email_Report.cfm | 1,384 | CFM File | 1/10/2005 2:33 PM |
| R_Analysis_AbsenceRate.cfm | 6,558 | CFM File | 1/10/2005 2:35 PM |
| R_Reason_Analysis.cfm | 4,268 | CFM File | 1/10/2005 2:36 PM |
| O_Trend_Reports.cfm | 2,276 | CFM File | 1/10/2005 2:38 PM |
| Q_Administrators.cfm | 4,110 | CFM File | 1/10/2005 2:41 PM |
| R_Absence_Month_Breakdown.cfm | 8,822 | CFM File | 1/10/2005 2:43 PM |
| R_Exception_Report.cfm | 7,241 | CFM File | 1/10/2005 2:50 PM |
| RE_Exception_Report.cfm | 2,672 | CFM File | 1/10/2005 2:52 PM |
| R_TaskList.cfm | 5,683 | CFM File | 1/10/2005 2:54 PM |
| R_TaskList_Details.cfm | 3,488 | CFM File | 1/10/2005 2:54 PM |
| O_Analysis_Reports.cfm | 1,428 | CFM File | 1/10/2005 4:45 PM |
| T_Reconcile.cfm | 8,657 | CFM File | 1/11/2005 1:33 PM |
| q_reconcile.cfm | 10 KB | CFM File | 1/11/2005 2:01 PM |
| R_WC_FMLA.cfm | 13 KB | CFM File | 1/11/2005 3:01 PM |
| R_FMLA_Denied.cfm | 13 KB | CFM File | 1/11/2005 3:01 PM |
| R_Approved_FMLA_RTW_14.cfm | 13 KB | CFM File | 1/11/2005 3:01 PM |
| R_Approved_FMLA.cfm | 13 KB | CFM File | 1/11/2005 3:01 PM |
| Analysis_TabO.gif | 460 | GIF Image | 1/11/2005 3:32 PM |
| Analysis_Tab.gif | 460 | GIF Image | 1/11/2005 3:32 PM |
| WH-380 Med Cert REV 0105.pdf | 32 KB | Adobe Acrobat Document | 1/11/2005 6:14 PM |
| R_Analysis_OverallAbsence.cfm | 7,813 | CFM File | 1/12/2005 11:58 AM |
| R_Analysis_DaybyDay.cfm | 7,249 | CFM File | 1/12/2005 12:31 PM |
| R_Analysis_MonthbyMonth.cfm | 7,400 | CFM File | 1/12/2005 12:32 PM |
| R_Analysis_Employee.cfm | 11 KB | CFM File | 1/12/2005 4:02 PM |
| T_Add_Employee.cfm | 10 KB | CFM File | 1/14/2005 10:57 AM |
| Q_Add_Employee.cfm | 6,165 | CFM File | 1/14/2005 11:06 AM |
| T_Employee_Duplicate.cfm | 4,201 | CFM File | 1/14/2005 11:07 AM |
| T_Reports.cfm | 3,972 | CFM File | 1/14/2005 11:11 AM |
| O_PopUpEmployee.cfm | 6,255 | CFM File | 1/14/2005 11:21 AM |
| Q_Read_Message.cfm | 826 | CFM File | 1/14/2005 11:54 AM |
| O_Modify_Convert_Reduced.cfm | 4,048 | CFM File | 1/14/2005 12:35 PM |
| Q_Historic.cfm | 4,689 | CFM File | 1/14/2005 12:53 PM |
| Permission.pdf | 11 KB | Adobe Acrobat Document | 1/14/2005 2:30 PM |
| FullResponse_CAPreg.pdf | 180 KB | Adobe Acrobat Document | 1/14/2005 2:34 PM |
| AbsentysOnePage.pdf | 17 KB | Adobe Acrobat Document | 1/14/2005 2:35 PM |
| FullResponse.pdf | 42 KB | Adobe Acrobat Document | 1/14/2005 2:37 PM |
| O_Employee_History.cfm | 9,654 | CFM File | 1/14/2005 2:39 PM |
| T_New_Task.cfm | 8,851 | CFM File | 1/14/2005 3:37 PM |
| O_PopUp_Task_Leave.cfm | 5,603 | CFM File | 1/17/2005 9:53 AM |
| O_PopUp_Task_Employee.cfm | 6,619 | CFM File | 1/17/2005 9:56 AM |
| O_View_Demograph.cfm | 3,308 | CFM File | 1/17/2005 10:10 AM |
| Q_Record_Payment.cfm | 753 | CFM File | 1/17/2005 2:06 PM |
| T_Record_Payment.cfm | 2,541 | CFM File | 1/17/2005 2:10 PM |
| O_Modify_MLOA.cfm | 1,970 | CFM File | 1/17/2005 3:26 PM |
| T_InTake_STD.cfm | 7,586 | CFM File | 1/19/2005 11:55 AM |
| T_Leave_Check.cfm | 7,586 | CFM File | 1/19/2005 11:55 AM |
| Q_Eligibility_Review.cfm | 6,422 | CFM File | 1/19/2005 5:57 PM |
| Q_Modify_Recalc.cfm | 7,630 | CFM File | 1/19/2005 6:13 PM |
| O_Employee_Accruals.cfm | 1,548 | CFM File | 1/20/2005 3:41 PM |
| T_Accrual_New.cfm | 3,069 | CFM File | 1/20/2005 3:43 PM |
| Q_Accrual_New.cfm | 1,829 | CFM File | 1/20/2005 3:48 PM |
| T_Sample_Letter.cfm | 13 KB | CFM File | 1/21/2005 10:35 AM |
| T_Leave_Details.cfm | 15 KB | CFM File | 1/21/2005 1:35 PM |
| T_Employee_Profile.cfm | 7,068 | CFM File | 1/21/2005 3:54 PM |
| Q_NonSTD_Paperwork.cfm | 915 | CFM File | 1/21/2005 4:22 PM |
| Q_New_Intake.cfm | 16 KB | CFM File | 1/24/2005 6:00 PM |
| T_New_Intake.cfm | 11 KB | CFM File | 1/25/2005 10:24 AM |
| T_Historic.cfm | 11 KB | CFM File | 1/26/2005 9:21 AM |
| O_Leave_Audit.cfm | 4,093 | CFM File | 1/26/2005 2:56 PM |
| LoadingImage.gif | 2,898 | GIF Image | 1/28/2005 9:55 AM |
| O_View_Correspondence.cfm | 894 | CFM File | 1/28/2005 10:22 AM |
| Q_New_Correspondence.cfm | 2,436 | CFM File | 1/28/2005 10:26 AM |
| O_Leave_Certification.cfm | 5,706 | CFM File | 1/28/2005 10:26 AM |
| O_Leave_Insurance.cfm | 2,293 | CFM File | 1/28/2005 10:31 AM |
| O_Tasks_Coming.cfm | 3,169 | CFM File | 1/28/2005 3:02 PM |
| Q_Sick_Bypass.CFM | 5,829 | CFM File | 1/30/2005 2:25 PM |
| T_Enquiry_Result.cfm | 22 KB | CFM File | 1/30/2005 2:30 PM |
| T_Handle_Warning.cfm | 3,351 | CFM File | 1/30/2005 2:31 PM |
| Q_Admin_Contact.cfm | 1,319 | CFM File | 1/31/2005 3:16 PM |
| T_Admin_Contact.cfm | 5,228 | CFM File | 1/31/2005 3:18 PM |
| O_Tasks_All.cfm | 2,601 | CFM File | 1/31/2005 3:32 PM |
| Q_Reassign_Tasks.cfm | 2,248 | CFM File | 1/31/2005 3:37 PM |
| Q_Review_Finished.cfm | 11 KB | CFM File | 1/31/2005 3:43 PM |
| VerifyLogin.cfm | 8,383 | CFM File | 2/1/2005 10:02 AM |
| PageStart.cfm | 8,753 | CFM File | 2/1/2005 2:03 PM |
| PageEnd.cfm | 1,487 | CFM File | 2/1/2005 2:07 PM |
| Menu.cfm | 3,223 | CFM File | 2/1/2005 2:15 PM |
| Home.cfm | 1,350 | CFM File | 2/1/2005 2:16 PM |
| Application.cfm | 1,961 | CFM File | 2/1/2005 2:48 PM |
| R_Regis_MDR.cfm | 12 KB | CFM File | 2/1/2005 2:59 PM |
| T_Find_Employee.cfm | 7,220 | CFM File | 2/2/2005 4:11 PM |
| J_New_Intake.cfm | 5,261 | CFM File | 2/2/2005 4:46 PM |
| Q_Extend_Coverage.cfm | 10 KB | CFM File | 2/3/2005 3:53 PM |
| Q_Modify_MLOA.cfm | 2,432 | CFM File | 2/4/2005 11:15 AM |
| Q_Entitlement.cfm | 8,145 | CFM File | 2/7/2005 1:52 PM |
| Confirm.gif | 522 | GIF Image | 2/7/2005 5:54 PM |
| T_Modify_Leave.cfm | 8,354 | CFM File | 2/7/2005 6:05 PM |
| O_Modify_OWNWC.cfm | 760 | CFM File | 2/7/2005 6:13 PM |
| Q_Modify_Leave.cfm | 29 KB | CFM File | 2/7/2005 6:14 PM |
| Q_Tasks.cfm | 3,436 | CFM File | 2/8/2005 3:41 PM |
| Logout.cfm | 1,635 | CFM File | 2/9/2005 10:17 AM |
| T_Immediate_Reject.cfm | 9,715 | CFM File | 2/9/2005 11:15 AM |
| T_Immediate_Reject_Entitlement.cfm | 8,005 | CFM File | 2/9/2005 11:16 AM |
| T_Enquiry_View.cfm | 8,995 | CFM File | 2/9/2005 5:58 PM |
| O_PopUp_Dates.cfm | 7,132 | CFM File | 2/9/2005 6:06 PM |
| T_Batch_Recent.cfm | 2,037 | CFM File | 2/10/2005 1:36 PM |
| T_Immed_Reject_Inelig.cfm | 8,423 | CFM File | 2/11/2005 1:58 PM |
| O_Leave_Correspond.cfm | 4,002 | CFM File | 2/11/2005 2:12 PM |
| Q_Eligibility_Qualifies.cfm | 20 KB | CFM File | 2/11/2005 2:48 PM |
| O_Breakdown.cfm | 11 KB | CFM File | 2/23/2005 3:18 PM |
| T_Coverage_Breakdown.cfm | 4,453 | CFM File | 2/23/2005 3:21 PM |
| T_Extend_Coverage_Breakdown.cfm | 9,910 | CFM File | 2/23/2005 3:21 PM |
| O_Recalc_Confirmed.cfm | 4,882 | CFM File | 2/23/2005 3:21 PM |
| O_Tasks_Mine.cfm | 3,452 | CFM File | 3/3/2005 9:46 AM |
| Q_Evaluate.cfm | 49 KB | CFM File | 3/4/2005 4:47 PM |
| Q_Mod_Cert.cfm | 27 KB | CFM File | 3/4/2005 4:48 PM |
| Q_Create_Letter.cfm | 13 KB | CFM File | 3/4/2005 4:49 PM |
| T_My_Employees.cfm | 3,939 | CFM File | 3/7/2005 11:43 AM |

What is claimed is:

1. An apparatus for managing information related to absence of an employee from a workplace, the apparatus comprising:
an employee database for maintaining employee identification information and information related to absence of the employee;
a client computer comprising an input device for entering input information related to the absence of the employee and a display device for displaying information related to the absence of the employee;
a server computer in communication with the client computer and the employee database, the server computer for receiving the input information, accessing the employee database and executing one or more software modules for operating on the information related to the absence of the employee; and
a communication network through which the client computer communicates with the server computer.

2. The apparatus of claim 1 further comprising:
the server computer further in communication with a first vendor computer system that maintains workers' compensation information; and
the communication network further for providing communication between the server computer and the first vendor computer system.

3. The apparatus of claim 1 further comprising:
the server computer further in communication with a second vendor computer system that maintains short term disability information; and
the communication network further for providing communication between the server computer and the second vendor computer system.

4. The apparatus of claim 1 further comprising the one or more software modules for operating on the information related to the absence of the employee to determine compliance with government-enacted employee leave laws.

5. The apparatus of claim 1 further comprising the one or more software modules for operating on the information related to the absence of the employee to determine compliance with employer leave policies.

6. The apparatus of claim 1 further comprising the one or more software modules for receiving requests for approval of employee leave.

7. The apparatus of claim 1 further comprising the one or more software modules for receiving status inquiries regarding requested employee leave.

8. The apparatus of claim 1 further comprising the one or more software modules for determining eligibility of an employee for a requested employee leave.

9. The apparatus of claim 8 wherein the input information includes a work location of the employee requesting leave, and the one or more software modules determine eligibility for leave based at least in part on the work location of the employee requesting leave.

10. The apparatus of claim 8 wherein the input information includes a reason for the requested employee leave, and the one or more software modules determine eligibility for leave based at least in part on the reason for requested leave.

11. The apparatus of claim 1 further comprising the one or more software modules for generating task lists for use by an administrator in tracking tasks to be completed related to employee absences and leave requests.

12. The apparatus of claim 1 further comprising the one or more software modules for automatically generating documentation related to a requested employee leave.

13. The apparatus of claim 1 further comprising the one or more software modules for processing medical certifications related to an employee absence.

14. An apparatus for managing information related to employee leave, the apparatus comprising:
an employee database for maintaining employee information related to absences of the employee from the workplace;
a client computer connected to a communication network, the client computer for entering input information related to requested employee leave; and
a server computer connected to the communication network and in communication with the employee database, the server computer for receiving the input information, accessing employee information from the employee database and executing one or more software modules for operating on the input information and the employee information to determine whether the requested employee leave is to be granted based at least in part on government-enacted employee leave laws and employer leave policies.

15. An apparatus for managing information related to requests for employee leave, the apparatus comprising:
means for maintaining employee identification information and employee leave information;
means for receiving a request for approval of the employee leave, where the request includes a reason for the requested leave;
means for determining eligibility of the employee for the requested leave based at least in part on the employee identification information, the employee leave information and the reason for the requested leave; and
means for automatically generating documentation for notifying the employee regarding whether the employee is eligible for the requested leave.

16. The apparatus of claim 15 further comprising means for receiving a status inquiry regarding status of the determination of eligibility of the employee for the requested leave.
